(19) United States
(12) Patent Application Publication
(10) Pub. No.: US 2026/0281131 A1
(43) Pub. Date: Sep. 17, 2026

(54) AUTHENTICATION WITH DELEGATION AND DYNAMIC REVOCATION

(71) Applicant: QOMPLX LLC, Reston, VA (US)

(72) Inventors: Jason Crabtree, Vienna, VA (US); Richard Kelley, Woodbridge, VA (US); David Park, Fairfax, VA (US); Jason Hopper, Halifax, Nova Scotia (CA)

(21) Appl. No.: 19/668,326

(22) Filed: May 5, 2026

Related U.S. Application Data
(63) Continuation-in-part of application No. 18/665,556, filed on May 15, 2024.
(63) Continuation-in-part of application No. 18/184,548, filed on Mar. 15, 2023, now Pat. No. 12,621,311.
Application No. 18/184,548 is a continuation-in-part of application No. 18/152,142, filed on Jan. 9, 2023, now abandoned.
Application No. 18/152,142 is a continuation of application No. 17/163,073, filed on Jan. 29, 2021, now Pat. No. 11,552,968.
Application No. 17/163,073 is a continuation-in-part of application No. 15/837,845, filed on Dec. 11, 2017, now Pat. No. 11,005,824.
Application No. 15/837,845 is a continuation-in-part of application No. 15/825,350, filed on Nov. 29, 2017, now Pat. No. 10,594,714.
Application No. 15/825,350 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017, now abandoned.
Application No. 15/616,427 is a continuation-in-part of application No. 14/925,974, filed on Oct. 28, 2015, now abandoned.
Application No. 15/655,113 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016, now abandoned.
Application No. 15/206,195 is a continuation-in-part of application No. 15/186,453, filed on Jun. 18, 2016, now abandoned.
Application No. 15/186,453 is a continuation-in-part of application No. 15/166,158, filed on May 26, 2016, now abandoned.
Application No. 15/166,158 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 18/184,548 is a continuation-in-part of application No. 17/170,288, filed on Feb. 8, 2021, now Pat. No. 11,570,204.
Application No. 17/170,288 is a continuation-in-part of application No. 17/169,924, filed on Feb. 8, 2021, now Pat. No. 11,570,209.
Application No. 17/169,924 is a continuation-in-part of application No. 15/837,845, filed on Dec. 11, 2017, now Pat. No. 11,005,824.
(63) Continuation-in-part of application No. 19/365,134, filed on Oct. 21, 2025.
Application No. 19/365,134 is a continuation-in-part of application No. 18/361,825, filed on Jul. 29, 2023, now Pat. No. 12,580,898.
Application No. 18/361,825 is a continuation-in-part of application No. 18/297,500, filed on Apr. 7, 2023.
Application No. 18/297,500 is a continuation-in-part of application No. 18/169,203, filed on Feb. 14, 2023, now abandoned.
Application No. 18/169,203 is a continuation-in-part of application No. 17/245,162, filed on Apr. 30, 2021, now Pat. No. 11,582,207.
Application No. 17/245,162 is a continuation of application No. 15/837,845, filed on Dec. 11, 2017, now Pat. No. 11,005,824.
Application No. 18/361,825 is a continuation-in-part of application No. 17/986,850, filed on Nov. 14, 2022, now Pat. No. 12,634,345.
Application No. 17/986,850 is a continuation-in-part of application No. 17/567,060, filed on Dec. 31, 2021.
Application No. 17/567,060 is a continuation-in-part of application No. 17/389,863, filed on Jul. 30, 2021, now Pat. No. 11,792,229.
Application No. 17/389,863 is a continuation of application No. 16/792,754, filed on Feb. 17, 2020, now Pat. No. 11,184,401.
Application No. 16/792,754 is a continuation-in-part of application No. 16/779,801, filed on Feb. 3, 2020, now Pat. No. 11,032,323.
Application No. 16/779,801 is a continuation-in-part of application No. 16/777,270, filed on Jan. 30, 2020, now Pat. No. 11,025,674.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 17/567,060 is a continuation-in-part of application No. 17/170,288, filed on Feb. 8, 2021, now Pat. No. 11,570,204.
Application No. 17/170,288 is a continuation-in-part of application No. 17/102,561, filed on Nov. 24, 2020, now abandoned.
Application No. 17/102,561 is a continuation of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017, now abandoned.
Application No. 15/616,427 is a continuation-in-part of application No. 15/141,752, filed on Apr. 28, 2016, now Pat. No. 10,860,962.
Application No. 17/986,850 is a continuation-in-part of application No. 17/105,025, filed on Nov. 25, 2020, now Pat. No. 11,503,066.
Application No. 17/105,025 is a continuation of application No. 16/836,717, filed on Mar. 31, 2020, now Pat. No. 10,917,428.
Application No. 16/836,717 is a continuation-in-part of application No. 15/887,496, filed on Feb. 2, 2018, now Pat. No. 10,783,241.
Application No. 15/887,496 is a continuation-in-part of application No. 15/823,285, filed on Nov. 27, 2017, now Pat. No. 10,740,096.
Application No. 15/823,285 is a continuation-in-part of application No. 15/788,718, filed on Oct. 19, 2017, now Pat. No. 10,861,014.
Application No. 15/788,718 is a continuation-in-part of application No. 15/788,002, filed on Oct. 19, 2017, now abandoned.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017, now abandoned.
Application No. 15/887,496 is a continuation-in-part of application No. 15/818,733, filed on Nov. 20, 2017, now Pat. No. 10,673,887.
Application No. 15/818,733 is a continuation-in-part of application No. 15/725,274, filed on Oct. 4, 2017, now Pat. No. 10,609,079.
Application No. 18/361,825 is a continuation-in-part of application No. 17/683,242, filed on Feb. 28, 2022.
Application No. 17/683,242 is a continuation-in-part of application No. 16/896,764, filed on Jun. 9, 2020, now Pat. No. 11,297,088.
Application No. 16/896,764 is a continuation of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 19/365,134 is a continuation-in-part of application No. 18/361,799, filed on Jul. 28, 2023, now Pat. No. 12,537,848.
Application No. 18/361,799 is a continuation-in-part of application No. 18/359,883, filed on Jul. 27, 2023.
Application No. 19/365,134 is a continuation-in-part of application No. 18/361,811, filed on Jul. 28, 2023, now Pat. No. 12,500,929.
Application No. 18/361,811 is a continuation-in-part of application No. 18/359,895, filed on Jul. 27, 2023, now Pat. No. 12,500,823.
Application No. 18/359,895 is a continuation-in-part of application No. 18/359,883, filed on Jul. 27, 2023.
Application No. 19/365,134 is a continuation-in-part of application No. 18/358,005, filed on Jul. 24, 2023, now Pat. No. 12,500,920.
Application No. 18/358,005 is a continuation-in-part of application No. 18/354,651, filed on Jul. 19, 2023.
Application No. 18/354,651 is a continuation-in-part of application No. 18/186,117, filed on Mar. 17, 2023, now Pat. No. 12,225,042.
Application No. 18/186,117 is a continuation of application No. 17/363,222, filed on Jun. 30, 2021, now Pat. No. 11,647,039.
Application No. 17/363,222 is a continuation of application No. 16/807,007, filed on Mar. 2, 2020, now Pat. No. 11,089,045.
Application No. 16/807,007 is a continuation-in-part of application No. 15/825,350, filed on Nov. 29, 2017, now Pat. No. 10,594,714.
Application No. 19/365,134 is a continuation-in-part of application No. 18/354,664, filed on Jul. 19, 2023, now Pat. No. 12,500,767.
Application No. 18/354,664 is a continuation of application No. 18/343,716, filed on Jun. 28, 2023, now Pat. No. 12,452,284.
Application No. 18/343,716 is a continuation-in-part of application No. 18/339,191, filed on Jun. 21, 2023, now Pat. No. 12,556,523.
Application No. 18/339,191 is a continuation-in-part of application No. 18/333,414, filed on Jun. 12, 2023, now Pat. No. 12,506,715.
Application No. 18/333,414 is a continuation-in-part of application No. 18/297,500, filed on Apr. 7, 2023.
Application No. 18/297,500 is a continuation-in-part of application No. 17/986,850, filed on Nov. 14, 2022, now Pat. No. 12,634,345.
Application No. 17/986,850 is a continuation-in-part of application No. 17/683,242, filed on Feb. 28, 2022.
Application No. 18/339,191 is a continuation-in-part of application No. 18/333,421, filed on Jun. 12, 2023, now Pat. No. 12,500,888.
Application No. 18/333,421 is a continuation-in-part of application No. 18/186,605, filed on Mar. 20, 2023.
Application No. 18/186,605 is a continuation-in-part of application No. 18/146,966, filed on Dec. 27, 2022, now abandoned.
Application No. 18/146,966 is a continuation-in-part of application No. 16/412,340, filed on May 14, 2019, now Pat. No. 11,539,663.
Application No. 16/412,340 is a continuation-in-part of application No. 16/267,893, filed on Feb. 5, 2019, now abandoned.
Application No. 16/267,893 is a continuation-in-part of application No. 16/248,133, filed on Jan. 15, 2019, now abandoned.
Application No. 16/248,133 is a continuation-in-part of application No. 15/849,901, filed on Dec. 21, 2017, now Pat. No. 11,023,284.
Application No. 15/849,901 is a continuation-in-part of application No. 15/835,436, filed on Dec. 7, 2017, now Pat. No. 10,572,828.
Application No. 15/835,436 is a continuation-in-part of application No. 15/790,457, filed on Oct. 23, 2017, now Pat. No. 10,884,999.
Application No. 15/849,901 is a continuation-in-part of application No. 15/835,312, filed on Dec. 7, 2017, now Pat. No. 11,055,451.
Application No. 15/835,312 is a continuation-in-part of application No. 15/186,453, filed on Jun. 18, 2016, now abandoned.
Application No. 16/248,133 is a continuation-in-part of application No. 15/813,097, filed on Nov. 14, 2017, now abandoned.
Application No. 15/813,097 is a continuation-in-part of application No. 15/616,427, filed on Jun. 7, 2017, now abandoned.
Application No. 16/248,133 is a continuation-in-part of application No. 15/806,697, filed on Nov. 8, 2017, now abandoned.
Application No. 15/806,697 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/806,697 is a continuation-in-part of application No. 15/343,209, filed on Nov. 4, 2016, now Pat. No. 11,087,403.
Application No. 15/343,209 is a continuation-in-part of application No. 15/237,625, filed on Aug. 15, 2016, now Pat. No. 10,248,910.
Application No. 15/237,625 is a continuation-in-part of application No. 15/229,476, filed on Aug. 5, 2016, now Pat. No. 10,454,791.
Application No. 15/229,476 is a continuation-in-part of application No. 15/206,195, filed on Jul. 8, 2016, now abandoned.
Application No. 16/248,133 is a continuation-in-part of application No. 15/673,368, filed on Aug. 9, 2017, now abandoned.
Application No. 15/673,368 is a continuation-in-part of application No. 15/376,657, filed on Dec. 13, 2016, now Pat. No. 10,402,906.
Application No. 19/365,134 is a continuation-in-part of application No. 18/339,207, filed on Jun. 21, 2023, now Pat. No. 12,495,076.
Application No. 18/339,207 is a continuation-in-part of application No. 17/829,211, filed on May 31, 2022, now Pat. No. 11,757,945.
Application No. 17/829,211 is a continuation of application No. 16/983,253, filed on Aug. 3, 2020, now Pat. No. 11,388,198.
Application No. 16/983,253 is a continuation-in-part of application No. 16/887,304, filed on May 29, 2020, now Pat. No. 11,297,109.
Application No. 16/887,304 is a continuation-in-part of application No. 16/837,551, filed on Apr. 1, 2020, now Pat. No. 11,070,592.
Application No. 16/837,551 is a continuation-in-part of application No. 16/777,270, filed on Jan. 30, 2020, now Pat. No. 11,025,674.
Application No. 16/777,270 is a continuation-in-part of application No. 15/818,733, filed on Nov. 20, 2017, now Pat. No. 10,673,887.
(60) Provisional application No. 62/568,291, filed on Oct. 4, 2017.
(60) Provisional application No. 62/568,298, filed on Oct. 4, 2017.
(60) Provisional application No. 62/568,312, filed on Oct. 4, 2017.
(60) Provisional application No. 62/568,305, filed on Oct. 4, 2017.
(60) Provisional application No. 62/568,307, filed on Oct. 4, 2017.
(60) Provisional application No. 62/596,105, filed on Dec. 7, 2017.

(51) Int. Cl. H04L 9/40

(52) U.S. Cl. CPC H04L 63/1416; H04L 63/0876; H04L 63/1425; H04L 63/1466

(57) ABSTRACT

A system and methods for authentication attack detection with embedded authentication and delegation is provided, comprising an authentication object inspector configured to observe a new authentication object generated by an identity provider, and retrieve the new authentication object, wherein subsequent access requests accompanied by authentication objects are validated by comparing identifiers for each authentication object to previous identifiers. The authentication objects are able to include physical authentication information gathered via a multi-factor authentication kiosk.

### CROSS-REFERENCE TO RELATED APPLICATIONS

Priority is claimed in the application data sheet to the following patents or patent applications, each of which is expressly incorporated herein by reference in its entirety:
Ser. No. 19/365,134
Ser. No. 18/665,556
Ser. No. 18/339,191
Ser. No. 18/184,548
Ser. No. 18/152,142
Ser. No. 17/163,073
Ser. No. 15/837,845
62/596,105
Ser. No. 15/825,350
Ser. No. 15/725,274
Ser. No. 15/655,113
Ser. No. 15/616,427
Ser. No. 14/925,974
Ser. No. 15/237,625
Ser. No. 15/206,195
Ser. No. 15/186,453
Ser. No. 15/166,158
Ser. No. 15/141,752
Ser. No. 15/091,563
Ser. No. 14/986,536
Ser. No. 17/170,288
Ser. No. 17/169,924
Ser. No. 18/343,716
Ser. No. 18/361,825
Ser. No. 18/297,500
Ser. No. 18/169,203
Ser. No. 17/245,162
Ser. No. 17/986,850
Ser. No. 17/567,060
Ser. No. 17/389,863
Ser. No. 16/792,754
Ser. No. 16/779,801
Ser. No. 16/777,270
Ser. No. 16/720,383
Ser. No. 15/823,363
Ser. No. 17/102,561
Ser. No. 15/790,457
Ser. No. 15/790,327
62/568,291
62/568,298
Ser. No. 17/105,025
Ser. No. 16/836,717
Ser. No. 15/887,496
Ser. No. 15/823,285
Ser. No. 15/788,718
Ser. No. 15/788,002
Ser. No. 15/787,601
62/568,312
62/568,305
62/568,307
Ser. No. 15/818,733
Ser. No. 17/683,242
Ser. No. 16/896,764
Ser. No. 16/191,054
Ser. No. 18/361,799
Ser. No. 18/359,883
Ser. No. 18/361,811
Ser. No. 18/359,895
Ser. No. 18/358,005
Ser. No. 18/354,651
Ser. No. 18/186,117
Ser. No. 17/363,222
Ser. No. 16/807,007
Ser. No. 18/354,664
Ser. No. 18/333,414
Ser. No. 18/333,421
Ser. No. 18/186,605
Ser. No. 18/146,966
Ser. No. 16/412,340
Ser. No. 16/267,893
Ser. No. 16/248,133
Ser. No. 15/849,901
Ser. No. 15/835,436
Ser. No. 15/835,312
Ser. No. 15/813,097
Ser. No. 15/806,697
Ser. No. 15/376,657
Ser. No. 15/343,209
Ser. No. 15/229,476
Ser. No. 15/673,368
Ser. No. 18/339,207
Ser. No. 17/829,211
Ser. No. 16/983,253
Ser. No. 16/887,304
Ser. No. 16/837,551

### BACKGROUND OF THE INVENTION

### Field of the Invention

The disclosure relates to the field of network security, particularly to authentication and authorization with delegation and dynamic revocation, with multi-factor-based delegated authority, dynamic authorization changes, and dynamic revocation.

### Discussion of the State of the Art

Maintaining the security of computer systems is a matter of great economic significance in the modern world. At the same time, computer users within large enterprises, which maintain one or several protected computing domains each comprising many computers and other devices, often require secure access on many devices across the domain. A common way of providing this securely is to use domain controllers (i.e. Key Distribution Centers or KDCs) to provide authentication objects for users—after they successfully authenticate themselves—so that they can access those devices, applications, and services within the domain that are authorized for their particular user profile. Unfortunately, even with strong authentication systems such as Kerberos, which is used within Microsoft Active Directory domains, security lapses do occur. In particular, a variety of Kerberos-based attack vectors have been shown to be possible, including “golden ticket” and “silver ticket” and “diamond” and “sapphire” ticket attacks, which may grant to hostile attackers elevated and even potentially unlimited access to and control of vital domain assets if not detected quickly. This is further exacerbated when federated to cloud resources of other identity providers (e.g. via AD Connect or AD Federation Services).

What is needed is a system that can mitigate, in near real-time, both replay and forged or manipulated ticket-based Kerberos attacks in enterprise domains.

### SUMMARY OF THE INVENTION

Accordingly, the inventor has conceived, and reduced to practice, a system and method for detecting and mitigating Kerberos ticket forgery and manipulation attacks within a domain.

In a typical embodiment, a system for detecting and mitigating forged or tampered authentication object attacks acts as an external, and non-blocking (or optionally blocking via additional integrated active measures such as user or account disablement via LDAP call) validation service for existing implementations using an authentication domain that uses a common identity provider. The system provides services to generate cryptographic hashes to legitimately-generated authentication objects, and also to check incoming authentication objects against a database of cryptographic hashes of previously-generated authentication objects (and detecting fraudulent authentication attempts by detecting attempts whose authentication objects' cryptographic hashes are not present in the database of authentication object hashes). The system may also optionally keep an active list of domain controllers and other Tier 1 resources (E.g. AD Connect servers) as part of an integrated allowlist/blocklist in memory array to aid in DC Sync and DC Shadow type attacks which are often chained together with Kerberos manipulation. The system may also allow setting of a plurality of rules or model-based (e.g. machine learning or statistical) to trigger events after certain conditions are satisfied.

In one aspect of the invention, a computer system for dynamically authenticating devices in a network, comprising a computing device, including a processor and memory, a plurality of programming instructions stored in the memory of, and operating on the processor of, the computing device, wherein the first plurality of programmable instructions, when operating on the processor, cause the computing device to: maintain a record of authentication objects associated with different users in the network; receive a first authentication object and a request for delegation from a primary user, wherein the request for delegation designates a secondary user; authenticate the primary user based on comparing the first authentication object to the record of authentication objects; generate a second authentication object associated with the secondary user, wherein the second authentication object provides a subset of privileges allowed by the primary user; add the second authentication object to the record of authentication objects; upon receiving a request by the secondary user to perform an action beyond the subset of privileges provided by the second authentication object, send a request for additional authentication information to the primary user; and upon receiving a request for revocation of delegation from the primary user, automatically remove the second authentication object from the record of authentication objects and revoke any authentication of the secondary user, is disclosed.

In another aspect of the invention, a computer-implemented method for dynamically authenticating devices in a network, comprising maintaining a record of authentication objects associated with different users in the network; receiving a first authentication object and a request for delegation from a primary user, wherein the request for delegation designates a secondary user; authenticating the primary user based on comparing the first authentication object to the record of authentication objects; generating a second authentication object associated with the secondary user, wherein the second authentication object provides a subset of privileges allowed by the primary user; adding the second authentication object to the record of authentication objects; upon receiving a request by the secondary user to perform an action beyond the subset of privileges provided by the second authentication object, sending a request for additional authentication information to the primary user; and upon receiving a request for revocation of delegation from the primary user, automatically removing the second authentication object from the record of authentication objects and revoking any authentication of the secondary user, is disclosed.

In yet another aspect of the invention, non-transitory, computer-readable storage media having computer-executable instructions embodied thereon that, when executed by one or more processors of a computing system for dynamically authenticating devices in a network, cause the computing system to maintain a record of authentication objects associated with different users in the network; receive a first authentication object and a request for delegation from a primary user, wherein the request for delegation designates a secondary user; authenticate the primary user based on comparing the first authentication object to the record of authentication objects; generate a second authentication object associated with the secondary user, wherein the second authentication object provides a subset of privileges allowed by the primary user; add the second authentication object to the record of authentication objects; upon receiving a request by the secondary user to perform an action beyond the subset of privileges provided by the second authentication object, send a request for additional authentication information to the primary user; and upon receiving a request for revocation of delegation from the primary user, automatically remove the second authentication object from the record of authentication objects and revoke any authentication of the secondary user.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a diagram of an exemplary architecture of an advanced cyber decision platform according to one aspect.

FIG. 2 is a block diagram illustrating an exemplary system architecture for a system for detecting and mitigating forged authentication object attacks according to various embodiments of the invention.

FIG. 3A is a flow diagram of an exemplary function of the business operating system in the detection and mitigation of predetermining factors leading to and steps to mitigate ongoing cyberattacks.

FIG. 3B is a process diagram showing a general flow of the process used to detect rogue devices and analyze them for threats.

FIG. 3C is a process diagram showing a general flow of the process used to detect and prevent privilege escalation attacks on a network.

FIG. 3D is a process diagram showing a general flow of the process used to manage vulnerabilities associated with patches to network software.

FIGS. 4A and 4B are process diagrams showing business operating system functions in use to mitigate cyberattacks.

FIG. 5 is a process flow diagram of a method for segmenting cyberattack information to appropriate corporation parties.

FIG. 6 is a diagram of an exemplary architecture for a system for rapid predictive analysis of very large data sets using an actor-driven distributed computational graph, according to one aspect.

FIG. 7 is a diagram of an exemplary architecture for a system for rapid predictive analysis of very large data sets using an actor-driven distributed computational graph, according to one aspect.

FIG. 8 is a diagram of an exemplary architecture for a system for rapid predictive analysis of very large data sets using an actor-driven distributed computational graph, according to one aspect.

FIG. 9 is a diagram of an exemplary architecture for a user and entity behavioral analysis system, according to one aspect.

FIG. 10 is a flow diagram of an exemplary method for cybersecurity behavioral analytics, according to one aspect.

FIG. 11 is a flow diagram of an exemplary method for measuring the effects of cybersecurity attacks, according to one aspect.

FIG. 12 is a flow diagram of an exemplary method for continuous cybersecurity monitoring and exploration, according to one aspect.

FIG. 13 is a flow diagram of an exemplary method for mapping a cyber-physical system graph (CPG), according to one aspect.

FIG. 14 is a flow diagram of an exemplary method for continuous network resilience scoring, according to one aspect.

FIG. 15 is a flow diagram of an exemplary method for cybersecurity privilege oversight, according to one aspect.

FIG. 16 is a flow diagram of an exemplary method for cybersecurity risk management, according to one aspect.

FIG. 17 is a flow diagram of an exemplary method for mitigating compromised credential threats, according to one aspect.

FIG. 18 is a flow diagram of an exemplary method for dynamic network and rogue device discovery, according to one aspect.

FIG. 19 is a flow diagram of an exemplary method for Kerberos “golden ticket” attack detection, according to one aspect.

FIG. 20 is a flow diagram of an exemplary method for risk-based vulnerability and patch management, according to one aspect.

FIG. 21 is a flow diagram of an exemplary method for establishing groups of users according to one aspect.

FIG. 22 is a flow diagram of an exemplary method for monitoring groups for anomalous behavior, according to one aspect.

FIG. 23 is a flow diagram for an exemplary method for handing a detection of anomalous behavior, according to one aspect.

FIG. 24 is a flow diagram illustrating an exemplary method for processing a new user connection, according to one aspect.

FIG. 25 is a flow diagram illustrating an exemplary method for verifying the authenticity of an authentication object, according to one aspect.

FIG. 26 is a block diagram illustrating an exemplary hardware architecture of a computing device used in various embodiments of the invention.

FIG. 27 is a block diagram illustrating an exemplary logical architecture for a client device, according to various embodiments of the invention.

FIG. 28 is a block diagram illustrating an exemplary architectural arrangement of clients, servers, and external services, according to various embodiments of the invention.

FIG. 29 is another block diagram illustrating an exemplary hardware architecture of a computing device used in various embodiments of the invention.

FIG. 30 is a block diagram illustrating a system for detecting and mitigating attacks using forged authentication objects within a domain, according to a preferred embodiment of the invention.

FIG. 31 is a flow diagram illustrating a method for detecting “golden ticket” attacks within a domain, according to an aspect of the invention.

FIG. 32 is a flow diagram illustrating a method for detecting “silver ticket” attacks within a domain, according to an aspect of the invention.

FIG. 33 is a flow diagram illustrating a method for detecting “skeleton key” attacks within a domain, according to an aspect of the invention.

FIG. 34 is a flow diagram illustrating a method for detecting compromised credentials within a domain, according to an aspect of the invention.

FIG. 35 is a flow diagram illustrating a method for detecting attacks within a domain using a ticket ledger, according to an aspect of the invention.

FIG. 36 is a flow diagram illustrating a method for automatically reporting a golden ticket attack, according to an aspect of the invention.

FIG. 37 is a flow diagram illustrating a method for mitigating a golden ticket attack without alerting the attacker, according to an aspect of the invention.

FIG. 38 is a flow diagram illustrating a method for detecting a golden SAML attack by comparing IDs in event logs, according to an aspect of the invention.

FIG. 39 is a flow diagram illustrating a method for detecting a golden SAML attack using session tagging, according to an aspect of the invention.

FIG. 40 is a message flow diagram illustrating a valid SAML authentication session for a federated service.

FIG. 41 is a message flow diagram illustrating a golden SAML attack using a forged assertion within an authentication object to gain access to a federated service.

FIG. 42 is a flow diagram illustrating a process for authentication delegation, illustrating the generation of a dependent authentication object.

FIG. 43 is a flow diagram illustrating the use of a dependent authentication object to authenticate a delegated user.

FIG. 44 is a flow diagram illustrating a process for implicit authentication using an embedded authentication object in a URL.

FIG. 45 is a block diagram illustrating an exemplary system architecture for a multi-factor authentication kiosk, according to an embodiment.

FIG. 46 is a block diagram illustrating an exemplary embodiment of a MFA kiosk deployed at a physical location for authentication of a user.

FIG. 47 is a diagram illustrating an exemplary embodiment of an MFA kiosk configured for immersive authentication.

FIG. 48 is a block diagram illustrating an exemplary embodiment of a multi-factor authentication kiosk.

FIG. 49 is a flow diagram illustrating an exemplary method for constructing a physical profile for an individual during an initial interaction with an MFA kiosk, according to an embodiment.

FIG. 50 is a flow diagram illustrating an exemplary method for providing multi-factor authentication to an individual using an MFA kiosk, according to an embodiment.

FIG. 51 is a flow diagram illustrating an exemplary method for providing multi-factor authentication to an individual using an MFA kiosk with hierarchical biometric factors, according to an embodiment.

FIG. 52 is a flow diagram illustrating an exemplary method for providing multi-factor authentication to an individual using an MFA kiosk with an authentication threshold, according to an embodiment.

FIG. 53 is a flow diagram illustrating an exemplary method for utilizing an MFA kiosk to facilitate e-commerce transactions, according to an embodiment.

FIG. 54 is a flow diagram illustrating an exemplary method for an MFA kiosk providing multi-factor authentication using an authentication score, according to an embodiment.

FIG. 55 illustrates an exemplary computing environment on which an embodiment described herein may be implemented.

FIG. 56 is a diagram of an exemplary architecture of a system for the capture and storage of time series data from sensors with heterogeneous reporting profiles according to a preferred aspect of the invention.

FIG. 57 is a diagram of an exemplary architecture of a business operating system according to a preferred aspect of the invention.

FIG. 58 is a diagram of an exemplary architecture of a cybersecurity analysis system according to a preferred aspect of the invention.

FIG. 59 is a system diagram illustrating connections between important components for analyzing software and network-connected endpoints.

FIG. 60 is a method diagram illustrating important steps in detecting and analyzing software exploits or vulnerabilities of the invention.

FIG. 61 is a method diagram illustrating the use of advanced endpoint instrumentation to collect data on endpoint devices across a network.

FIG. 62 is a method diagram illustrating the prioritization of software flaws and exploits according to a preferred aspect.

FIG. 63 is a method diagram illustrating the basic steps for patching exploits and vulnerabilities in analyzed software, according to an aspect.

FIG. 64 is a block diagram showing an exemplary overall system architecture for a holistic computer system cybersecurity evaluation and scoring system.

FIG. 65 is a block diagram showing an exemplary architecture for a software analyzer for a holistic computer system cybersecurity evaluation and scoring system.

FIG. 66 is a block diagram showing an exemplary architecture for a hardware analyzer for a holistic computer system cybersecurity evaluation and scoring system.

FIG. 67 is a block diagram showing an exemplary architecture for an operating system analyzer for a holistic computer system cybersecurity evaluation and scoring system.

FIG. 68 is a block diagram showing an exemplary architecture for a scoring engine for a holistic computer system cybersecurity evaluation and scoring system.

FIG. 69 is a block diagram illustrating an exemplary architecture for an embodiment of a holistic network cybersecurity evaluation and scoring system configured to provide hardware exploit testing on external networks utilizing virtualized network testing.

FIG. 70 is a flow diagram illustrating an exemplary method for emulating, testing, and scoring a target network using a cloud-based test host.

FIG. 71 is a flow diagram illustrating an exemplary method for processing a new user connection, according to one aspect.

FIG. 72 is a flow diagram illustrating an exemplary method for verifying the authenticity of an authentication object, according to one aspect.

FIG. 73 is a block diagram illustrating an exemplary system architecture for a system for authentication transaction toxicity scoring.

FIG. 74 is a diagram illustrating differences between global authentication record validation versus heuristic assessment validation.

FIG. 75 is a diagram illustrating an analogy between authentication transaction toxicity scoring and water quality.

FIG. 76 is a flow diagram illustrating an exemplary method for performing authentication transaction toxicity scoring.

FIG. 77 shows an exemplary matrix of organization-specific penalty functions.

FIG. 78 is a diagram illustrating an exemplary five-step model of trusted authentication for computer networks.

FIG. 79 is a block diagram illustrating an exemplary system architecture for providing dynamic authentication attack detection and enforcement at the network, application, and host level, according to an embodiment.

FIG. 80 is a flow diagram illustrating an exemplary method for providing dynamic authentication attack detection and enforcement, according to an embodiment.

FIG. 81 is a flow diagram illustrating an exemplary method for providing an intervention at the application level, according to an embodiment.

FIG. 82 is a flow diagram illustrating an exemplary method for providing an intervention at the host level, according to an embodiment.

FIG. 83 is a flow diagram illustrating an exemplary method for providing an intervention list to network or host devices, according to an embodiment.

FIG. 84 is a flow diagram illustrating an method for determining if an intervention is required using a baseline comparison, according to an embodiment.

FIG. 85 is a flow diagram illustrating an exemplary method for using custom-designed hardware on network devices to inspect packets and identify authentication objects, according to an embodiment.

### DETAILED DESCRIPTION

The inventor has conceived, and reduced to practice, a system and method for detecting and mitigating golden ticket attacks within a domain.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “graph” is a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall”, “DOB Aug. 13, 1965” and “speaks English”. Similar to the use of properties to further describe the information in a node, a relationship between two nodes that forms an edge can be qualified using a “label”. Thus, given a second node “Thomas G,” an edge between “James R” and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention

As used herein, “transformation” is a function performed on zero or more streams of input data which results in a single stream of output which may or may not then be used as input for another transformation. Transformations may comprise any combination of machine, human or machine-human interactions Transformations need not change data that enters them, one example of this type of transformation would be a storage transformation which would receive input and then act as a queue for that data for subsequent transformations. As implied above, a specific transformation may generate output data in the absence of input data. A time stamp serves as a example. In the invention, transformations are placed into pipelines such that the output of one transformation may serve as an input for another. These pipelines can consist of two or more transformations with the number of transformations limited only by the resources of the system. Historically, transformation pipelines have been linear with each transformation in the pipeline receiving input from one antecedent and providing output to one subsequent with no branching or iteration. Other pipeline configurations are possible. The invention is designed to permit several of these configurations including, but not limited to: linear, afferent branch, efferent branch and cyclical.

A “database” or “data storage subsystem” (these terms may be considered substantially synonymous), as used herein, is a system adapted for the long-term storage, indexing, and retrieval of data, the retrieval typically being via some sort of querying interface or language. “Database” may be used to refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, in-memory databases, and the like. While various aspects may preferentially employ one or another of the various data storage subsystems available in the art (or available in the future), the invention should not be construed to be so limited, as any data storage architecture may be used according to the aspects. Similarly, while in some cases one or more particular data storage needs are described as being satisfied by separate components (for example, an expanded private capital markets database and a configuration database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as an expanded private capital markets database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

A “data context”, as used herein, refers to a set of arguments identifying the location of data. This could be a Rabbit queue, a .csv file in cloud-based storage, or any other such location reference except a single event or record. Activities may pass either events or data contexts to each other for processing. The nature of a pipeline allows for direct information passing between activities, and data locations or files do not need to be predetermined at pipeline start.

A “pipeline”, as used herein and interchangeably referred to as a “data pipeline” or a “processing pipeline”, refers to a set of data streaming activities and batch activities. Streaming and batch activities can be connected indiscriminately within a pipeline. Events will flow through the streaming activity actors in a reactive way. At the junction of a streaming activity to batch activity, there will exist a StreamBatchProtocol data object. This object is responsible for determining when and if the batch process is run. One or more of three possibilities can be used for processing triggers: regular timing interval, every N events, or optionally an external trigger. The events are held in a queue or similar until processing. Each batch activity may contain a “source” data context (this may be a streaming context if the upstream activities are streaming), and a “destination” data context (which is passed to the next activity). Streaming activities may have an optional “destination” streaming data context (optional meaning: caching/persistence of events vs. ephemeral), though this should not be part of the initial implementation.

### Conceptual Architecture

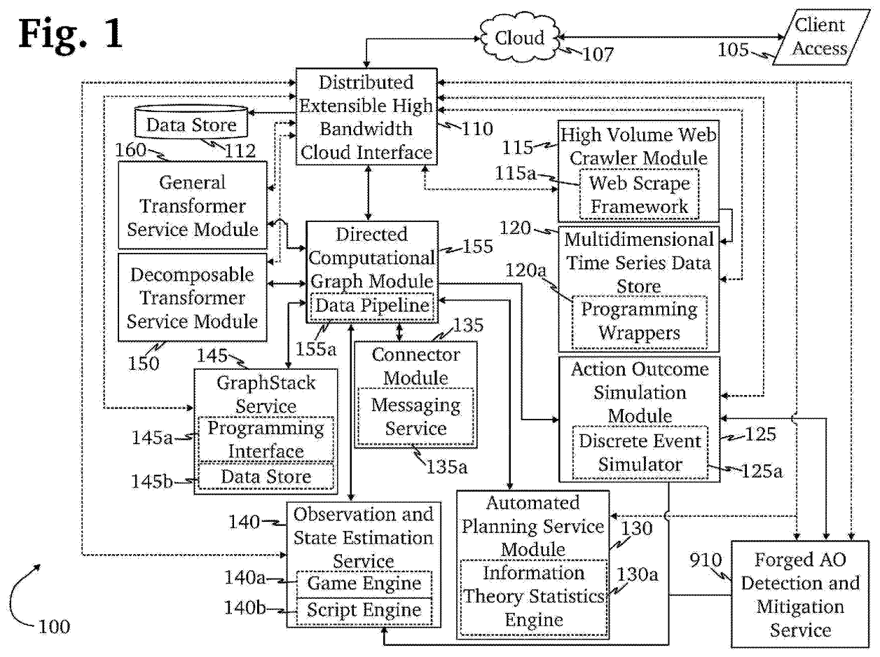

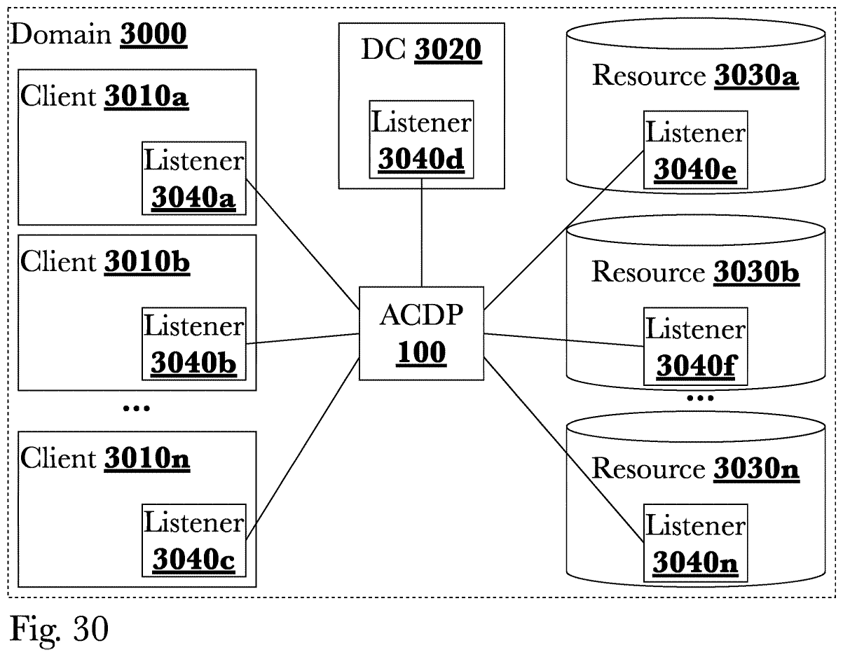

FIG. 30 is a block diagram illustrating a system for detecting and mitigating attacks using forged authentication objects (AOs) within a domain, according to a preferred embodiment of the invention. According to the embodiment, an advanced cyber decision platform (ACDP) 100 may be operated within a domain 3000, providing analysis and predictive capabilities that are discussed in greater detail below (referring to FIG. 1). A plurality of client devices 3010a-n may connect to a domain controller 3020 for authentication purposes, receiving authentication tickets as appropriate when a client passes authentication (for example, when the client device is known and provides valid credentials for an account). An identity provider such as a Kerberos domain controller (DC) 3020 authenticates devices and accounts before providing an authentication ticket comprising an authentication object to a requesting device, which is then used to access resources 3030a-n within the domain according to the privileges given to the ticketholder's account. This facilitates single sign-on (SSO) within a domain and minimizes the risks associated with passing credentials between devices in a network, as the user authenticates once and is issued a ticket that may then be checked at each resource to determine an access level, rather than requiring the user to sign on at each resource individually.

Additionally, known active domain controllers and other tier 1 resources (such as AD Connect servers or other authorities) may be cached in memory to enable protection against chained attacks such as (for example, including but not limited to) DC Sync or DC Shadow type attacks. The cached list of tier 1 resources may be used to apply whitelist and blacklist functionality to these resources, which in turn may be used to provide a baseline level of protection through “default-blacklist” and other configurations that may be stored and applied using the cached list. This improves protection against these forms of attack without the need to configure rules for individual tier 1 resources, instead providing a rules-based approach that can be easily applied to changing lists of known and trusted resources.

More particularly, a client device 3010a-n first requests a SSO ticket (also referred to as a ticket-granting-ticket, or TGT) from the DC 3020. The DC returns a TGT that is encrypted using a key known only to the DC, which is then stored on the client device. When the client device attempts to access a resource 3030a-n on the network, it provides the TGT to the domain controller where it is checked for validity (for example, ensuring that the account is valid and the ticket has not expired), and if valid the account is checked for access privileges to the requested resource. If access is permitted, the DC returns a ticket and session key specific to the requesting client and the resource being accessed, allowing the user to access the resource transparently without the need for additional sign-on (as the tickets and keys are exchanged in the background without user involvement, and typically the exchange occurs rapidly with no apparent delay in accessing the resource).

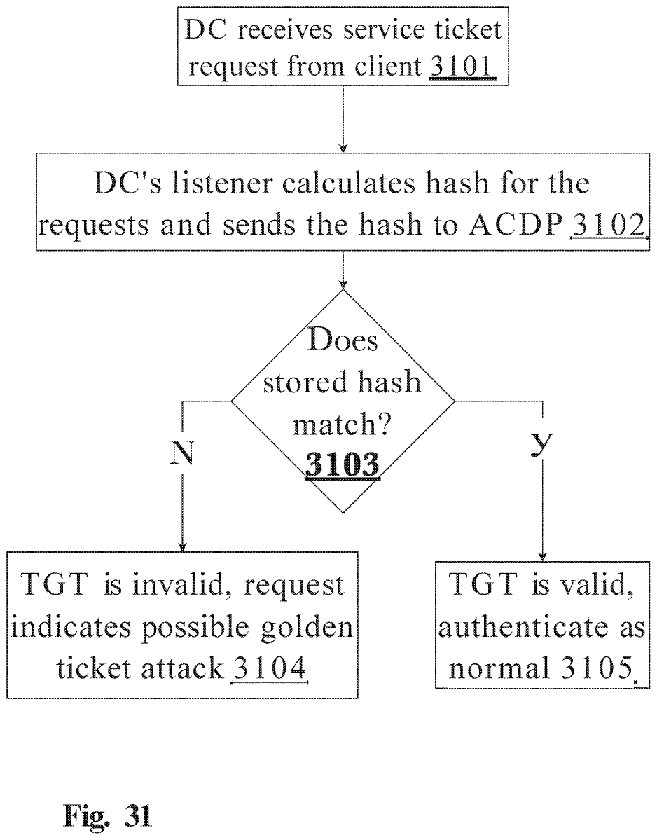

In traditional arrangements, this architecture is vulnerable to a variety of ticket-based attacks involving forged tickets, such as a “golden ticket” attack wherein a TGT is forged and used to obtain full domain administrator privileges (for example, by manufacturing tickets for falsified accounts with full privileges within the domain), or a “silver ticket” attack where a ticket is forged for a specific account by exploiting information that is ordinarily inaccessible in memory on a client device. To detect and mitigate this category of threats, a plurality of listeners 3040a-n may be installed on each of the client devices, the domain controller, and any connected resources within the domain. Each listener passively collects cryptographic hashes for tickets exchanged between the DC and clients, which may then (by the ACDP) be compared against previous hashes for known-issued tickets. Attacks may then be identified based on hash mismatches, such as (for example) detecting a golden ticket attack by identifying a client passing a TGT when no TGT was previously issued to the client, or detecting a silver ticket attack by identifying when a client is passing a service ticket when no such service ticket was issued to that client. The specific threat identification methods are described below in greater detail, with reference to FIGS. 31-37.

FIG. 1 is a diagram of an exemplary architecture of an advanced cyber decision platform (ACDP) 100 according to one aspect. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™ CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

For example, the Information Assurance department is notified by the system 100 that principal X is using credentials K (Kerberos Principal Key) never used by it before to access service Y. Service Y utilizes these same credentials to access secure data on data store Z. This correctly generates an alert as suspicious lateral movement through the network and will recommend isolation of X and Y and suspension of K based on continuous baseline network traffic monitoring by the multidimensional time series data store 120 programmed to process such data 120a, rigorous analysis of the network baseline by the directed computational graph 155 with its underlying general transformer service module 160 and decomposable transformer service module 150 in conjunction with the AI and primed machine learning capabilities 130a of the automated planning service module 130 which had also received and assimilated publicly available from a plurality of sources through the multi-source connection APIs of the connector module 135. Ad hoc simulations of these traffic patterns are run against the baseline by the action outcome simulation module 125 and its discrete event simulator 125a which is used here to determine probability space for likelihood of legitimacy. The system 100, based on this data and analysis, was able to detect and recommend mitigation of a cyberattack that represented an existential threat to all business operations, presenting, at the time of the attack, information most needed for an actionable plan to human analysts at multiple levels in the mitigation and remediation effort through use of the observation and state estimation service 140 which had also been specifically preprogrammed to handle cybersecurity events 140b.

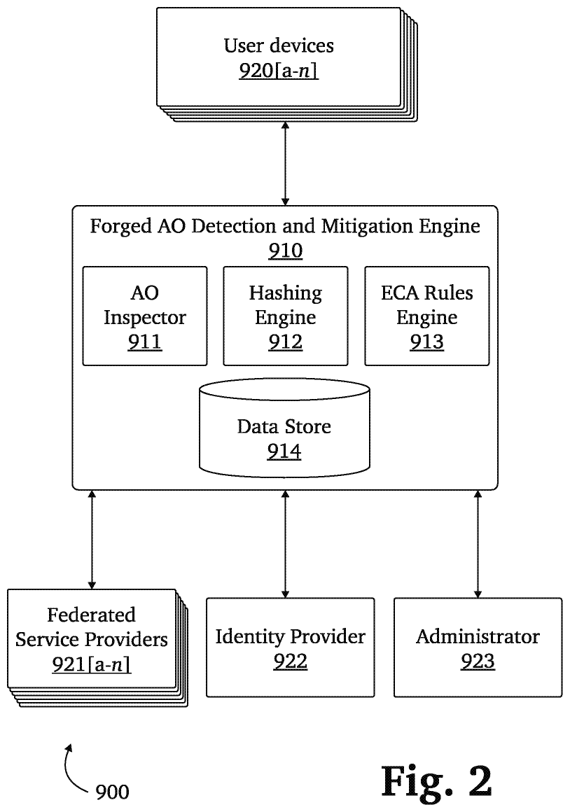

A forged authentication object detection and mitigation service 910 may be used to detect and mitigate cyberattacks stemming from the use of authentication objects generated by an attacker. Service 910 is discussed in further detail below in FIG. 2.

According to one aspect, the advanced cyber decision platform, a specifically programmed usage of the business operating system, continuously monitors a client enterprise's normal network activity for behaviors such as but not limited to normal users on the network, resources accessed by each user, access permissions of each user, machine to machine traffic on the network, sanctioned external access to the core network and administrative access to the network's identity and access management servers in conjunction with real-time analytics informing knowledge of cyberattack methodology. The system then uses this information for two purposes: First, the advanced computational analytics and simulation capabilities of the system are used to provide immediate disclosure of probable digital access points both at the network periphery and within the enterprise's information transfer and trust structure and recommendations are given on network changes that should be made to harden it prior to or during an attack. Second, the advanced cyber decision platform continuously monitors the network in real-time both for types of traffic and through techniques such as deep packet inspection for pre-decided analytically significant deviation in user traffic for indications of known cyberattack vectors such as, but not limited to, ACTIVE DIRECTORY™/Kerberos pass-the-ticket attack, ACTIVE DIRECTORY™/Kerberos pass-the-hash attack and the related ACTIVE DIRECTORY™/Kerberos overpass-the-hash attack, ACTIVE DIRECTORY™/Kerberos Skeleton Key, ACTIVE DIRECTORY™/Kerberos golden and silver ticket attack, privilege escalation attack, compromised user credentials, ransomware disk attacks, and forged authentication object attack (also may be referred to as authentication tickets). When suspicious activity at a level signifying an attack (for example, including but not limited to skeleton key attacks, pass-the-hash attacks, or attacks via compromised user credentials) is determined, the system issues action-focused alert information to all predesignated parties specifically tailored to their roles in attack mitigation or remediation and formatted to provide predictive attack modeling based upon historic, current, and contextual attack progression analysis such that human decision makers can rapidly formulate the most effective courses of action at their levels of responsibility in command of the most actionable information with as little distractive data as possible. The system then issues defensive measures in the most actionable form to end the attack with the least possible damage and exposure. All attack data are persistently stored for later forensic analysis.

FIG. 2 is a block diagram illustrating an exemplary system architecture 900 for a system 910 for detecting and mitigating forged authentication object attacks according to various embodiments of the invention. Architecture 900 may comprise system 910 acting as a non-blocking intermediary between a connecting user 920 [a-n], a plurality of federated service providers (SP) 921a-n, an identity provider (IdP) 922, and an administrative user 923.

System 910 may be configured to verifying incoming connections when the user has an AO, and also keeps track of legitimately generated AO's. System 910 may comprise an AO inspector 911, a hashing engine 912, an event-condition-action (ECA) rules engine 913, and a data store 914.

AO inspector 911 may be configured to use faculties of ACDP 100, for example DCG module 155 and associated transformer modules to analyze and process AO's associated with incoming connections, and observation and state estimation services 140 to monitor connections for incoming AO's. Incoming AO's may be retrieved for further analysis by system 910.

Hashing engine 912 may be configured to calculate a cryptographic hash for AOs generated by identity provider 922 using functions of ACDP 100, such as DCG module 155, generate a cryptographic hash for both incoming AO's (for analysis purposes), and new AO's created by IdP 922. A one-way hash may be used to allow protecting of sensitive information contained in the AO, but preserving uniqueness of each AO. Generated hashes may be stored in data store 914. Hashing engine may also run a hash check function, used for validating incoming AO's.

ECA rules engine 913 may be used by a network administrator to create and manage ECA rules that may trigger actions and queries in the event of detection of a forged AO. Rules may be for example, tracking and logging the actions of the suspicious user, deferring the suspicious connection, and the like. Rules may be nested to create a complex flow of various conditional checks and actions to create a set of “circuit breaker” checks to further ascertain the connection, or try and resolve the matter automatically before notifying a human network administrator.

Data store 914 may be a graph and time-series hybrid database, such as multidimensional time-series data store 120 or data store 112, that stores hashes, ECA rules, log data, and the like, and may be quickly and efficiently queried and processed using ACDP 100.

Federated service providers 921a-n may comprise a group of trusted service partners that may share a common IdP 922 in which user 920 [a-n] may wish to access. Federated service providers 921a-n may be, for instance, services employing MICROSOFT'S ACTIVE DIRECTORY FEDERATED SERVICES (AS DS), AZURE AD, OKTA, many web browser single-sign-on (SSO) implementations, cloud service provides (such as, AMAZON AWS, AZURE, and GOOGLE), and the like.

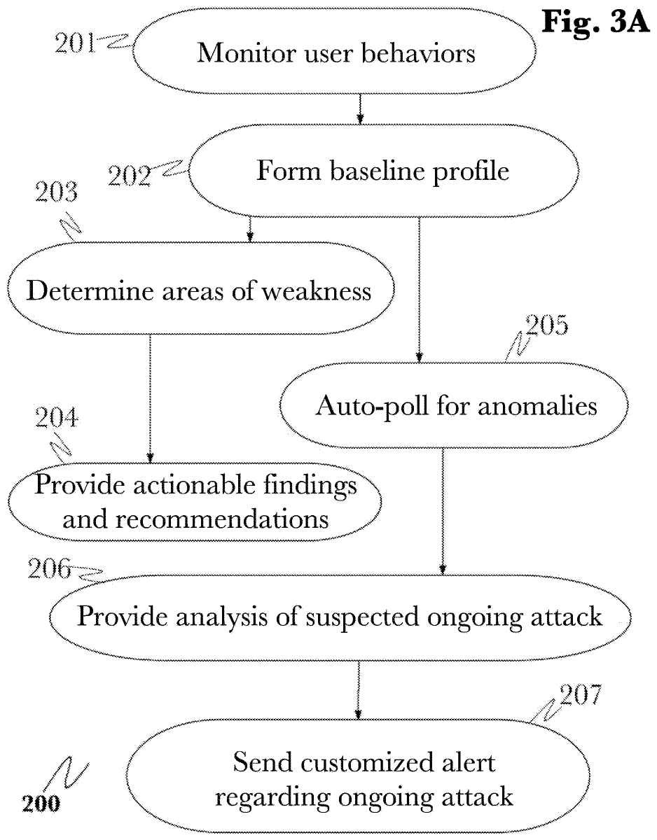

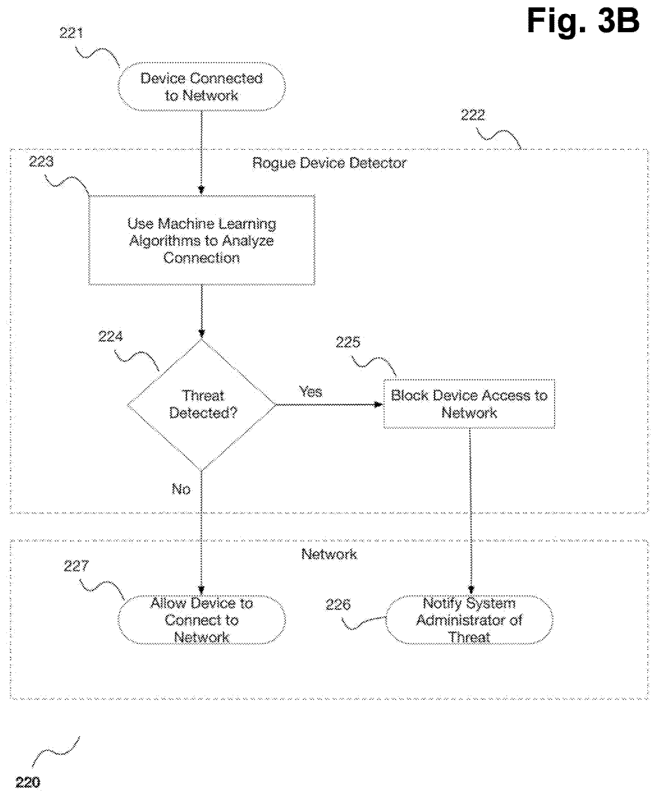

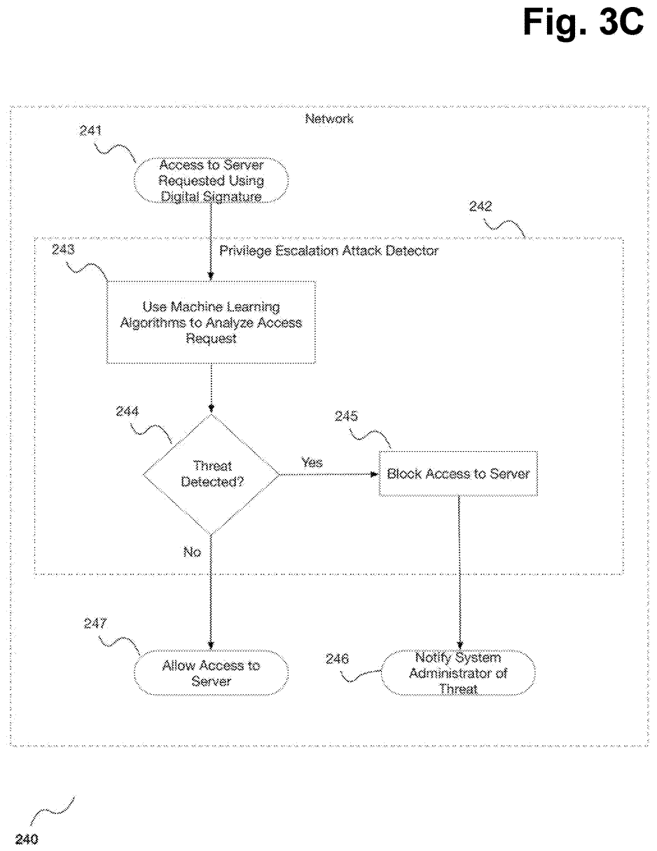

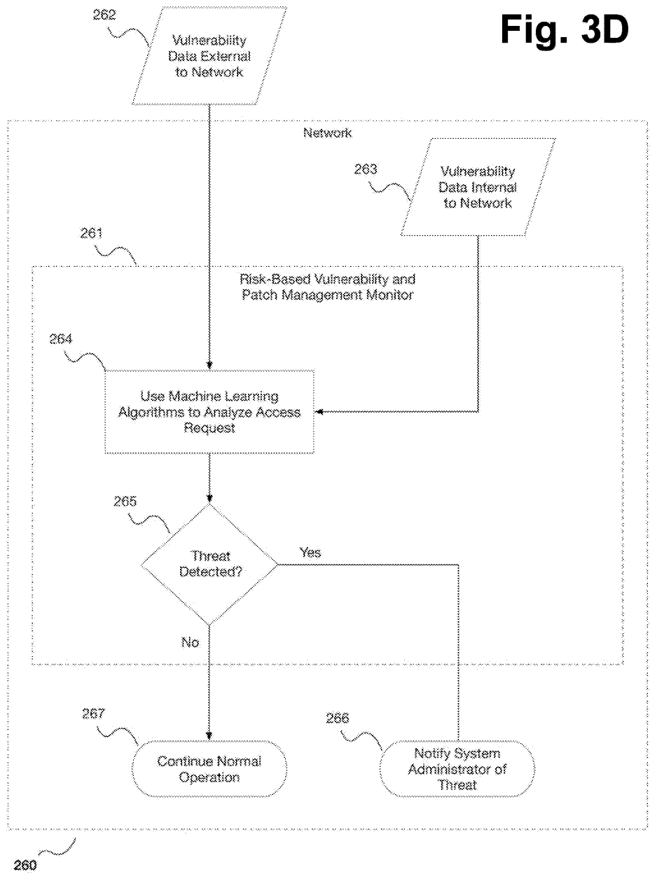

FIG. 3A is a flow diagram of an exemplary function of the business operating system in the detection and mitigation of predetermining factors leading to and steps to mitigate ongoing cyberattacks 200. The system continuously retrieves network traffic data 201 which may be stored and preprocessed by the multidimensional time series data store 120 and its programming wrappers 120a. All captured data are then analyzed to predict the normal usage patterns of network nodes such as internal users, network connected systems and equipment and sanctioned users external to the enterprise boundaries for example off-site employees, contractors and vendors, just to name a few likely participants. Of course, normal other network traffic may also be known to those skilled in the field, the list given is not meant to be exclusive and other possibilities would not fall outside the design of the invention. Analysis of network traffic may include graphical analysis of parameters such as network item to network usage using specifically developed programming in the graphstack service 145, 145a, analysis of usage by each network item may be accomplished by specifically pre-developed algorithms associated with the directed computational graph module 155, general transformer service module 160 and decomposable service module 150, depending on the complexity of the individual usage profile 201. These usage pattern analyses, in conjunction with additional data concerning an enterprise's network topology; gateway firewall programming; internal firewall configuration; directory services protocols and configuration; and permissions profiles for both users and for access to sensitive information, just to list a few non-exclusive examples may then be analyzed further within the automated planning service module 130, where machine learning techniques which include but are not limited to information theory statistics 130a may be employed and the action outcome simulation module 125, specialized for predictive simulation of outcome based on current data 125a may be applied to formulate a current, up-to-date and continuously evolving baseline network usage profile 202. This same data would be combined with up-to-date known cyberattack methodology reports, possibly retrieved from several divergent and exogenous sources through the use of the multi-application programming interface aware connector module 135 to present preventative recommendations to the enterprise decision makers for network infrastructure changes, physical and configuration-based to cost effectively reduce the probability of a cyberattack and to significantly and most cost effectively mitigate data exposure and loss in the event of attack 203, 204.

While some of these options may have been partially available as piecemeal solutions in the past, we believe the ability to intelligently integrate the large volume of data from a plurality of sources on an ongoing basis followed by predictive simulation and analysis of outcome based upon that current data such that actionable, business practice efficient recommendations can be presented is both novel and necessary in this field.

Once a comprehensive baseline profile of network usage using all available network traffic data has been formulated, the specifically tasked business operating system continuously polls the incoming traffic data for activities anomalous to that baseline as determined by pre-designated boundaries 205. Examples of anomalous activities may include a user attempting to gain access several workstations or servers in rapid succession, or a user attempting to gain access to a domain server of server with sensitive information using random userIDs or another user's userID and password, or attempts by any user to brute force crack a privileged user's password, or replay of recently issued ACTIVE DIRECTORY™/Kerberos ticket granting tickets, or using a forged Kerberos ticket, or the presence on any known, ongoing exploit on the network or the introduction of known malware to the network, just to name a very small sample of the cyberattack profiles known to those skilled in the field. The invention, being predictive as well as aware of known exploits is designed to analyze any anomalous network behavior, formulate probable outcomes of the behavior, and to then issue any needed alerts regardless of whether the attack follows a published exploit specification or exhibits novel characteristics deviant to normal network practice. Once a probable cyberattack is detected, the system then is designed to get needed information to responding parties 206 tailored, where possible, to each role in mitigating the attack and damage arising from it 207. This may include the exact subset of information included in alerts and updates and the format in which the information is presented which may be through the enterprise's existing security information and event management system. Network administrators, then, might receive information such as but not limited to where on the network the attack is believed to have originated, what systems are believed currently affected, predictive information on where the attack may progress, what enterprise information is at risk and actionable recommendations on repelling the intrusion and mitigating the damage, whereas a chief information security officer may receive alert including but not limited to a timeline of the cyberattack, the services and information believed compromised, what action, if any has been taken to mitigate the attack, a prediction of how the attack may unfold and the recommendations given to control and repel the attack 207, although all parties may access any network and cyberattack information for which they have granted access at any time, unless compromise is suspected. Other specifically tailored updates may be issued by the system 206, 207.

FIG. 3B is a process diagram showing a general flow of the process used to detect rogue devices and analyze them for threats 220. Whenever a device is connected to the network 221, the connection is immediately sent to the rogue device detector 222 for analysis. As disclosed below at 300, the advanced cyber decision platform uses machine learning algorithms to analyze system-wide data to detect threats. The connected device is analyzed 223 to assess its device type, settings, and capabilities, the sensitivity of the data stored on the server to which the device wishes to connect, network activity, server logs, remote queries, and a multitude of other data to determine the level of threat associated with the device. If the threat reaches a certain level 224, the device is automatically prevented from accessing the network 225, and the system administrator is notified of the potential threat, along with contextually-based, tactical recommendations for optimal response based on potential impact 226. Otherwise, the device is allowed to connect to the network 227.

FIG. 3C is a process diagram showing a general flow of the process used to detect and prevent privilege escalation attacks on a network (for example, “Golden Ticket” attacks) 240. When access to a server within the network is requested using a digital signature or AO 241, the connection is immediately sent to the privilege escalation attack detector 242 for analysis. As disclosed below at 300, the advanced cyber decision platform uses machine learning algorithms to analyze system-wide data to detect threats. The access request is analyzed 243 to assess the validity of the access request using the digital signature validation, plus other system-wide information such as the sensitivity of the server being accessed, the newness of the digital signature or AO, the digital signature's or AO's prior usage, and other measures of the digital signature's or AO's validity. If the assessment determines that the access request represents a significant threat 244, even despite the Kerberos validation of the digital signature or validation of a AO, the access request is automatically denied 245, and the system administrator is notified of the potential threat, along with contextually-based, tactical recommendations for optimal response based on potential impact 246. Otherwise, the access request is granted 247.

FIG. 3D is a process diagram showing a general flow of the process used to manage vulnerabilities associated with patches to network software 260. As part of a continuously-operating risk-based vulnerability and patch management monitor 261, data is gathered from both sources external to the network 262 and internal to the network 263. As disclosed below at 300, the advanced cyber decision platform uses machine learning algorithms to analyze system-wide data to detect threats. The data is analyzed 264 to determine whether network vulnerabilities exist for which a patch has not yet been created and/or applied. If the assessment determines that such a vulnerability exists 265, whether or not all software has been patched according to manufacturer recommendations, the system administrator is notified of the potential vulnerability, along with contextually-based, tactical recommendations for optimal response based on potential impact 266. Otherwise, network activity is allowed to continue normally 267.

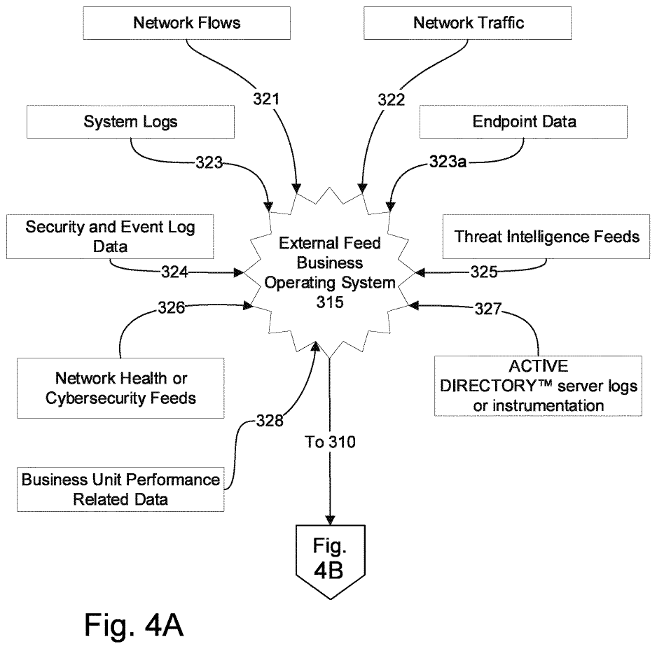

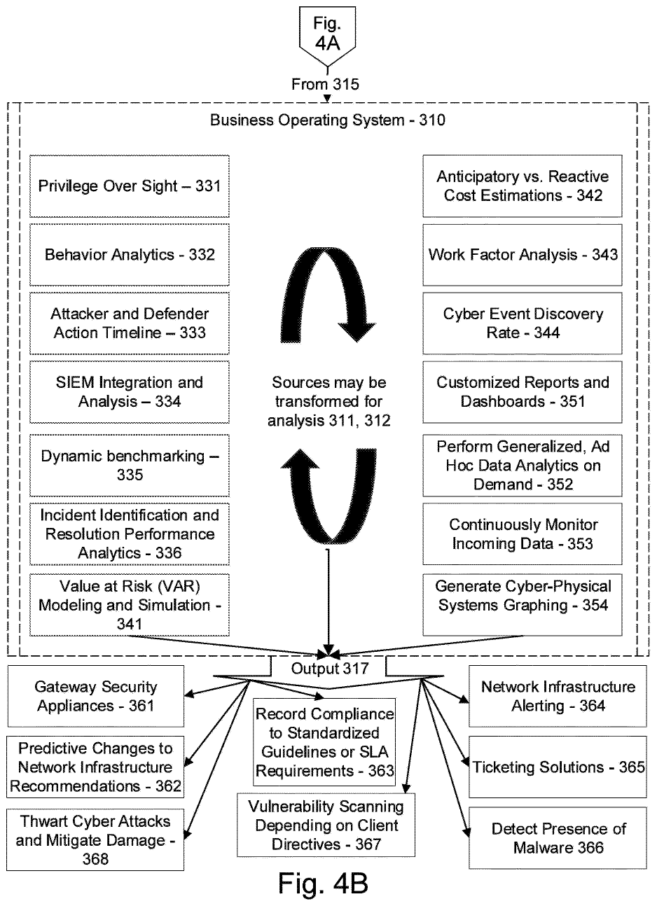

FIGS. 4A and 4B are process diagrams showing a general flow 300 of business operating system functions in use to mitigate cyberattacks. Input network data which may include network flow patterns 321, the origin and destination of each piece of measurable network traffic 322, system logs from servers and workstations on the network 323, endpoint data 323a, any security event log data from servers or available security information and event (SIEM) systems 324, external threat intelligence feeds 324a, identity or assessment context 325, external network health or cybersecurity feeds 326, Kerberos domain controller or ACTIVE DIRECTORY™ server logs or instrumentation 327 and business unit performance related data 328, among many other possible data types for which the invention was designed to analyze and integrate, may pass into 315 the business operating system 310 for analysis as part of its cyber security function. These multiple types of data from a plurality of sources may be transformed for analysis 311, 312 using at least one of the specialized cybersecurity, risk assessment or common functions of the business operating system in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the business operating system's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 368, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, and perform one time or continuous vulnerability scanning depending on client directives 367. These examples are, of course, only a subset of the possible uses of the system, they are exemplary in nature and do not reflect any boundaries in the capabilities of the invention.

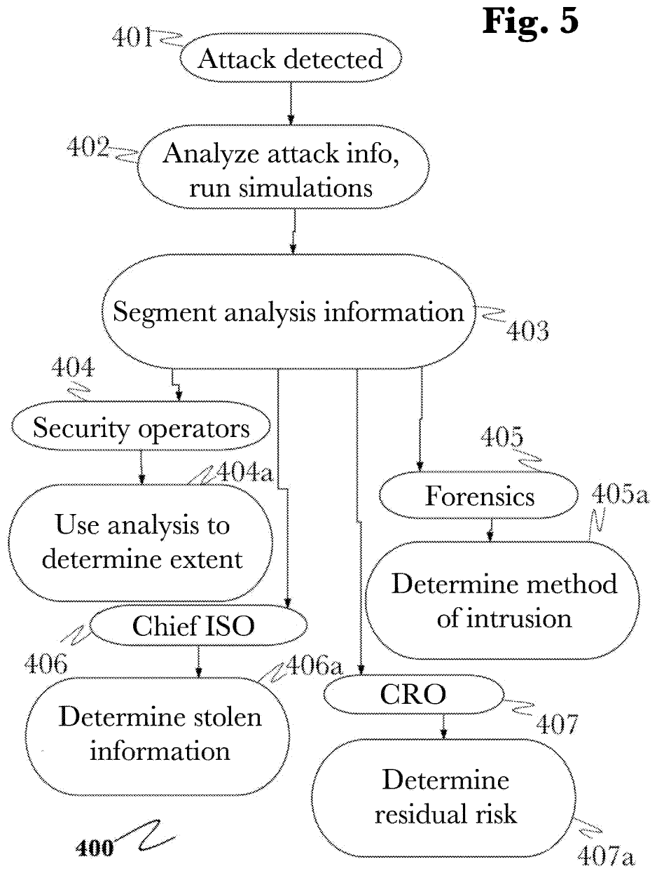

FIG. 5 is a process flow diagram of a method for segmenting cyberattack information to appropriate corporation parties 400. As previously disclosed 200, 351, one of the strengths of the advanced cyber-decision platform is the ability to finely customize reports and dashboards to specific audiences, concurrently is appropriate. This customization is possible due to the devotion of a portion of the business operating system's programming specifically to outcome presentation by modules which include the observation and state estimation service 140 with its game engine 140a and script interpreter 140b. In the setting of cybersecurity, issuance of specialized alerts, updates and reports may significantly assist in getting the correct mitigating actions done in the most timely fashion while keeping all participants informed at predesignated, appropriate granularity. Upon the detection of a cyberattack by the system 401 all available information about the ongoing attack and existing cybersecurity knowledge are analyzed, including through predictive simulation in near real time 402 to develop both the most accurate appraisal of current events and actionable recommendations concerning where the attack may progress and how it may be mitigated. The information generated in totality is often more than any one group needs to perform their mitigation tasks. At this point, during a cyberattack, providing a single expansive and all inclusive alert, dashboard image, or report may make identification and action upon the crucial information by each participant more difficult, therefore the cybersecurity focused arrangement may create multiple targeted information streams each concurrently designed to produce most rapid and efficacious action throughout the enterprise during the attack and issue follow-up reports with and recommendations or information that may lead to long term changes afterward 403. Examples of groups that may receive specialized information streams include but may not be limited to front line responders during the attack 404, incident forensics support both during and after the attack 405, chief information security officer 406 and chief risk officer 407 the information sent to the latter two focused to appraise overall damage and to implement both mitigating strategy and preventive changes after the attack. Front line responders may use the cyber-decision platform's analyzed, transformed and correlated information specifically sent to them 404a to probe the extent of the attack, isolate such things as: the predictive attacker's entry point onto the enterprise's network, the systems involved or the predictive ultimate targets of the attack and may use the simulation capabilities of the system to investigate alternate methods of successfully ending the attack and repelling the attackers in the most efficient manner, although many other queries known to those skilled in the art are also answerable by the invention. Simulations run may also include the predictive effects of any attack mitigating actions on normal and critical operation of the enterprise's IT systems and corporate users. Similarly, a chief information security officer may use the cyber-decision platform to predictively analyze 406a what corporate information has already been compromised, predictively simulate the ultimate information targets of the attack that may or may not have been compromised and the total impact of the attack what can be done now and in the near future to safeguard that information. Further, during retrospective forensic inspection of the attack, the forensic responder may use the cyber-decision platform 405a to clearly and completely map the extent of network infrastructure through predictive simulation and large volume data analysis. The forensic analyst may also use the platform's capabilities to perform a time series and infrastructural spatial analysis of the attack's progression with methods used to infiltrate the enterprise's subnets and servers. Again, the chief risk officer would perform analyses of what information 407a was stolen and predictive simulations on what the theft means to the enterprise as time progresses. Additionally, the system's predictive capabilities may be employed to assist in creation of a plan for changes of the IT infrastructural that should be made that are optimal for remediation of cybersecurity risk under possibly limited enterprise budgetary constraints in place at the company so as to maximize financial outcome.

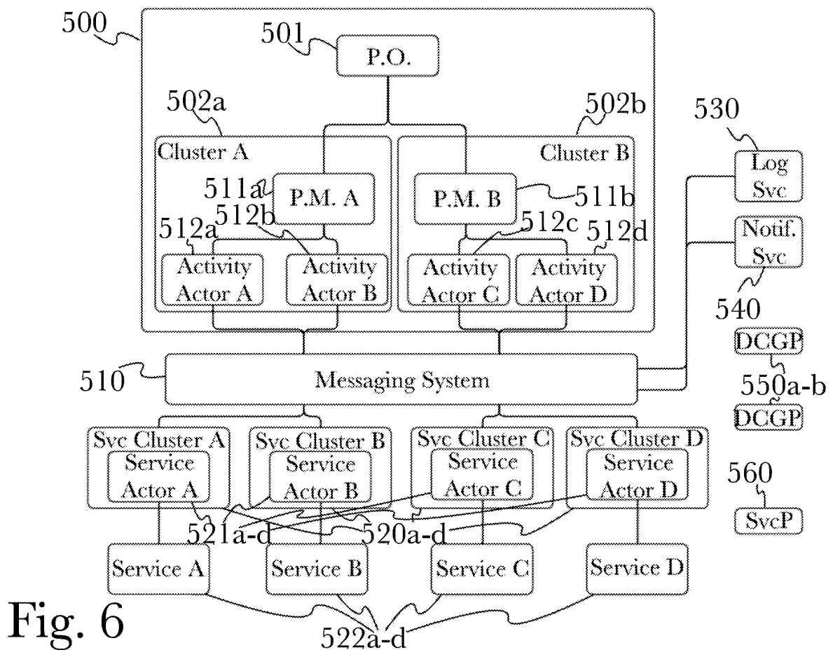

FIG. 6 is a diagram of an exemplary architecture for a system for rapid predictive analysis of very large data sets using an actor-driven distributed computational graph 500, according to one aspect. According to the aspect, a DCG 500 may comprise a pipeline orchestrator 501 that may be used to perform a variety of data transformation functions on data within a processing pipeline, and may be used with a messaging system 510 that enables communication with any number of various services and protocols, relaying messages and translating them as needed into protocol-specific API system calls for interoperability with external systems (rather than requiring a particular protocol or service to be integrated into a DCG 500).

Pipeline orchestrator 501 may spawn a plurality of child pipeline clusters 502a-b, which may be used as dedicated workers for streamlining parallel processing. In some arrangements, an entire data processing pipeline may be passed to a child cluster 502a for handling, rather than individual processing tasks, enabling each child cluster 502a-b to handle an entire data pipeline in a dedicated fashion to maintain isolated processing of different pipelines using different cluster nodes 502a-b. Pipeline orchestrator 501 may provide a software API for starting, stopping, submitting, or saving pipelines. When a pipeline is started, pipeline orchestrator 501 may send the pipeline information to an available worker node 502a-b, for example using AKKA™ clustering. For each pipeline initialized by pipeline orchestrator 501, a reporting object with status information may be maintained. Streaming activities may report the last time an event was processed, and the number of events processed. Batch activities may report status messages as they occur. Pipeline orchestrator 501 may perform batch caching using, for example, an IGFS™ caching filesystem. This allows activities 512a-d within a pipeline 502a-b to pass data contexts to one another, with any necessary parameter configurations.

A pipeline manager 511a-b may be spawned for every new running pipeline, and may be used to send activity, status, lifecycle, and event count information to the pipeline orchestrator 501. Within a particular pipeline, a plurality of activity actors 512a-d may be created by a pipeline manager 511a-b to handle individual tasks, and provide output to data services 522a-d. Data models used in a given pipeline may be determined by the specific pipeline and activities, as directed by a pipeline manager 511a-b. Each pipeline manager 511a-b controls and directs the operation of any activity actors 512a-d spawned by it. A pipeline process may need to coordinate streaming data between tasks. For this, a pipeline manager 511a-b may spawn service connectors to dynamically create TCP connections between activity instances 512a-d. Data contexts may be maintained for each individual activity 512a-d, and may be cached for provision to other activities 512a-d as needed. A data context defines how an activity accesses information, and an activity 512a-d may process data or simply forward it to a next step. Forwarding data between pipeline steps may route data through a streaming context or batch context.

A client service cluster 530 may operate a plurality of service actors 521a-d to serve the requests of activity actors 512a-d, ideally maintaining enough service actors 521a-d to support each activity per the service type. These may also be arranged within service clusters 520a-d, in a manner similar to the logical organization of activity actors 512a-d within clusters 502a-b in a data pipeline. A logging service 530 may be used to log and sample DCG requests and messages during operation while notification service 540 may be used to receive alerts and other notifications during operation (for example to alert on errors, which may then be diagnosed by reviewing records from logging service 530), and by being connected externally to messaging system 510, logging and notification services can be added, removed, or modified during operation without impacting DCG 500. A plurality of DCG protocols 550a-b may be used to provide structured messaging between a DCG 500 and messaging system 510, or to enable messaging system 510 to distribute DCG messages across service clusters 520a-d as shown. A service protocol 560 may be used to define service interactions so that a DCG 500 may be modified without impacting service implementations. In this manner it can be appreciated that the overall structure of a system using an actor-driven DCG 500 operates in a modular fashion, enabling modification and substitution of various components without impacting other operations or requiring additional reconfiguration.

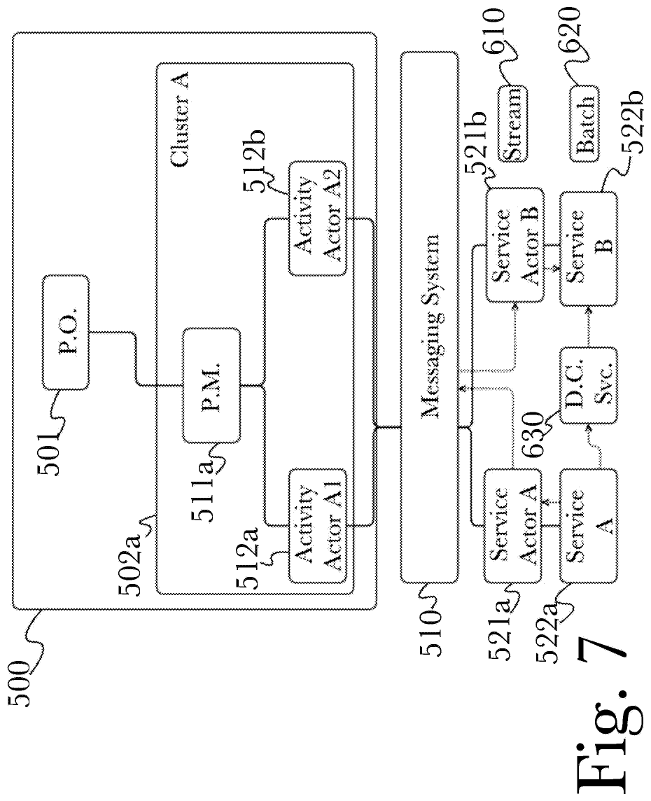

FIG. 7 is a diagram of an exemplary architecture for a system for rapid predictive analysis of very large data sets using an actor-driven distributed computational graph 500, according to one aspect. According to the aspect, a variant messaging arrangement may utilize messaging system 510 as a messaging broker using a streaming protocol 610, transmitting and receiving messages immediately using messaging system 510 as a message broker to bridge communication between service actors 521a-b as needed. Alternately, individual services 522a-b may communicate directly in a batch context 620, using a data context service 630 as a broker to batch-process and relay messages between services 522a-b.

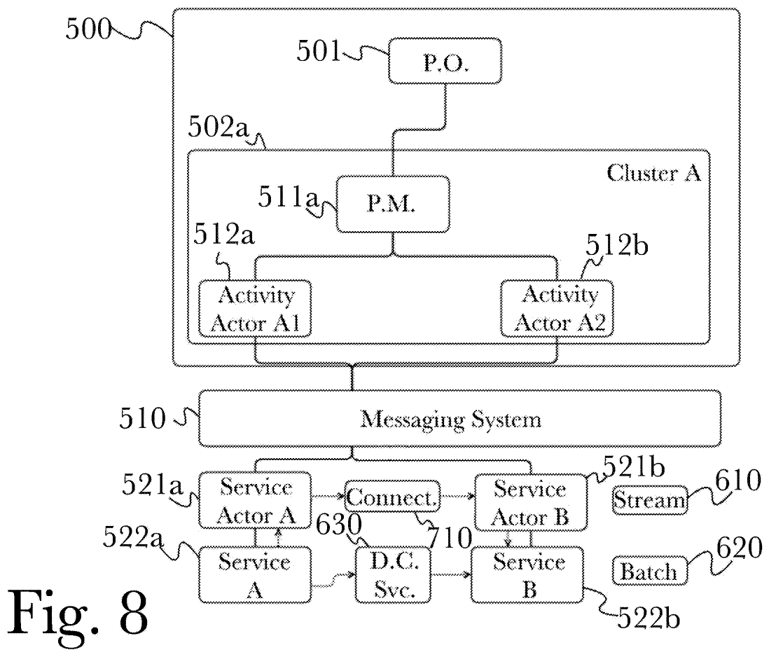

FIG. 8 is a diagram of an exemplary architecture for a system for rapid predictive analysis of very large data sets using an actor-driven distributed computational graph 500, according to one aspect. According to the aspect, a variant messaging arrangement may utilize a service connector 710 as a central message broker between a plurality of service actors 521a-b, bridging messages in a streaming context 610 while a data context service 630 continues to provide direct peer-to-peer messaging between individual services 522a-b in a batch context 620.

It should be appreciated that various combinations and arrangements of the system variants described above (referring to FIGS. 1A-8) may be possible, for example using one particular messaging arrangement for one data pipeline directed by a pipeline manager 511a-b, while another pipeline may utilize a different messaging arrangement (or may not utilize messaging at all). In this manner, a single DCG 500 and pipeline orchestrator 501 may operate individual pipelines in the manner that is most suited to their particular needs, with dynamic arrangements being made possible through design modularity as described above in FIG. 6.

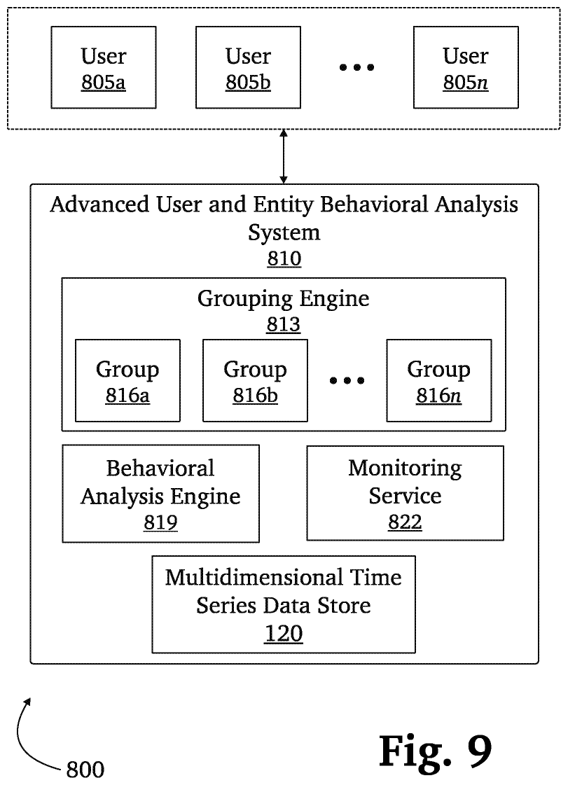

Another way to detect cyberthreats may be through the continuous monitoring and analysis of user and device behavioral patterns. This method may be particularly useful when there is little info available on an exploit, for example, a newly developed malware. FIG. 9 is a diagram of an exemplary architecture 800 for a user and entity behavioral analysis system, according to one aspect. Architecture 800 may comprise a plurality of users 805a-n, which may be individuals or connected devices, connecting to a user and entity behavioral analysis system 810. System 810 may comprise a grouping engine 813, a behavioral analysis engine 819, a monitoring service 822, and a multidimensional time series data store 120 for storing gathered and processed data. Grouping engine 813 may be configured to gather and identify user interactions and related metrics, which may include volume of interaction, frequency of interaction, and the like. Grouping engine 813 may use graph stack service 145 and DCG module 155 to convert and analyze the data in graph format. The interaction data may then be used to split users 805a-n into a plurality of groups 816a-n. Groupings may be based on department, project teams, interaction frequency, and other metrics which may be user-defined. Groupings may not be permanent, and may be adjusted and changed in real-time as group dynamics change. This may be automated by system 810, or an administrative user may manually change the groupings.

Behavioral analysis engine 819 may batch process and aggregate overall usage logs, access logs, Kerberos session data, or data collected through the use of other network monitoring tools commonly used in the art such as BRO or SURICATA. The aggregated data may then be used to generate a behavioral baseline for each group established by grouping engine 813. Behavioral analysis engine 819 may use graph stack service 145 and DCG module 155 to convert and analyze the data in graph format using various machine learning models, and may also process the data using parallel computing to quickly process large amounts of data. Models may be easily added to the system. Behavioral analysis engine 819 may also be configured to process internal communications, such as email, using natural language processing. This may provide additional insight into current group dynamics so that a more accurate baseline may be established, or may provide an insight into health and mood of users.

Monitoring service 822 may actively monitor groups for anomalous behavior, as based the established baseline. For example, monitoring service 822 may use the data pipelines of ACDP system 100 or multidimensional time series data store 120 to conduct real-time monitoring of various network resource sensors. Aspects that may be monitored may include, but is not limited to, anomalous web browsing, for example, the number of distinct domains visited exceeding a predefined threshold; anomalous data exfiltration, for example, the amount of outgoing data exceeding a predefined threshold; unusual domain access, for example, a subgroup consisting a few members within an established group demonstrating unusual browsing behavior by accessing an unusual domain a predetermined number of times within a certain timeframe; anomalous login times, for example, a user logging into a workstation during off-hours; unlikely login locations, for example, a user logging in using an account from two distinct locations that may be physically impossible within a certain timeframe; anomalous service access, for example, unusual application access or usage pattern; and new machines, for example, a user logging into a machine or server not typically accessed.

### Detailed Description of Exemplary Aspects

FIG. 31 is a flow diagram illustrating a method for detecting “golden ticket” attacks within a domain, according to an aspect of the invention. In a golden ticket attack, a malicious actor forges a TGT using compromised information (such as information dumped from memory on a client device connected to the domain, regardless of the authentication tickets actually issued to that client device), and then uses this falsified TGT to grant themselves domain administrator access. According to the method, a DC 3020 configured with a passive listener (as described above, with reference to FIG. 30) receives a request for a service ticket from a client (also known as a “principal” according to the Kerberos authentication protocol) 3101, the request including a TGT. The listener calculates a hash for the included TGT 3102, and sends the hash to ACDP 100. ACDP 100 then checks 3103 for a stored hash for the requesting client, which would indicate that the TGT is valid and was previously issued to this client for use in requesting service tickets for resource access. If no existing hash is found, or an existing hash does not match the one provided, this indicates that the TGT has been forged or altered and there is a high risk that the service ticket request is part of a golden ticket attack being used to obtain illicit access to domain resources 3104. If an existing hash is found that does match the one provided, this indicates that the TGT is valid for the requesting client, and the service ticket requests may be authorized and authentication proceeds as normal 3105.

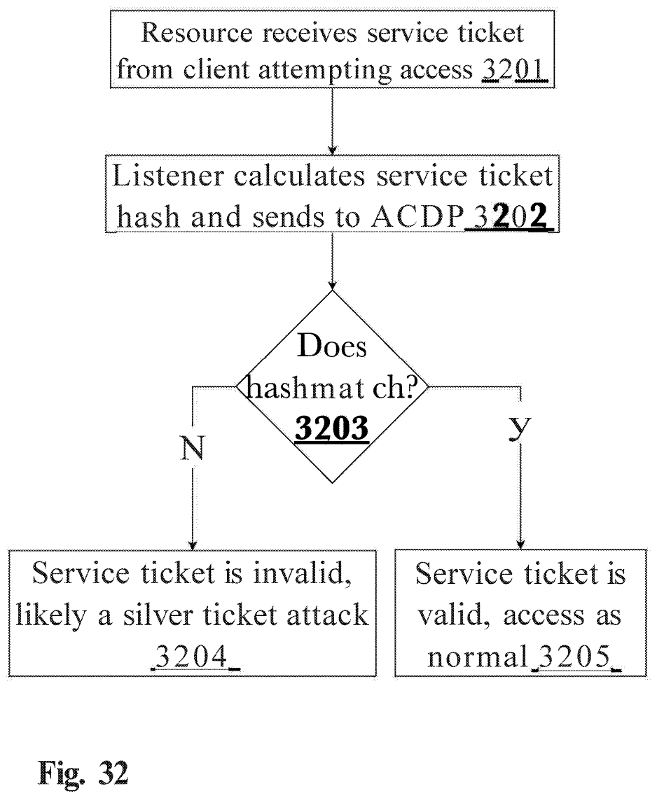

FIG. 32 is a flow diagram illustrating a method for detecting “silver ticket” attacks within a domain, according to an aspect of the invention. A silver ticket attack involves a malicious actor forging a service ticket, rather than the TGT involved in a golden ticket attack. According to the method, a resource configured with a passive listener (as described above, with reference to FIG. 30) receives a service ticket from a client (also known as a “principal” according to the Kerberos authentication protocol) 3201. The listener calculates a hash for the service ticket 3202, and sends the hash to ACDP 100. ACDP 100 then checks 3203 for a stored hash for the client, which would indicate that the service ticket is valid and was previously issued to this client for use in accessing the respective resource. If no existing hash is found, or an existing hash does not match the one provided, this indicates that the service ticket has been forged or altered and there is a high risk that the service ticket is part of a silver ticket attack being used to obtain illicit access to domain resources 3204. If an existing hash is found that does match the one provided, this indicates that the service ticket is valid for the client and resource, and the client may be authorized to access the resource as normal 3205.

Golden and silver ticket attacks may be detected using this hash-based approach, as forged tickets generated by malicious software contain formatting anomalies such as empty fields that would be populated if the TGT was properly-issued and valid. These anomalies result in a different hash being created than the one created for a valid TGT issued by the DC, thereby making the forged ticket obvious upon inspection. Once such an attack has been detected, care must be taken not to alert the malicious actor that they have been discovered, as they may abandon the attack prematurely and prevent the collection of important information such as from where the attack originated or what access paths were used, what was accessed using the forged ticket, or what the intent of the attack may have been. Therefore, when a golden or silver ticket attack is discovered, a domain administrator may identify compromised accounts involved in the attack and choose to disable all but a selection of low-risk accounts; this may prevent the attacker from accessing sensitive information or causing damage to internal resources, while still allowing them some degree of activity to conceal their discovery while the administrator continues to analyze the attack.

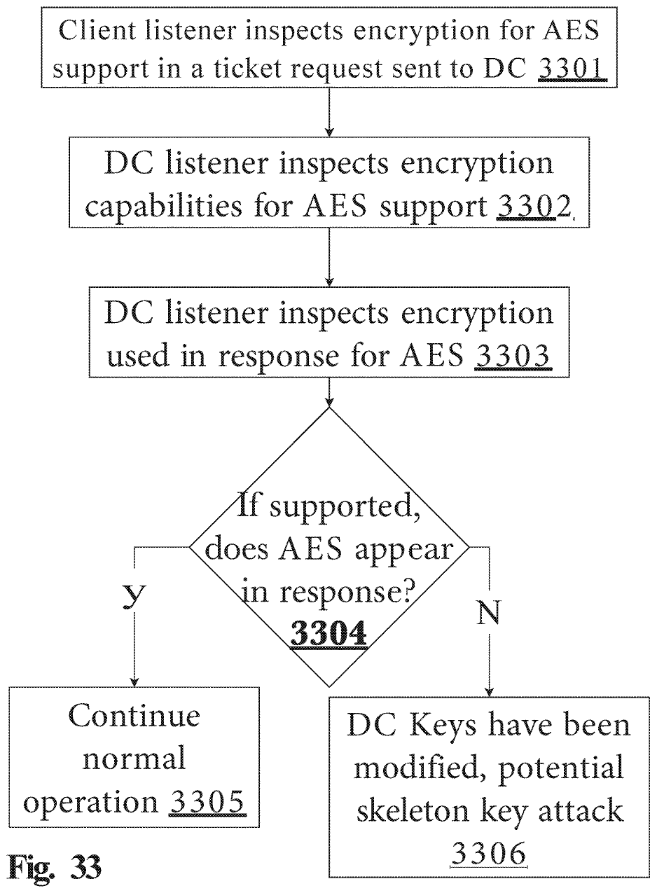

FIG. 33 is a flow diagram illustrating a method for detecting “skeleton key” attacks within a domain, according to an aspect of the invention. In a skeleton key attack, a malicious actor modifies stored keys on a DC to grant themselves the ability to change the master password, enabling additional attacks as they can take control of the DC and perform such actions as granting tickets or creating new accounts with full privileges within the domain. According to the method, a listener operating on a client device may inspect the client's advertised encryption types within a ticket request to determine if AES is supported 3301. A listener operating on a DC may similarly inspect the DC's advertised encryption types for AES support 3302, as well as inspecting the encryption that appears in a DC response to the ticket request 3303 to determine whether AES encryption is used 3304. If AES is used in the response, operation continues as normal 3305. However, if AES is supported by both the client and DC yet does not appear in the response, this indicates that the keys stored by the DC have been tampered with 3306, potentially as part of a skeleton key attack wherein an attacker manipulates stored keys to implant a modified key that allows use of a new master password to grant them access.

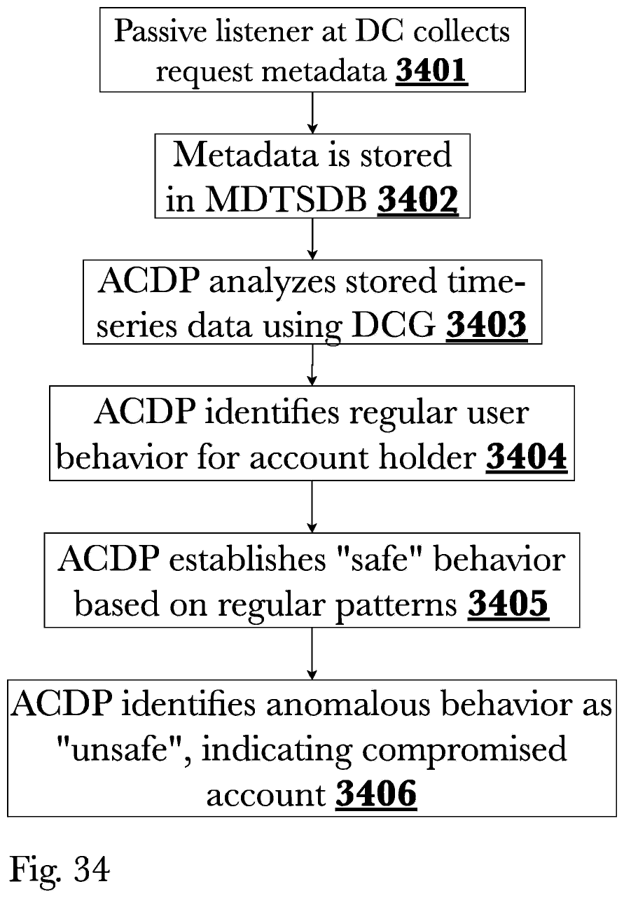

FIG. 34 is a flow diagram illustrating a method for detecting compromised credentials within a domain, according to an aspect of the invention. In an attack using compromised credentials, a malicious actor takes control of a domain account and uses that account to access resources and perform actions while masquerading as the accountholder. According to the method, a listener operating on a DC may collect metadata on received requests 3401, such as (for example, including but not limited to) username, timestamp, location, device ID, or success/failure of each request. This information may then be stored in a multidimensional time-series database (MDTSDB) 3402 with associated timestamp information. This stored time-series data may then be analyzed using a directed computational graph (DCG) 3403 to identify regular patterns of user behavior 3404 and establish a baseline of “safe” behavior 3405. When DCG analysis indicates activity outside the normal parameters, this may indicate a compromised user account 3406, such as when a malicious actor connects using stolen credentials and behaves in a manner inconsistent with the actual accountholder.

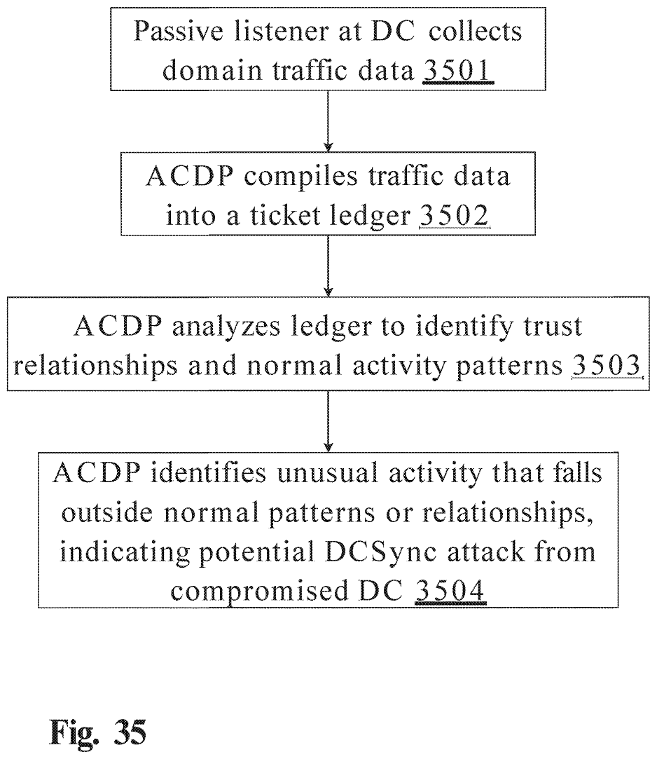

FIG. 35 is a flow diagram illustrating a method for detecting attacks within a domain using a ticket ledger, according to an aspect of the invention. These attacks may include exploits known as “DCSync”, “DCShadow”, and “Kerberoasting”. In a DCSync attack, a malicious actor that has already obtained administrator privileges (such as through a golden ticket attack) mimics a valid domain admin account in order to request additional information from the DC, such as user passwords and account information. In a DCShadow attack, a malicious actor that has already obtained administrator privileges (such as through a golden ticket attack) mimics a domain controller to inject new data into the domain records while bypassing the normal security protocols that would prevent a nonprivileged account from modifying records. Both of these attack types require administrator access and can be identified using a ticket ledger collected over time using listeners within a domain. In a Kerberoasting attack, a malicious actor does not require a compromised account or any obtained privileges (unlike with DCSync and DCShadow). A malicious actor also does not need to send any packets to a DC or client in order to effect the compromise; information may be collected in memory by simply connecting a device to a domain, and then it may be dumped from memory and compromised offline. The actor may then reconnect and use obtained information such as account credentials, to obtain access within the domain and potentially continue with additional attacks (for example, escalating to a silver or golden ticket attack to obtain administrator access).

According to the method, a listener operating on a DC may collect traffic information within the domain 3501, allowing an ACDP to compile the traffic data and build a ledger of issued tickets within the domain 3502. This ledger may be analyzed by the ACDP to identify trust relationships between domain controllers and clients 3503. Any unusual activity, such as a DC admin account request from an account that is ordinarily unusued or has no involvement with the clients for which is requesting data, may be identified as falling outside the known relationships 3504. This unusual activity may then indicate that an administrator account is acting unusually (such as requesting information for users with which it has no established trust relationship), or new information may suddenly appear that may indicate that records have been modified as part of a DCShadow attack. Spikes in activity levels may be used as an indicator of a Kerberoasting attack, indicating an account requesting or being issued more tickets than normal, which may serve as an indicator of a compromised account that may have had its credentials cracked in a Kerberoasting exploit.

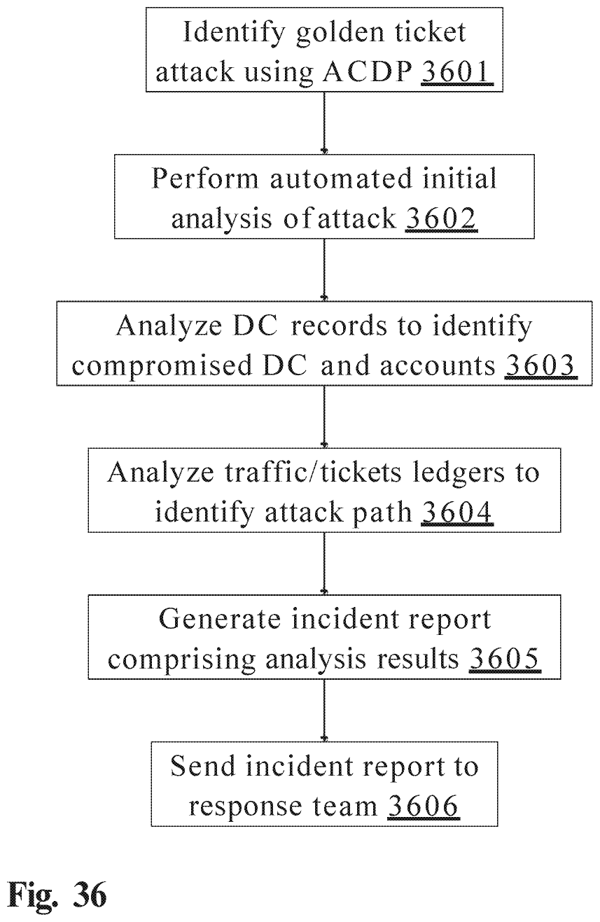

FIG. 36 is a flow diagram illustrating a method for automatically reporting a golden ticket attack, according to an aspect of the invention. According to the method, when a golden ticket attack is recognized 3601 (as described above, with reference to FIG. 31) an ACDP may determine the extent of the attack 3602. For example, a domain controller's records may be analyzed to determine any compromised accounts or domain controllers 3603 that may require immediate action, and traffic and ticket ledger records (as detailed above, with reference to FIG. 35) may be analyzed to identify an attack vector, i.e. the path used by the attacker to gain access to the domain 3604. ACDP may then generate a detailed incident report 3605 comprising the attack information and initial analysis. This incident report is then sent to an administrator or response team as an urgent notification 3606, providing the details of the attack so a remediation strategy may be implemented immediately.

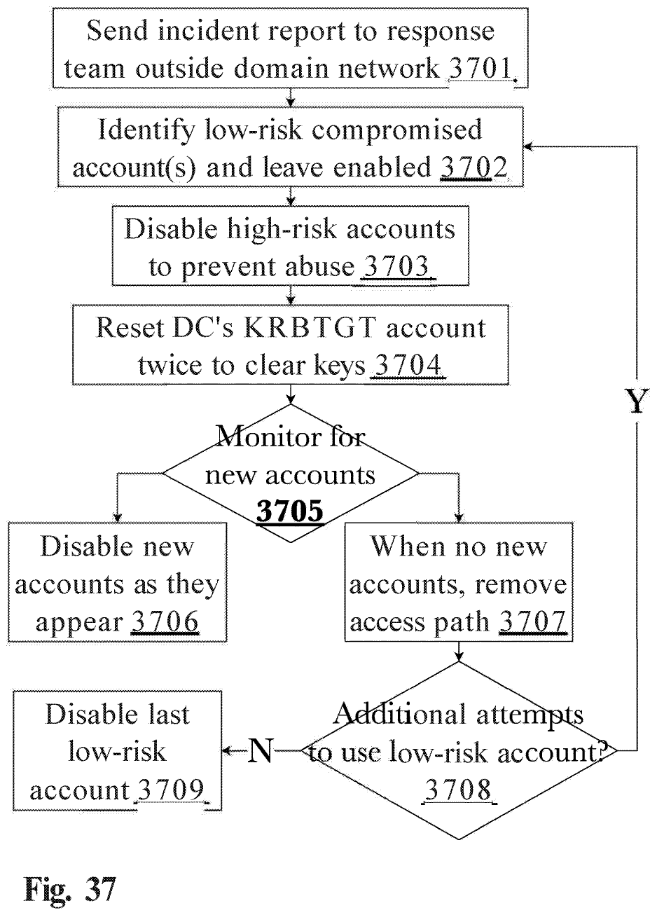

FIG. 37 is a flow diagram illustrating a method for mitigating a golden ticket attack without alerting the attacker, according to an aspect of the invention. According to the method, once an incident report is received 3701 indicating a golden ticket attack is underway, care must be taken not to undermine response efforts by alerting the attacker prematurely. If alerted, the attacker may abandon the attack before any meaningful analysis can be performed, whereas a careful mitigation effort allows the attack a degree of low-risk access while the attack is analyzed to obtain as much information as possible and facilitate more thorough remediation (such as hardening systems against an exploited vulnerability, patching discovered access paths, or other such responses that are only possible with knowledge about the attack that took place). To reduce the risk of alerting the attacker, a response team may be alerted 3701 outside the domain network, for example via telephone, and no incident records are left on networked systems where an attacker may discover them. The response team may then perform mitigation measures while allowing the attacker limited capability while the attack is further analyzed.

Mitigation may begin with identifying low-risk compromised accounts (that is, the lowest-risk account or accounts among those confirmed to be compromised in the attack underway) to keep enabled 3702, allowing the attacker a controlled degree of access while mitigation and analysis continue. Higher-risk accounts may then be disabled 3703, preventing them from being used to access internal resources by the attacker. The domain controller's KRBTGT account (that is, the administrative account that issues and authenticates ticket-granting tickets) must then be reset twice 3704, as a single reset only clears the current password while the previous keys persist in memory and can still be used to authenticate already-issued tickets the attacker may have obtained. This prevents the attacker from obtaining additional tickets (as they can no longer authenticate against the DC's new account) and limits their access with current tickets by clearing the authentication keys. The response team may then monitor for any additional compromised accounts 3705, disabling as needed 3706. When no new compromised accounts appear after a time, the attack path may be removed while leaving a low-risk compromised account enabled 3707 to monitor for any additional attempted attacks using the same account 3708. If a new attack is attempted, such as the known compromised account attempting a different access path, the mitigation process repeats for the new attack. When no attempts have been made after a time, the last compromised account may be disabled to prevent re-use 3709.

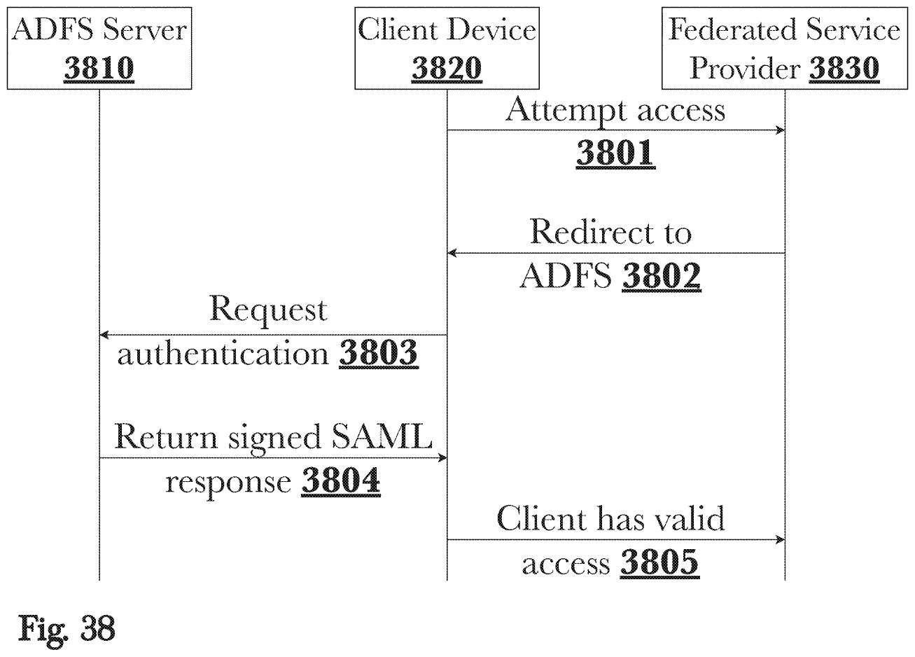

FIG. 38 is a message flow diagram illustrating a valid SAML authentication session for a federated service. When a client device 3820 attempts to access 3801 a federated service 3830, the service provider redirects the client 3802 to an ADFS server 3810 to request 3803 authentication. The ADFS server validates the client's credentials and returns a signed SAML authentication response 3804 containing an authentication object that may be presented to the federated service provider to verify the client and grant access to the service 3805. In this usage, clients are authenticated prior to any access to a federated service, using an ADFS server maintained locally within the client's domain in communication with an identity provider such as a KERBEROS™ domain controller to enforce authentication for domain clients. Once authenticated, a client has access to the federated services outside the domain, allowing SSO for cloud-based and distributed services.

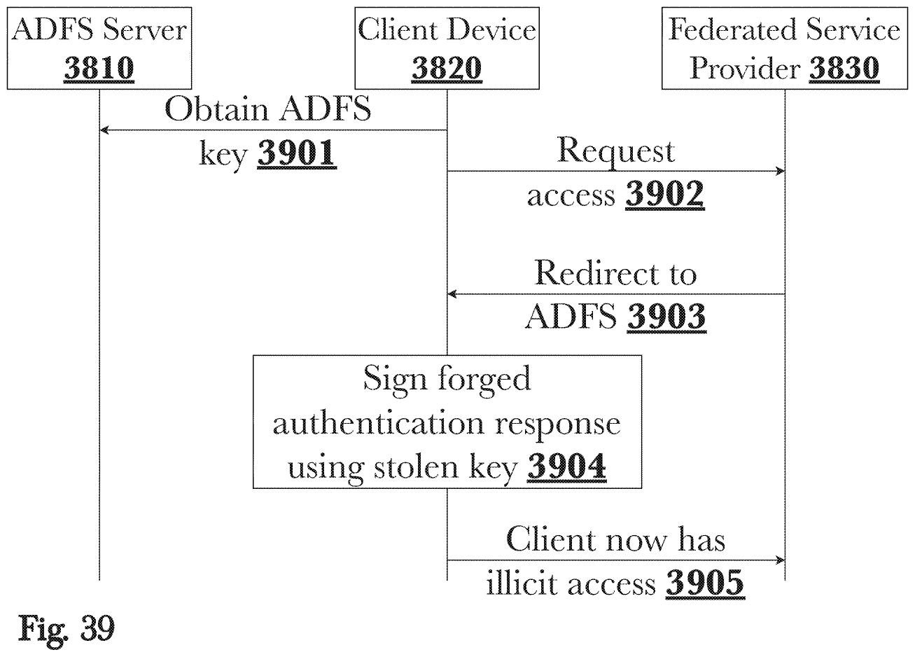

FIG. 39 is a message flow diagram illustrating a golden SAML attack using a forged authentication object to gain access to a federated service. In a golden SAML attack, a client 3820 first compromises 3901 a local ADFS server 3810 to acquire the ADFS key used to sign authentication responses (as described above in FIG. 30). The client then attempts normal access 3902 to a federated service 3830, which prompts a redirection to ADFS for authentication 3903. The client then uses the stolen authentication key to sign a forged authentication response 3904, granting itself access as needed using the stolen credentials obtained from the ADFS server previously. At this point, the client has now obtained illicit access to the federated service 3905, and can continue to grant itself access to any SAML-enabled service using SSO by simply forging and signing authentication responses as needed to imitate a legitimately-authenticated session by an ADFS server.

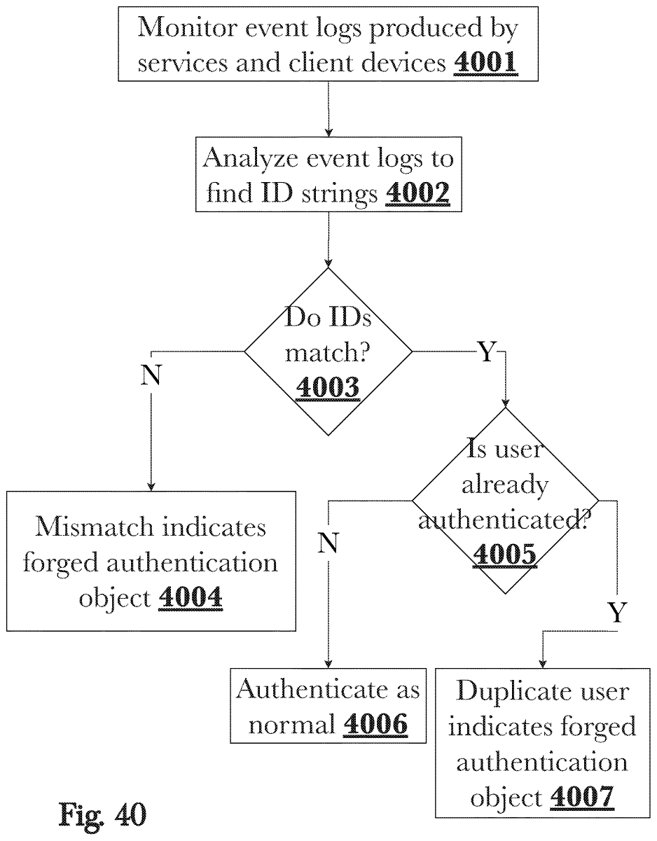

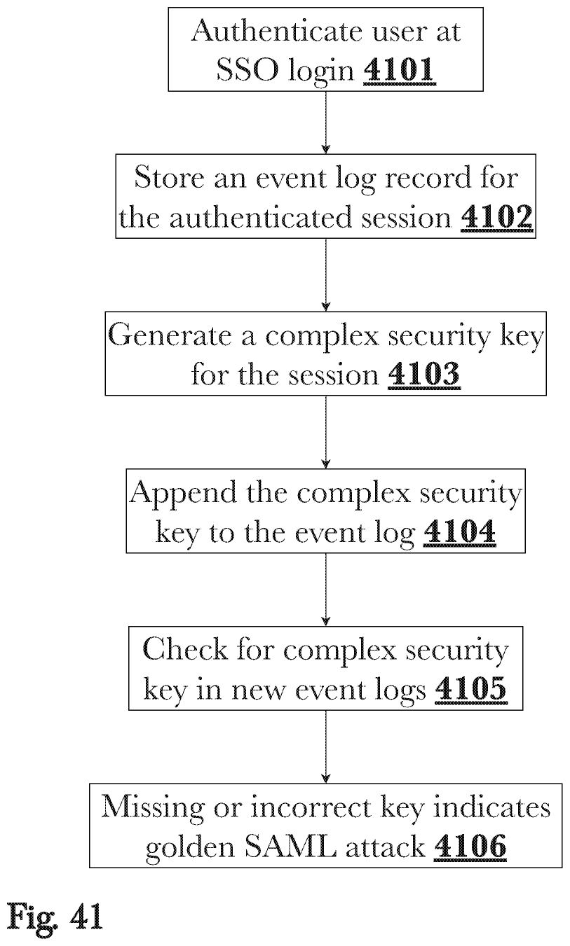

FIG. 40 is a flow diagram illustrating a method for detecting a golden SAML attack by comparing IDs in event logs, according to an aspect of the invention. When a user authenticates with a federated service provider 921a-n such as (for example) AWS™ or other cloud-based products or services (as described below, referring to FIG. 2), event logs such as (for example, including but not limited to) AWS™ logs or WINDOWS™ event logs (WELs) on an Active Directory Federated Services (ADFS) server, according to what event logs are available for access, may be analyzed to detect SAML forgery attacks such as those using “golden SAML”. Golden SAML attacks use a forged authentication object to authenticate across SAML-enabled services using SSO, effectively gaining access to any federated services without needing to compromise any particular accounts or domain controllers, enabling global access to these services without compromising any particular domain controller or client devices within a domain. By monitoring and analyzing event logs these forged authentication objects may be detected, enabling a response team to respond quickly to the attack as described below in greater detail, with reference to FIG. 41.

According to the method shown in FIG. 40, an event log (such as WEL on an ADFS server, or an event log for a particular federated service such as AWS™ or MICROSOFT™ OFFICE 365™) may be monitored for activity 4001, such as new events being written to the log (indicating service activity). Logs may be analyzed 4002 either in real-time (that is, analyzing each new event as it is logged) or in batches (such as scheduled analysis of log files, or manually-triggered analysis of a defined set of logs, or other such batch operations), and checked for unique ID tokens such as SAMLAssertionID found in a service's event log as well as a SamlSession GUID found in a Windows event log (WEL) of the identity provider, as shown in the exemplary SAML code segments below.

The following is an example of a SAML event log record, showing the SAMLAssertionID field containing a unique string that may be checked and compared against a known valid session to determine if the event indicates a forged authentication object and thus a golden SAML attack. This record appears in a WEL entry on an ADFS server, where it may be monitored and analyzed by the operator of the server without needing direct access to logs for any connected federated services. This enables any business to monitor for golden SAML attacks on their own ADFS servers, without needing access to logs generated by services operated by outside entities.

```
″requestParameters″: {
  ″SAMLAssertionID″: ″_e76f6004-cdcb-4580-9a8c-43c160633133″, ″roleSessionName″:
″sample@email.com″, ″durationSeconds″: 3600,
  ″roleArn″: ″arn:aws:iam::227545963958:role/ADFS-ec2-readonly″, ″principalArn″:
″arn:aws:iam::227545963958:saml-provider/idp1″
}
```

These IDs are stored in log entries, both in event logs for a federated service (to which a business may not have access, making them less useful in detection) or on an ADFS server operated by a business (where they may be actively monitored and analyzed easily) as strings that can be identified with text-based searching and matching, and in a valid authentication request (that is, one wherein a user has a valid authentication object issued by a domain controller that grants them access to a service) the IDs will match between the WEL record on the ADFS server granting authorization, and the WEL record of the access response from a federated service; that is, the ID that was granted access by the ADFS server should match the ID that was granted access by the federated service. In a golden SAML attack, a forged authentication object produces a mismatch in these IDs (in other words, an ID is given access to a federated service, but no authorization record for the ID exists in the ADFS log because it was forged), so the log records are compared 4003 to determine if the IDs are a match; if there is a mismatch 4005 this indicates a forged authentication object and serves as positive identification of an attack 4004, and if the IDs match the username (or account ID, or other user-specific unique identifier) may then be checked 4005 to determine if this user has already authenticated. If the user has not already authenticated, then authentication proceeds as normal 4006; however, if the user has already authenticated, this duplicate request indicates a forged authentication object and identifies an attack wherein the attacker is attempting to duplicate an existing user's credentials 4007.

FIG. 41 is a flow diagram illustrating a method for detecting and mitigating a golden SAML attack using session tagging, according to an aspect of the invention. With session tagging, authentication requests within a domain may be tagged with specially-created metadata to identify each valid session and identify invalid sessions arising from a golden SAML attack. According to the method, when an identity provider successfully authenticates a user (e.g., the user's initial login within a domain using SSO for federated services) 4101 a record is created for the user's authenticated session in an event log 4102. A QOMPLX® security cookie may be created 4103 for the valid authentication session, that uniquely identifies that specific authenticated session. The security cookie may then be added to a DC's database 4104 associated with the authentication object issued to the user, ensuring that all future objects issued for that user now include the QOMPLX® security cookie. This security cookie may then be checked in event logs 4105, and any invalid records (for example, records of a user authenticating against a federated service, wherein the user's authentication object was missing the security cookie) indicate a golden SAML attack 4106 wherein an attacker has forged an assertion to gain access, but as a result has not been issued a valid security cookie. This method ensures reliable detection of golden SAML attacks by creating additional unique metadata for known authenticated sessions, preventing session forgery and making authentication attempts using forged objects immediately obvious.

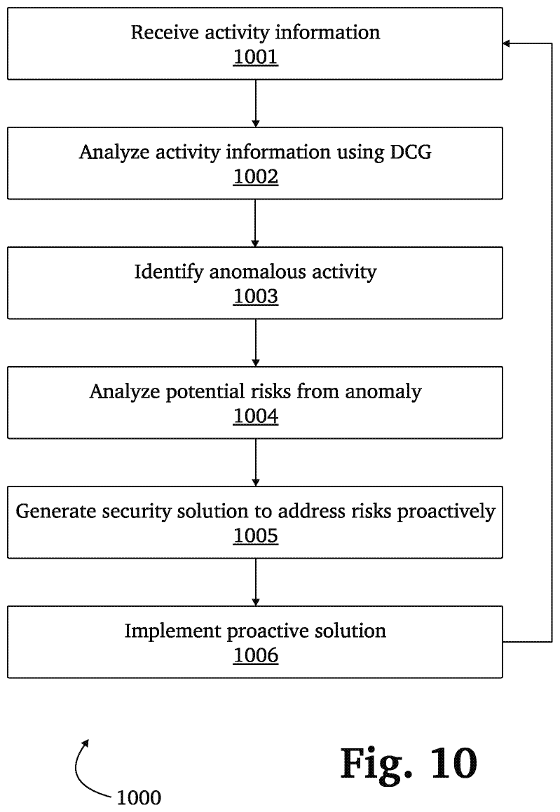

FIG. 10 is a flow diagram of an exemplary method 1000 for cybersecurity behavioral analytics, according to one aspect. According to the aspect, behavior analytics may utilize passive information feeds from a plurality of existing endpoints (for example, including but not limited to user activity on a network, network performance, or device behavior) to generate security solutions. In an initial step 1001, a web crawler 115 may passively collect activity information, which may then be processed 1002 using a DCG 155 to analyze behavior patterns. Based on this initial analysis, anomalous behavior may be recognized 1003 (for example, based on a threshold of variance from an established pattern or trend) such as high-risk users or malicious software operators such as bots. These anomalous behaviors may then be used 1004 to analyze potential angles of attack and then produce 1005 security suggestions based on this second-level analysis and predictions generated by an action outcome simulation module 125 to determine the likely effects of the change. The suggested behaviors may then be automatically implemented 1006 as needed. Passive monitoring 1001 then continues, collecting information after new security solutions are implemented 1006, enabling machine learning to improve operation over time as the relationship between security changes and observed behaviors and threats are observed and analyzed.

This method 1000 for behavioral analytics enables proactive and high-speed reactive defense capabilities against a variety of cyberattack threats, including anomalous human behaviors as well as nonhuman “bad actors” such as automated software bots that may probe for, and then exploit, existing vulnerabilities. Using automated behavioral learning in this manner provides a much more responsive solution than manual intervention, enabling rapid response to threats to mitigate any potential impact. Utilizing machine learning behavior further enhances this approach, providing additional proactive behavior that is not possible in simple automated approaches that merely react to threats as they occur.

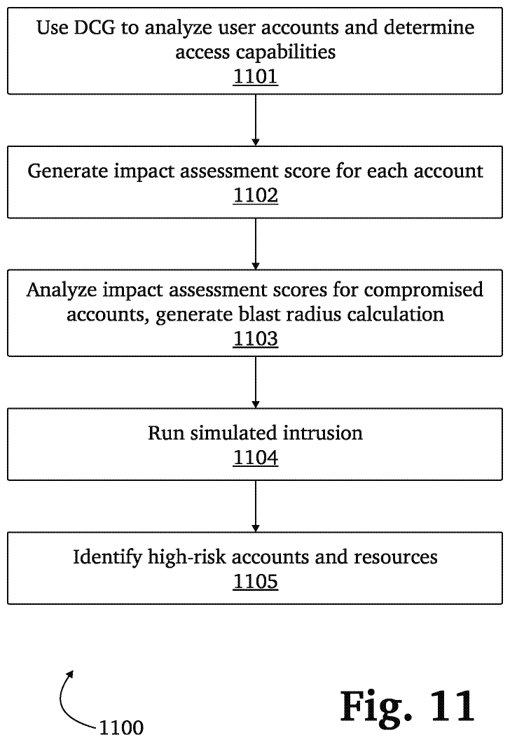

FIG. 11 is a flow diagram of an exemplary method 1100 for measuring the effects of cybersecurity attacks, according to one aspect. According to the aspect, impact assessment of an attack may be measured using a DCG 155 to analyze a user account and identify its access capabilities 1101 (for example, what files, directories, devices or domains an account may have access to). This may then be used to generate 1102 an impact assessment score for the account, representing the potential risk should that account be compromised. In the event of an incident, the impact assessment score for any compromised accounts may be used to produce a “blast radius” calculation 1103, identifying exactly what resources are at risk as a result of the intrusion and where security personnel should focus their attention. To provide proactive security recommendations through a simulation module 125, simulated intrusions may be run 1104 to identify potential blast radius calculations for a variety of attacks and to determine 1105 high risk accounts or resources so that security may be improved in those key areas rather than focusing on reactive solutions.

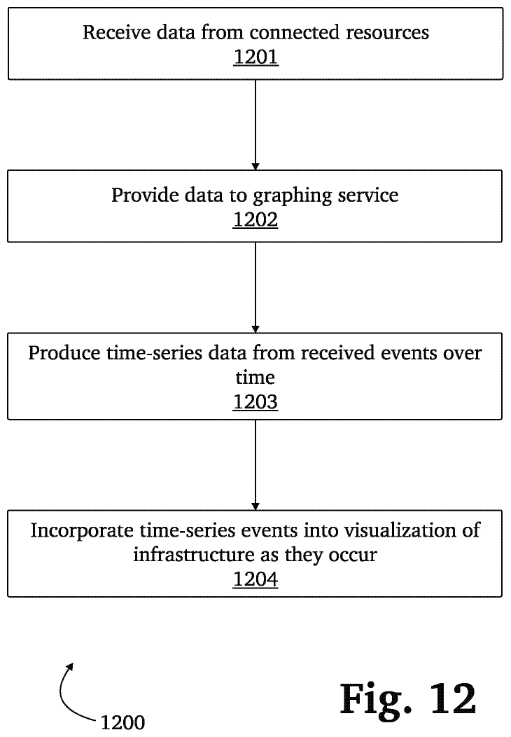

FIG. 12 is a flow diagram of an exemplary method 1200 for continuous cybersecurity monitoring and exploration, according to one aspect. According to the aspect, a state observation service 140 may receive data from a variety of connected systems 1201 such as (for example, including but not limited to) servers, domains, databases, or user directories. This information may be received continuously, passively collecting events and monitoring activity over time while feeding 1202 collected information into a graphing service 145 for use in producing time-series graphs 1203 of states and changes over time. This collated time-series data may then be used to produce a visualization 1204 of changes over time, quantifying collected data into a meaningful and understandable format. As new events are recorded, such as changing user roles or permissions, modifying servers or data structures, or other changes within a security infrastructure, these events are automatically incorporated into the time-series data and visualizations are updated accordingly, providing live monitoring of a wealth of information in a way that highlights meaningful data without losing detail due to the quantity of data points under examination.

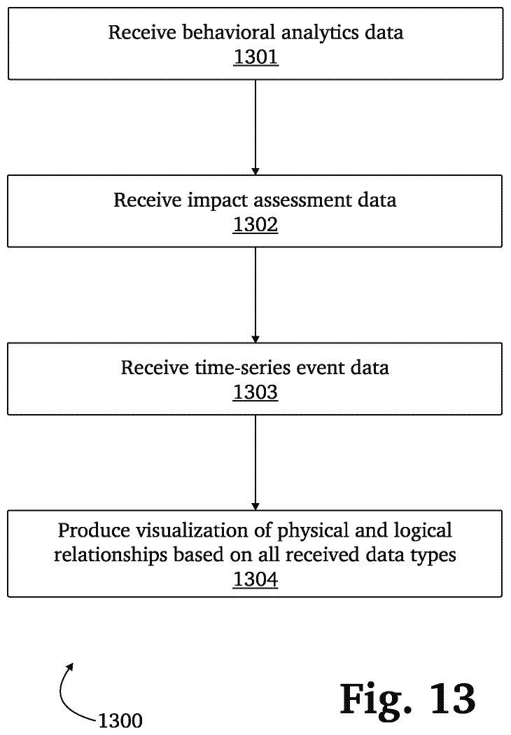

FIG. 13 is a flow diagram of an exemplary method 1300 for mapping a cyber-physical system graph (CPG), according to one aspect. According to the aspect, a cyber-physical system graph may comprise a visualization of hierarchies and relationships between devices and resources in a security infrastructure, contextualizing security information with physical device relationships that are easily understandable for security personnel and users. In an initial step 1301, behavior analytics information (as described previously, referring to FIG. 10) may be received at a graphing service 145 for inclusion in a CPG. In a next step 1302, impact assessment scores (as described previously, referring to FIG. 11) may be received and incorporated in the CPG information, adding risk assessment context to the behavior information. In a next step 1303, time-series information (as described previously, referring to FIG. 12) may be received and incorporated, updating CPG information as changes occur and events are logged. This information may then be used to produce 1304 a graph visualization of users, servers, devices, and other resources correlating physical relationships (such as a user's personal computer or smartphone, or physical connections between servers) with logical relationships (such as access privileges or database connections), to produce a meaningful and contextualized visualization of a security infrastructure that reflects the current state of the internal relationships present in the infrastructure.

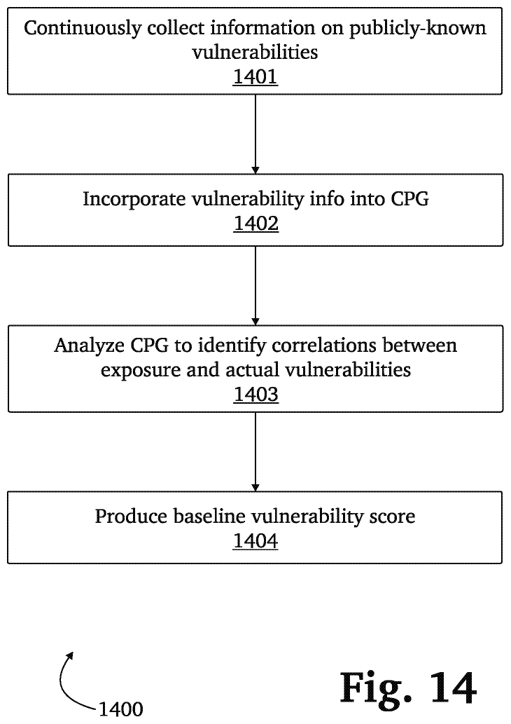

FIG. 14 is a flow diagram of an exemplary method 1400 for continuous network resilience scoring, according to one aspect. According to the aspect, a baseline score can be used to measure an overall level of risk for a network infrastructure, and may be compiled by first collecting 1401 information on publicly-disclosed vulnerabilities, such as (for example) using the Internet or common vulnerabilities and exploits (CVE) process. This information may then 1402 be incorporated into a CPG as described previously in FIG. 13, and the combined data of the CPG and the known vulnerabilities may then be analyzed 1403 to identify the relationships between known vulnerabilities and risks exposed by components of the infrastructure. This produces a combined CPG 1404 that incorporates both the internal risk level of network resources, user accounts, and devices as well as the actual risk level based on the analysis of known vulnerabilities and security risks.

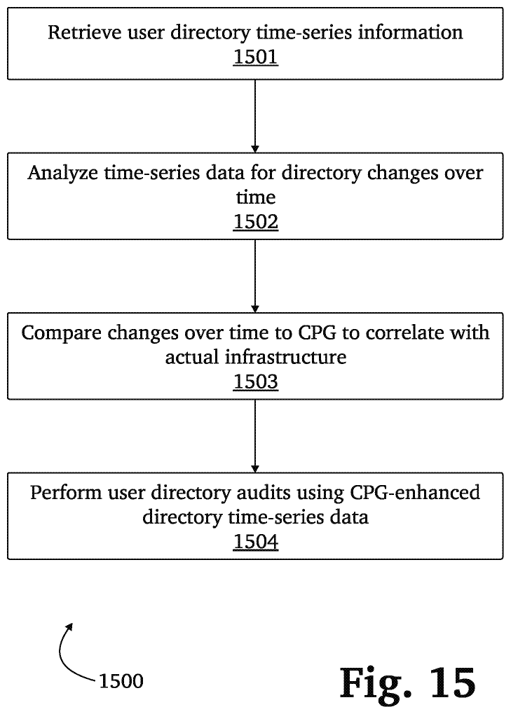

FIG. 15 is a flow diagram of an exemplary method 1500 for cybersecurity privilege oversight, according to one aspect. According to the aspect, time-series data (as described above, referring to FIG. 12) may be collected 1501 for user accounts, credentials, directories, and other user-based privilege and access information. This data may then 1502 be analyzed to identify changes over time that may affect security, such as modifying user access privileges or adding new users. The results of analysis may be checked 1503 against a CPG (as described previously in FIG. 13), to compare and correlate user directory changes with the actual infrastructure state. This comparison may be used to perform accurate and context-enhanced user directory audits 1504 that identify not only current user credentials and other user-specific information, but changes to this information over time and how the user information relates to the actual infrastructure (for example, credentials that grant access to devices and may therefore implicitly grant additional access due to device relationships that were not immediately apparent from the user directory alone).

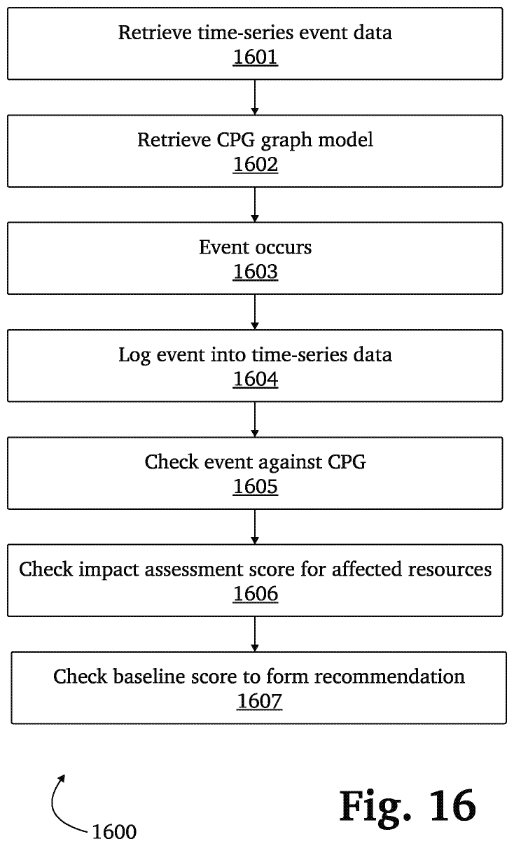

FIG. 16 is a flow diagram of an exemplary method 1600 for cybersecurity risk management, according to one aspect. According to the aspect, multiple methods described previously may be combined to provide live assessment of attacks as they occur, by first receiving 1601 time-series data for an infrastructure (as described previously, in FIG. 12) to provide live monitoring of network events. This data is then enhanced 1602 with a CPG (as described above in FIG. 13) to correlate events with actual infrastructure elements, such as servers or accounts. When an event (for example, an attempted attack against a vulnerable system or resource) occurs 1603, the event is logged in the time-series data 1604, and compared against the CPG 1605 to determine the impact. This is enhanced with the inclusion of impact assessment information 1606 for any affected resources, and the attack is then checked against a baseline score 1607 to determine the full extent of the impact of the attack and any necessary modifications to the infrastructure or policies.

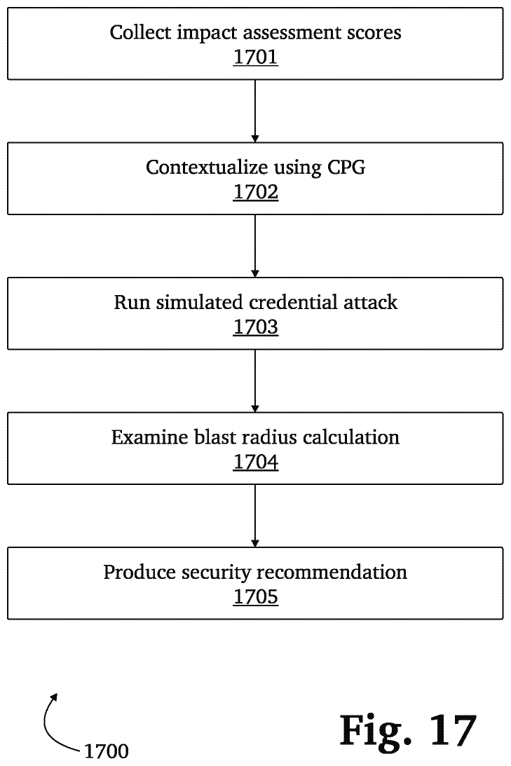

FIG. 17 is a flow diagram of an exemplary method 1700 for mitigating compromised credential threats, according to one aspect. According to the aspect, impact assessment scores (as described previously, referring to FIG. 11) may be collected 1701 for user accounts in a directory, so that the potential impact of any given credential attack is known in advance of an actual attack event. This information may be combined with a CPG 1702 as described previously in FIG. 13, to contextualize impact assessment scores within the infrastructure (for example, so that it may be predicted what systems or resources might be at risk for any given credential attack). A simulated attack may then be performed 1703 to use machine learning to improve security without waiting for actual attacks to trigger a reactive response. A blast radius assessment (as described above in FIG. 11) may be used in response 1704 to determine the effects of the simulated attack and identify points of weakness, and produce a recommendation report 1705 for improving and hardening the infrastructure against future attacks.

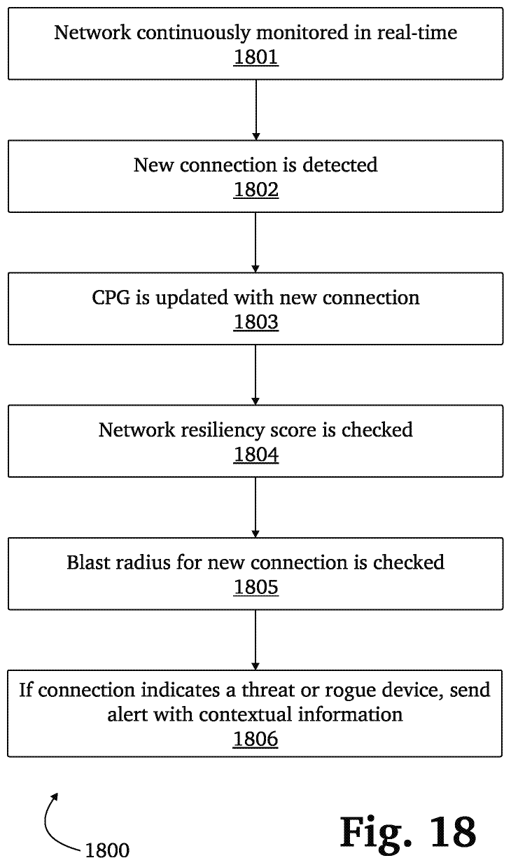

FIG. 18 is a flow diagram of an exemplary method 1800 for dynamic network and rogue device discovery, according to one aspect. According to the aspect, an advanced cyber decision platform may continuously monitor a network in real-time 1801, detecting any changes as they occur. When a new connection is detected 1802, a CPG may be updated 1803 with the new connection information, which may then be compared against the network's resiliency score 1804 to examine for potential risk. The blast radius metric for any other devices involved in the connection may also be checked 1805, to examine the context of the connection for risk potential (for example, an unknown connection to an internal data server with sensitive information may be considered a much higher risk than an unknown connection to an externally-facing web server). If the connection is a risk, an alert may be sent to an administrator 1806 with the contextual information for the connection to provide a concise notification of relevant details for quick handling.

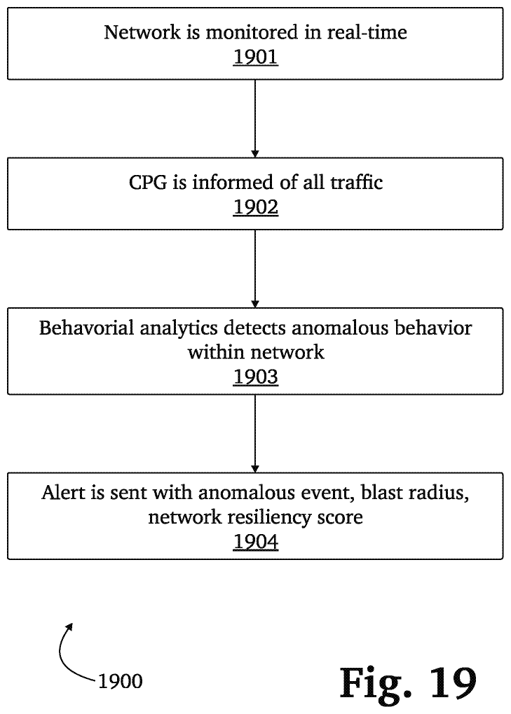

FIG. 19 is a flow diagram of an exemplary method 1900 for Kerberos “golden ticket” attack detection, according to one aspect. To detect these forms of attack, behavioral analytics may be employed to detect erroneously-issued authentication tickets or forged AO's, whether from incorrect configuration or from an attack. According to the aspect, an advanced cyber decision platform may continuously monitor a network 1901, informing a CPG in real-time of all traffic associated with people, places, devices, or services 1902. Machine learning algorithms detect behavioral anomalies as they occur in real-time 1903, notifying administrators with an assessment of the anomalous event 1904 as well as a blast radius score for the particular event and a network resiliency score to advise of the overall health of the network. By automatically detecting unusual behavior and informing an administrator of the anomaly along with contextual information for the event and network, a compromised ticket is immediately detected when a new authentication connection is made.

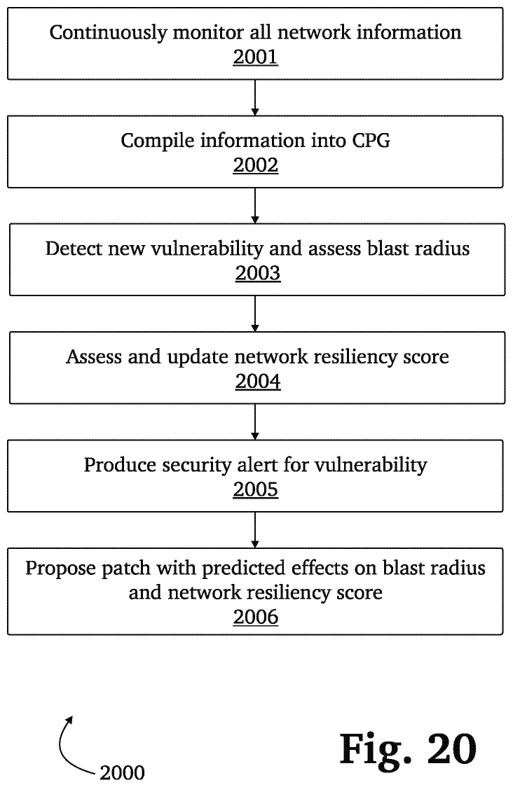

FIG. 20 is a flow diagram of an exemplary method 2000 for risk-based vulnerability and patch management, according to one aspect. According to the aspect, an advanced cyber decision platform may monitor all information about a network 2001, including (but not limited to) device telemetry data, log files, connections and network events, deployed software versions, or contextual user activity information. This information is incorporated into a CPG 2002 to maintain an up-to-date model of the network in real-time. When a new vulnerability is discovered, a blast radius score may be assessed 2003 and the network's resiliency score may be updated 2004 as needed. A security alert may then be produced 2005 to notify an administrator of the vulnerability and its impact, and a proposed patch may be presented 2006 along with the predicted effects of the patch on the vulnerability's blast radius and the overall network resiliency score. This determines both the total impact risk of any particular vulnerability, as well as the overall effect of each vulnerability on the network as a whole. This continuous network assessment may be used to collect information about new vulnerabilities and exploits to provide proactive solutions with clear result predictions, before attacks occur.

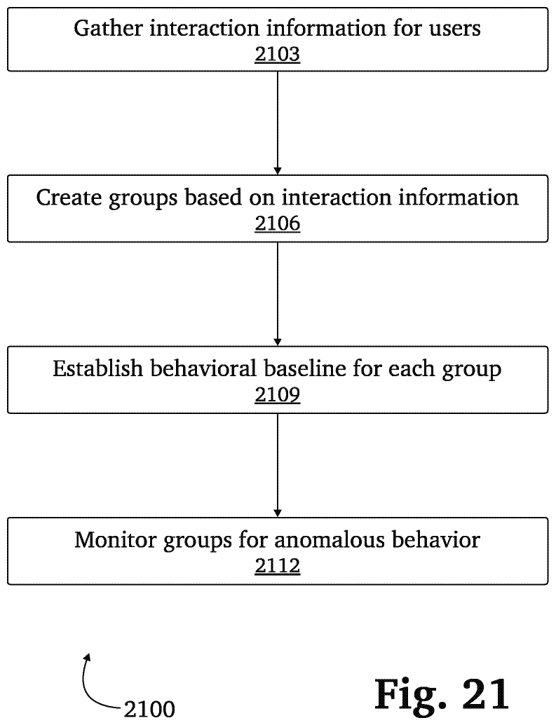

FIG. 21 is a flow diagram of an exemplary method 2100 for establishing groups of users according to one aspect. At an initial step 2103, data pertaining to network interaction between users and devices are gathered by a grouping engine. At step 2106, the grouping engine may then process the gathered information by converting it to a graph format and using DCG module to establish groupings for users. A system administrator may provide additional input, and fine-tune the groupings if required. At step 2109, a behavioral baseline is established for each group that may be based on the interaction information, network logs, connected devices, and the like. At step 2112, groups are continuous monitored for anomalous behavior.

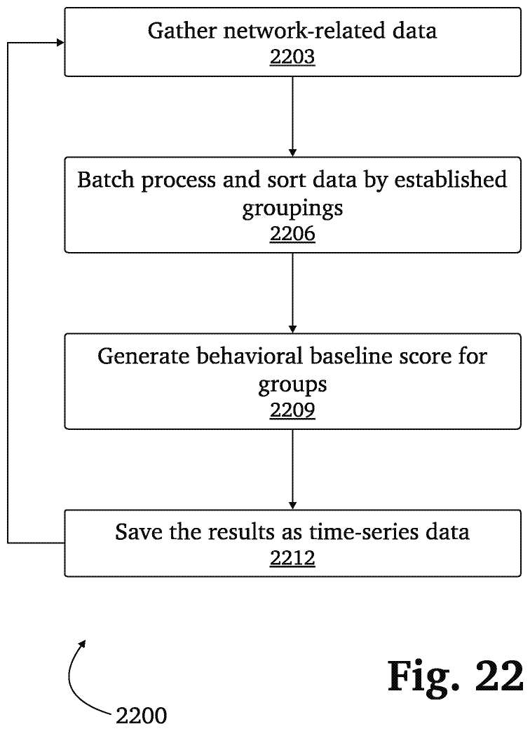

FIG. 22 is a flow diagram of an exemplary method 2200 for monitoring groups for anomalous behavior, according to one aspect. At an initial step 2203, a system, as described above in FIG. 8, gathers network-related data. This data may comprise usage logs, Kerberos session data, computers and other devices connected to the network, active users, software installed, and the like. At step 2206, a behavioral analysis engine may process the data. Parallel computing may be used to speed up the processing of the data. The data may then be sorted by, and associated to, previously established groupings. At step 2209, a behavioral baseline score is generated for each group based on the results of the data processing. At step 2212, the data is stored into a time-series graph database. The process repeats periodically to create snapshots of various moments in time, and stored into the database. This may allow the system to retrain the baseline to take into considering non-anomalous baseline variances that may occur over time, as well as forecast changes in group dynamics using predictive analysis functions of ACDP system 100.

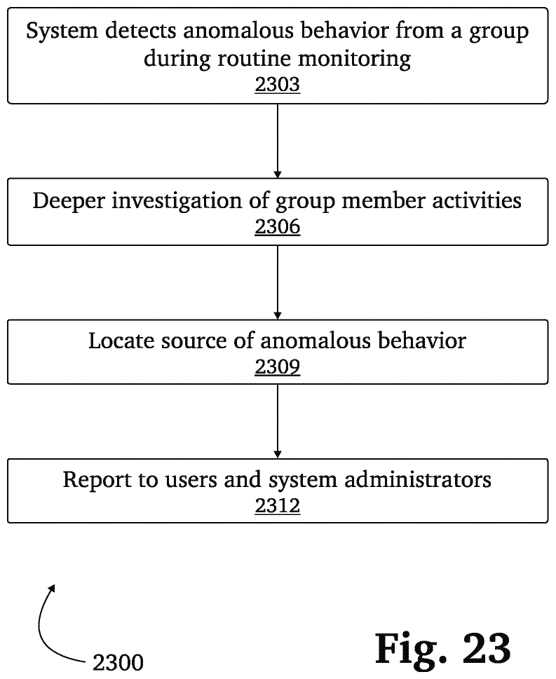

FIG. 23 is a flow diagram for an exemplary method 2300 for handing a detection of anomalous behavior, according to one aspect. At an initial step 2303, the system detects anomalous user behavior from a group. This may be based on comparison to established baselines, or a high priority incident caught during routine monitoring, for example a device accessing a blacklisted domain. At step 2306, the system investigates the group in which the anomalous behavior originated. This may include a more thorough analysis of usage and access logs. If applicable, users or devices with higher access privileges may be investigated before those with lower access privileges. At step 2309, the source or sources of the anomalous behavior is identified, and some corrective measures may be taken. For example, the offending device or user account may be automatically locked out of the network until a solution has been implemented. At step 2312, group members and system administrators may be notified. The system may utilize the various techniques discussed above to recommend a corrective action, or the system may take action automatically.

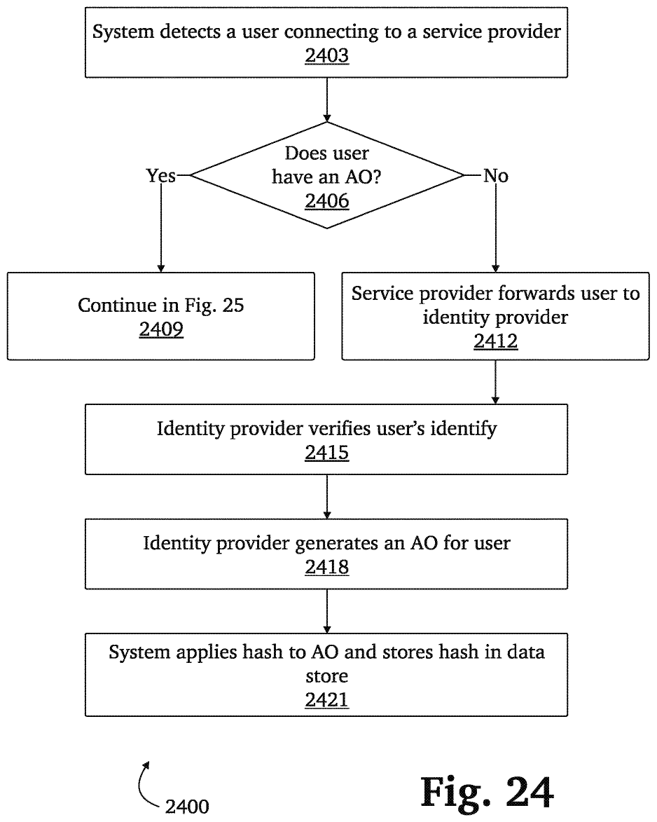

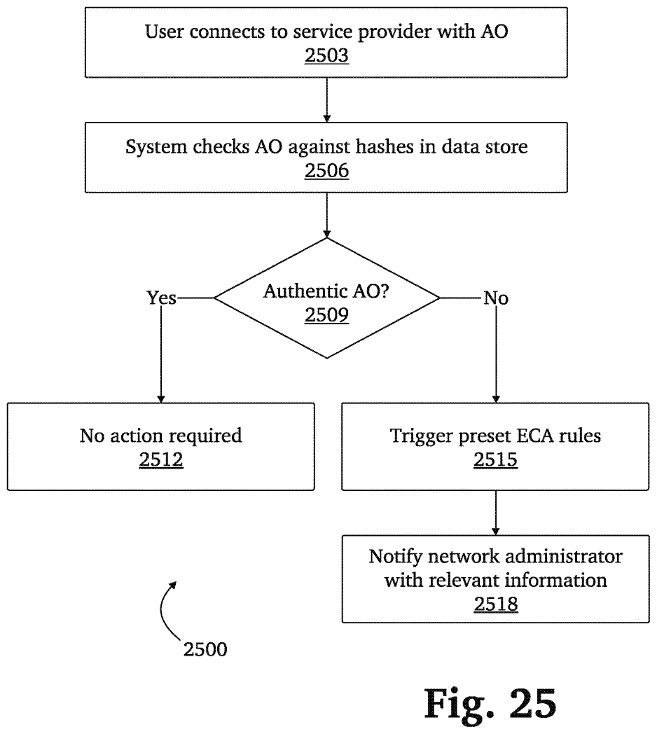

FIG. 24 is a flow diagram illustrating an exemplary method 2400 for processing a new user connection, according to one aspect. At an initial step 2403, system 910 detects a user connecting to a monitored service provider. At step 2406, if the user is connecting with an existing AO, the process leads to the method discussed in FIG. 25 at step 2409.

If the user doesn't have an existing AO, the service provider forwards the user to an identity provider at step 2412. At step 2415, the identity provider prompts the user for identifying information, such as a username and password. At step 2418, after successful verification, the IdP generates a unique AO for the user. At step 2421, system 910 retrieves the AO and uses a hashing engine to calculate a cryptographic hash for the newly generated AO, and stores the hash in a data store.

FIG. 25 is a flow diagram illustrating an exemplary method 2500 for verifying the authenticity of an authentication object, according to one aspect. At an initial step 2503, a user with an AO connects to a monitored service provider. At step 2506, system 910 detects the connection request, retrieves the AO, and generates a cryptographic hash for the AO. System 910 may now compare the newly generated hashes with previous generated hashes stored in memory. At step 2509, if the AO is found to be authentic, the connect proceeds as normal and method 2500 ends at step 2512 as no further action for this session is required. If the AO is determined to be forged, method 2500 goes to step 2515 where ECA rules may be triggered to perform their preset functions, and perform “circuit breaker” checks within a user-configurable time period. At step 2518, a network administrator at step may be notified, and sent any relevant information, such as blast radius, access logs for the forged AO connection, and the like.

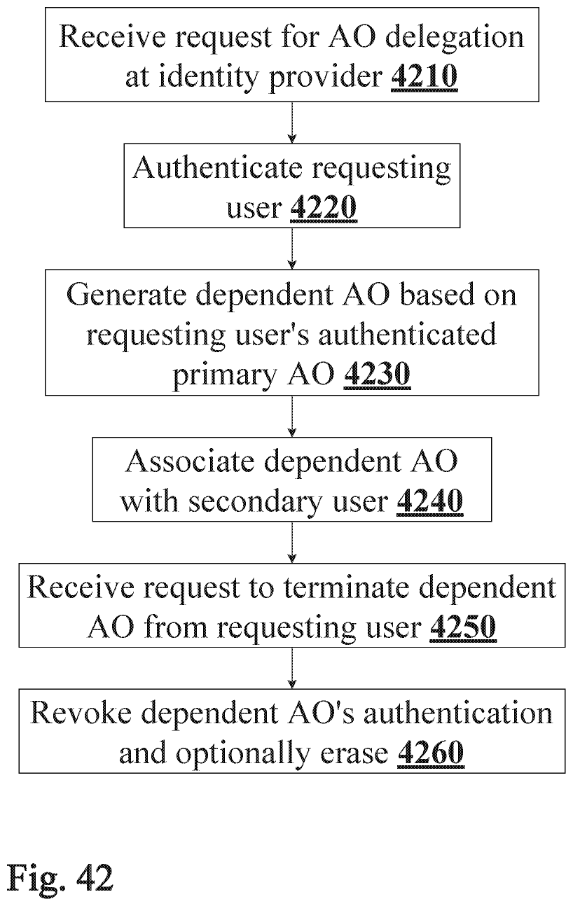

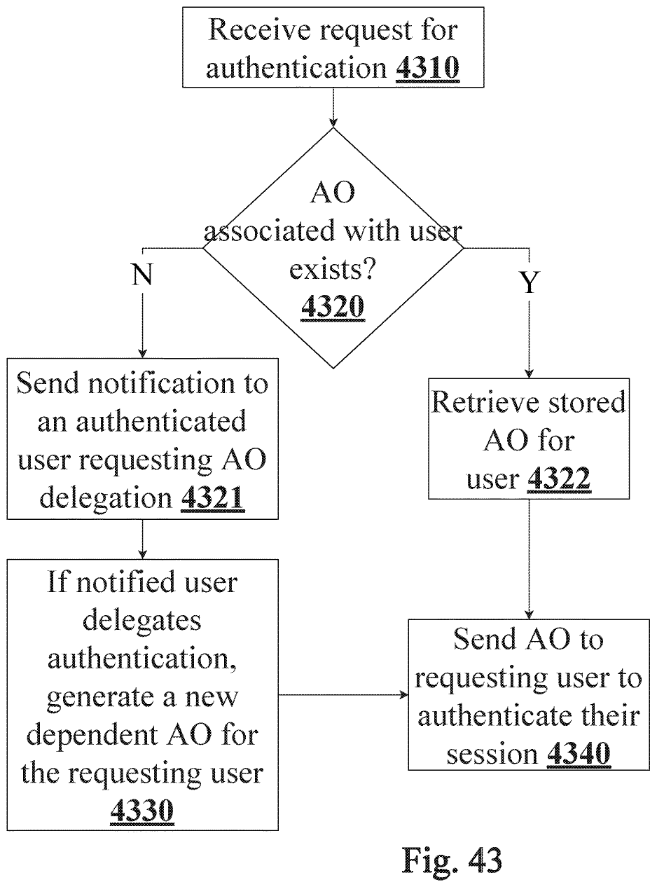

FIG. 42 is a flow diagram illustrating a process for authentication delegation, illustrating the generation of a dependent authentication object. According to this method, an authenticated user may delegate credentials to secondary users, effecting a process where authenticated users can “vouch” for new users and pass down their privileges. When a request for delegation is received 4210 at an identity provider, the requesting user is first authenticated normally 4220 to ensure they are indeed an authorized user. If the user passes authentication, a new dependent authentication object (AO) may be generated based on the requesting user's authentication 4230. For example, the privileges associated with the dependent AO may be based on a subset of the requesting user's privileges or they may have identical privileges, according to various configurations. The requesting user's AO may also be used as a cryptographic seed in the generation of the dependent AO, ensuring that the two objects are intrinsically associated with one another and the association can be deduced from a comparison of the objects (for example, as a step in verifying that a dependent user was authorized by the authenticated user they claim, to prevent forgeries). The dependent AO may then be associated with a secondary user 4240, for example a new user account that was provided with the initial request for delegation (or, optionally, the requesting user may provide or be prompted to provide a user after authentication, according to some arrangements). At this point, the secondary user now has a valid AO record that may be used for authentication, as described below with reference to FIG. 43. If the original requesting user that established the authentication delegation then wishes, they may optionally request 4250 to terminate the dependent AO and thus revoke the secondary user's privileges 4260, in effect making the original user the authenticating authority for the secondary user. The AO may optionally be destroyed when revoked, or stored for future use such as to maintain a record of prior authentication objects and delegation associations between requesting/secondary users, or between users and previously-valid authentication objects.

FIG. 43 is a flow diagram illustrating the use of a dependent authentication object to authenticate a delegated user. When a user requests authentication 4310, an identity provider may check to determine whether an AO associated with this user exists 4320. If a stored AO is found, it may be retrieved 4322 and provided to authenticate the user 4340. However, if there is no stored AO, a notification may be sent to a known, previously-authenticated user to request AO delegation 4321; for example, an administrator user may be configured to receive delegation notifications for new users, or an authenticated user may be selected based on known information about the new user such as, for example, working within the same department or sharing other business relationships, as may be known to an identity provider through configured domain information. If the notified user then choose to provide authentication delegation, a new dependent AO may be generated 4330 for the new user, which may then be provided to authenticate the current session 4340. This technique enables on-the-fly authentication of new and unknown users, or users that may fall short of a configured authentication threshold such as by using a new device or having changed personal or business information (for example, moving to a different regional office or transferring to a different department, that may create a conflict with stored domain information). In this manner, users can authenticate using delegation without having already established authentication information with an identity provider, and no assumptions need be made regarding new users or sessions; in effect, delegation creates a zero-assumption authentication procedure whereby new users can be authenticated and revoked on an as-needed basis, without assuming any base level of authentication for new sessions.

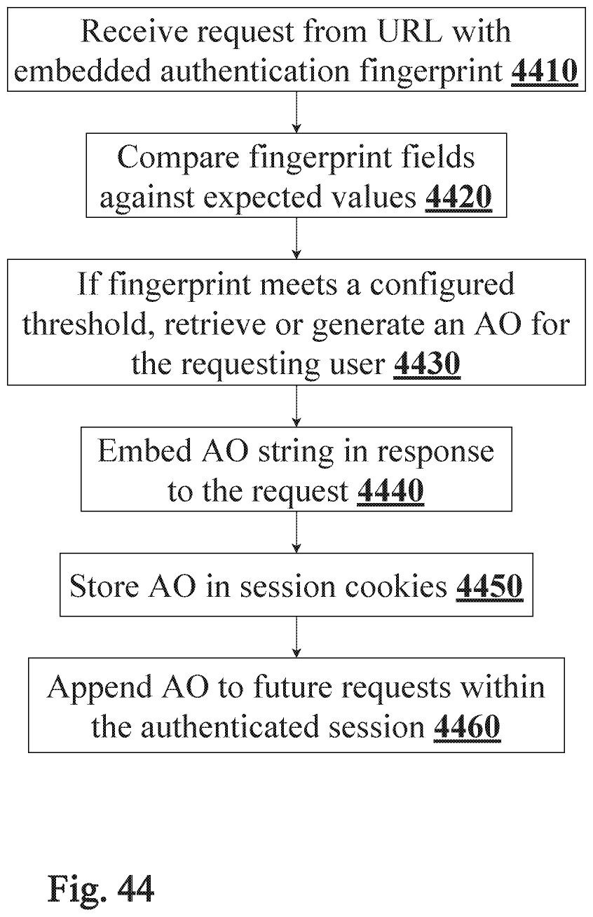

FIG. 44 is a flow diagram illustrating a process for implicit authentication using an embedded authentication object in a URL. According to this method, users may implicitly authenticate with services and providers through a URL-based fingerprinting process that identifies the user and, where possible, automatically retrieves an authentication object for their session which is then automatically included in future requests. When a URL is received with embedded fingerprinting 4410, the received fingerprint field values may be compared against expected values 4420 to determine whether the originator of the request (i.e., the as-yet-unauthenticated user) may be authenticated. Fingerprint values may be any of a number of arbitrary values that may be useful in identifying a user, device, or session, such as (for example, including but not limited to) device hardware information such as screen size or device sensor values (for example, orientation or location sensors on a mobile device), browser software information such as version or installed extensions, operating system information, date/time information, session cookies or other metadata, or any other information or combination of information that may be useful in identifying a user, device, or session. If the fingerprint data meets a configured threshold (that is, enough data matches that there can be a reasonable degree of confidence in the user's identity), an AO may be retrieved (if one already exists, as described above with reference to FIG. 43) or generated for the request. The AO may then be embedded in the response to the request 4440, for example embedded within a web page being served to fulfill the request. The AO may then be stored 4450 as with any other session-based metadata or cookies, and may be appended to future requests within the session to authenticate the user without additional prompts or interruptions 4460.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

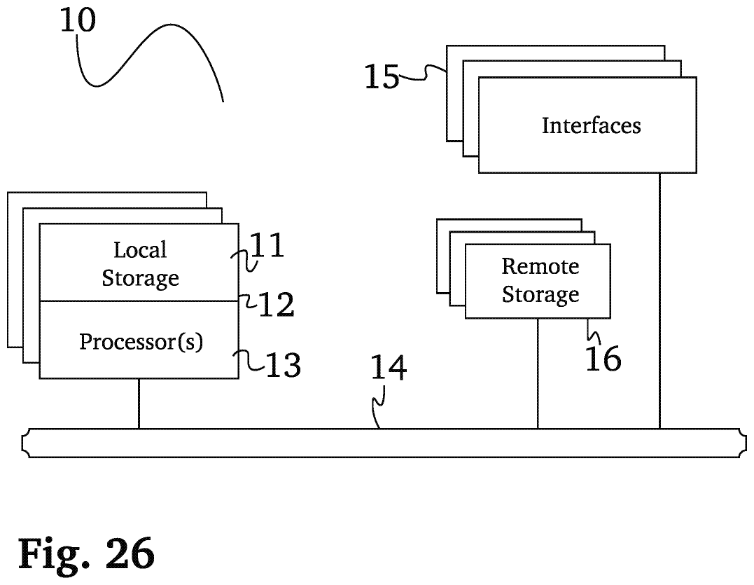

Referring now to FIG. 26, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 26 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

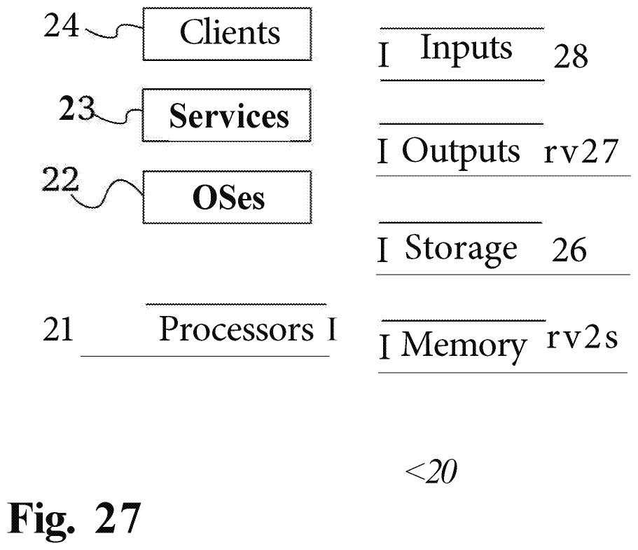

In some aspects, systems may be implemented on a standalone computing system. Referring now to FIG. 27, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 26). Examples of storage devices 26 include flash memory, magnetic hard drive, CD-ROM, and/or the like.

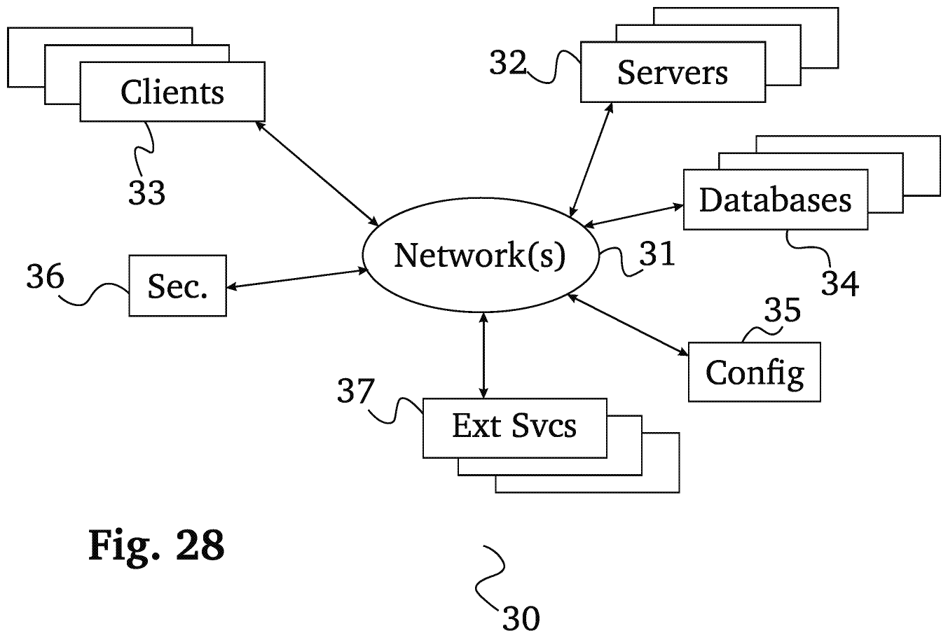

In some aspects, systems may be implemented on a distributed computing network, such as one having any number of clients and/or servers. Referring now to FIG. 28, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 27. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some aspects, clients 33 or servers 32 (or both) may make use of one or more specialized services or appliances that may be deployed locally or remotely across one or more networks 31. For example, one or more databases 34 may be used or referred to by one or more aspects. It should be understood by one having ordinary skill in the art that databases 34 may be arranged in a wide variety of architectures and using a wide variety of data access and manipulation means. For example, in various aspects one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

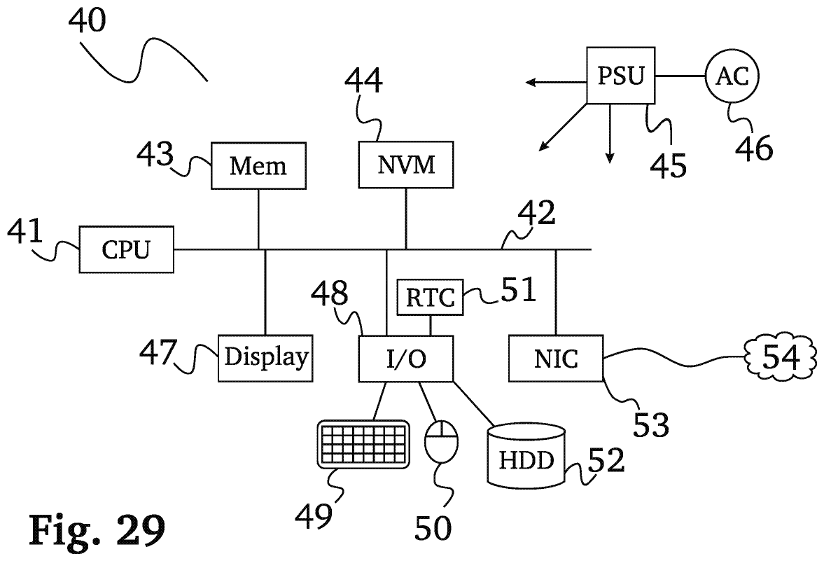

FIG. 29 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The invention also includes a multi-factor authentication kiosk that utilizes various sensors to capture biometric, behavioral, and physiological data for authentication. The kiosk includes a user interface, a set of sensors, and services such as kiosk management, rules configuration, sensor management, and an authentication service. The sensors, both integrated and external, gather diverse data, including facial recognition, fingerprint scans, voice recognition, gait analysis, and more, constructing a physical profile for authentication. The system incorporates a rules service for configuring authentication policies and a sensor management service to optimize sensor performance. Authentication service uses a scoring model, potentially a deep learning algorithm like an autoencoder, to generate an authentication score based on inputs from sensors, rules, and previous attempts. Security measures include encryption, isolation of components, and compliance with data protection regulations. A plurality of MFA kiosks may form an authentication network.

According to some embodiments, the kiosk may optionally have the ability to include device profiling and testing equipment (e.g., CPU/memory) and other diagnostics that can support “transfer” transactions. This can improve legitimate trade-ins, transfers, etc. of phones and devices while also helping to guard against direct device theft issues.

According to some use cases, a kiosk network provides the ability to link a person to a physical profile for sufficient onboarding in medical and employment issues. Fake worker onboarding, insurance abuse, etc., can all be significantly reduced if such profiles are available. Auto theft with “whole body profiles” could likewise leverage a broader host of data for digital sale/transfer, authorized rental/temporary borrowing, and general safety.

Other practical examples of use cases for an MFA kiosk are numerous an can include, but are not limited to: (a) transferring ownership of a mobile device (be it a watch, car, scooter, augmented reality (AR) device, phone, etc.): (b) opening or emptying a financial account (including loan applications); (c) engaging in meaningful legal obligations (e.g., marriage, a criminal plea, guardianship, divorce, social security, home mortgage closings, etc.); (d) major exams (e.g., bar exam, professional engineer, series 7 license, etc.) where great harm to the public can occur with illicit resulting licensure/qualification.

Therefore, the ability of the system to perform authentication delegation, as described in FIGS. 42-44 is further extended to situations not only where the authentication object used to authenticate the primary, or requesting, user is a key or other unique identifier held by a user device or associated with a user account, but also to instances in which the authentication object includes any authentication information (including biometric information) provided via a kiosk as described herein. For situations where authentication has already been delegated to a secondary user or device, but where the authority delegated is less than the total authority of the primary user, additional multi-factor authentication by the primary user, such as, but not limited to, using the MFA kiosk described below, may enable approval of actions by the secondary user that would otherwise not fall into the scope of authority delegated to the secondary user. In some instances, authority is delegated to nonhuman users and the use of MFA, particularly MFA requiring some amount of physical information or verification, is important for ensuring the nonhuman delegated user does not exceed its intended authority.

### MFA Kiosk Conceptual Architecture

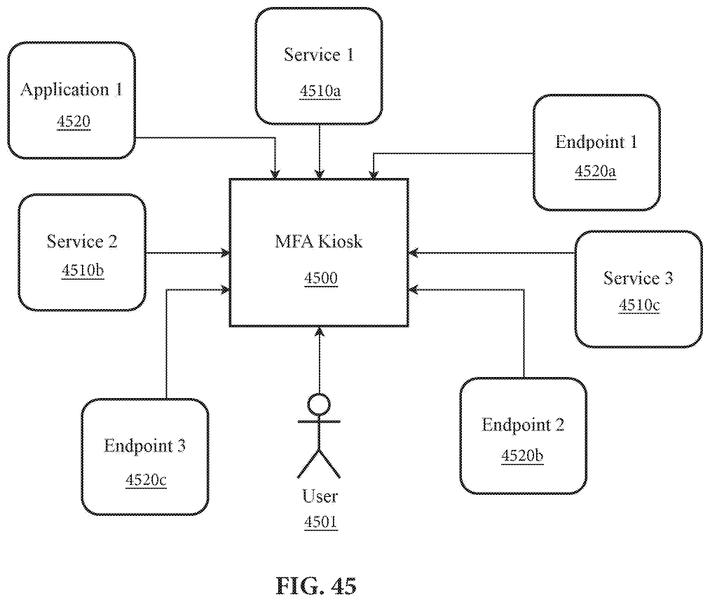

FIG. 45 is a block diagram illustrating an exemplary system architecture for a multi-factor authentication (MFA) kiosk, according to an embodiment. According to the embodiment, a plurality of federated applications, services, and corporate/organizational domains may construct “trusted authentication” kiosks which can be placed in a variety of locations. These kiosks might be organizationally owned and operated (e.g., by a corporate entity) or could be independently operated (e.g., similar to ATM [automated teller machine] networks). According to the embodiment, a multi-factor authentication kiosk 4500 may connect provide multi-factor authentication of a user 4501 to allow access to various services 4510a-n, applications 4530, and endpoints 4520a-n.

According to the embodiment, the user may be any individual human and MFA kiosk 4500 can provide authentication for their physical, digital, and/or legal personas. In some embodiments, it is envisioned that a user may be a robot, artificial intelligence, or some combination thereof. In various embodiments, services 4510a-n may be construed in the context of software and system architecture, wherein “services” generally refer to self-contained, modular, and independent components that perform specific functions or tasks with a larger system. Services 4510a-n can communicate with each other to achieve a higher-level goal or provide a complete transaction. In some implementations, services 4510a-n may comprise one or more microservices which may communicate with each other and/or MFA kiosk 4500 via well-defined application programming interfaces (APIs). Authentication is necessary to ensure that only authorized users or services can access specific functionalities or data.

Endpoints 4520a-n may refer to a plurality of devices, systems, applications, or physical locations which require user authentication for access to the endpoint. For example, endpoint devices may include, but are not limited to, mobile devices, devices provided by an employer to an employee, personal computers, workstations, tablets, medical equipment, smart devices, IoT devices, sensors, switches, routers, servers, printers, and/or other networked devices. Examples of endpoint physical locations may include, but are not limited to, medical facilities, exercise facilities, corporate facilities, military facilities, and/or the like. A physical location may also comprise a locker, safe, storage box, or some other type of container with a locking mechanism or some other means for restricting access to itself. For example, a short-term rental house may utilize a secure key storage that can be configured to release the key to a renter upon user authentication by MFA kiosk. As another example, kiosk could be used to control access to an endpoint related to controlled substance access (e.g., at a hospital or potentially in an at home drug dispenser or “robo-pharmacy”) or some other pharmaceutical process.

According to the embodiment, the multi-factor authentication kiosk 4500 may connect to and communicate with the various applications, services, and/or endpoints over a suitable communication network such as, for example, the Internet. Various other communication networks may be utilized and the choice of communication network may be dependent upon the use case or other aspect of an embodiment. For example, MFA kiosk 4500 may utilize a short-range wireless communication technology designed for exchanging data between devices (e.g., Bluetooth) to perform various tasks related to authentication of an individual and/or device such as by establishing a short-range wireless connection with a user device for the purpose of obtaining device data (e.g., device identifier, device location, device software/hardware data, etc.), user data (e.g., user location, user phone number, user handle, user email address, user biometric data, etc.), application data, and other data that may be useful for authenticating a user and/or a device.

In yet another embodiment, MFA kiosk 4500 may utilize Radio-Frequency Identification (RFID) technology to perform various tasks related to authentication of an individual and/or device. For example, MFA kiosk 4500 may comprise an RFID reader configured to communicate with RFID tags and collect data. When an RFID tag comes into range of an RFID reader, the reader sends a signal that activates the tag. The tag responds by transmitting its data to the reader. This data might include unique identification information which may be used as part of an authentication process.

According to the embodiment, the multi-factor authentication kiosk 4500 may connect to and communicate with the various applications, services, and/or endpoints over a suitable communication network such as, for example, a local network (wired or wireless). A local network, whether wired or wireless, is a collection of connected devices that can communicate with each other within a limited geographical area, such as a home, office, or campus. These networks facilitate the sharing of resources, information, and services among connected devices. In a wired local network, various networked devices/endpoints and MFA kiosk 4500 may connect to a local network via an Ethernet cable plugged into an Ethernet port on the device/endpoint/MFA kiosk 4500 and may communicate via Ethernet protocols and TCP/IP protocols. In a wireless local network, wireless-enabled devices/endpoints and MFA kiosk 4500 may connect to a wireless network via a wireless access point (e.g., wireless router) and may communicate using various Wi-Fi standard protocols (e.g., 802.11a, 802.11b, 802.11ac, etc.).

In some embodiments, MFA kiosk 4500 may be implemented as one or more computing devices comprising one or more hardware processors configured to perform the various methods and processes associated with authentication described herein. In some embodiments, MFA kiosk 4500 may be implemented as a purpose-built computing system comprising at least a processor and a memory, wherein a plurality of computer-readable instructions may be stored in the memory and executable by the processor cause the purpose-built computing system to perform the various methods and processes associated with authentication described herein.

In addition to processors and memory, MFA kiosk 4500 may further comprise each of the following depending upon the embodiment: a display for displaying various data associated with authentication processes via a user interface (e.g., graphic user interface), a network interface (e.g., network interface card or a software-based implementation), devices for providing input to the kiosk (e.g., keyboard, mouse, keypad, button, slider, switch, touchpad, controller, etc.), one or more cameras for capturing images and/or video, one or more microphones for capturing audio data (e.g., user speech and utterances), one or more sensors for capturing a plurality of data (e.g., biometric sensors, pressure sensors, x-ray sensor, light sensors, etc.), and one or more transducers for transforming electrical signals into various stimulation outputs. Biometric sensors may include, but are not limited to, fingerprint sensors, facial recognition cameras (e.g., cameras equipped with facial recognition technology capture and analyze facial features as a factor for multi-factor authentication), iris scanners (e.g., capture the unique patterns in the iris of the eye for identity verification), voice recognition microphones (e.g., voice recognition sensors analyze unique vocal patterns as a factor for multi-factor authentication), palm vein scanners (e.g., scanners that use near-infrared light to capture the vein pattern beneath eh skin of the palm for biometric identification), heart rate monitors, and behavioral biometrics (e.g., accelerometers and gyroscopes to analyze unique patterns in how a user interacts with their device or a kiosk, such as typing style or walking gait). It should be appreciated that each of these components and sensors may be integrated into MFA kiosk in a unified structure (e.g., like, for example, a photo booth) or may be implemented separate from MFA kiosk (e.g., cameras, gait sensors, heat sensors, elector magnetic sensors, etc., in a lobby of a bank or at a transit hub/chokepoint or retail center), but still communicatively coupled such that the components/sensors and the kiosk may be able to transmit/receive data and instructions to facilitate user and/or device authentication.

According to some embodiments, MFA kiosk 4500 provides multi-factor authentication of a user by constructing a physical profile of the user which can be used as a factor in a multi-factor authentication scheme. A physical profile of a user may be created after a user's initial interaction with MFA kiosk 4500. Various sensor/biometric data of the user is collected by MFA kiosk to create the physical profile. In some implementations, sensor/biometric data of the user may comprise one or more cranial measurements commonly used in facial recognition, ancillary features (e.g., beards, wigs, hair, brows, etc.), as well as potentially other medical related issues (e.g., fillings or crowns) that can be sensed. In at least one embodiment, x-rays (e.g., panoramic or sinus) can be used at times when need to diagnostically or to compensate for other authentication scoring issues/deficiencies when amassing (authentication) evidence in the aggregate. It should be appreciated that the kiosk need not focus solely on the head. In various implementations, the system may be used for whole body authentication and can go beyond liveliness (basic movements) and can require specific activities (e.g., a jumping-jack or a normal walk, a sequence). In some instances, sedentary versus athletic movement may in fact be needed to ascertain data necessary for downstream uses. It should be further appreciated that the physical profile constructed could also include indicators such as body fat, muscle composition, joint or bone enhancements (e.g., plates, screws, false joints, missing organs, etc. associated with prior surgical procedures).

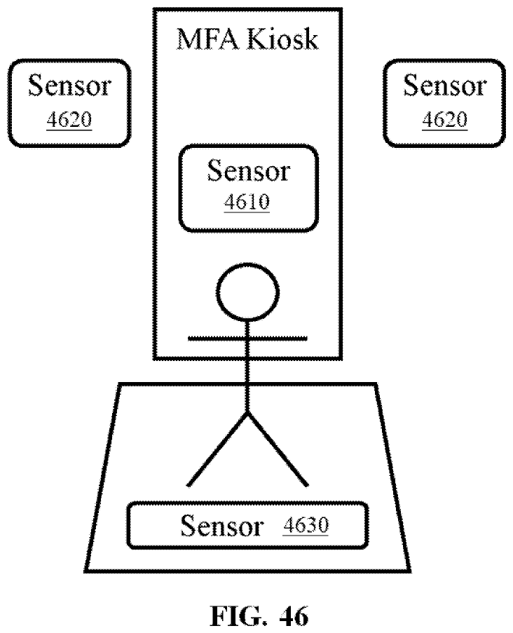

FIG. 46 is a block diagram illustrating an exemplary embodiment of a MFA kiosk deployed at a physical location for authentication of a user. According to the embodiment, the MFA kiosk 4600 is deployed at a physical location such as at an airport, bank, sports venue, medical facility, research facility, military facility, corporate office, and/or the like. MFA kiosk 4600 may comprise one or more onboard sensors 4610 integrated into the structure of the MFA kiosk and configured to capture, measure, and transmit various physical, biometric, physiological, and/or attributes of the user 4605 in order to facilitate user authentication. Additionally, or alternatively, one or more sensors 4620 may be present surrounding and not necessarily integrated into the structure of the kiosk, but still communicatively coupled with the kiosk via a suitable network connection and able to transmit various physical, biometric, physiological, and/or attributes of the user 4605 in order to facilitate user authentication. For example, the MFA kiosk may be placed in the lobby of a bank and may be able to receive video data from one or more cameras placed in the lobby of the bank. As another example, MFA kiosk 4600 may utilize integrated microphones to enable voice recognition or could even integrate a fingerprint/handprint sensors to analyze palm prints, fingerprints, and/or hand geometry to facilitate authentication.

In this embodiment, MFA kiosk 4600 includes at least one sensor on a surface in front of the kiosk, the at least one sensor able to provide authentication data. For example, one or more pressure sensors may be deployed in a surface in front of MFA kiosk so that when a kiosk user steps in front of the kiosk to facilitate authentication by capturing data related to the user's gait or walking pattern. The surface may be a purpose built surface with embedded sensors. For example, the surface could be a pad made from vinyl with one or more sensor arrays embedded therein.

A kiosk user can stand in front of MFA kiosk 4600 to facilitate authentication. If it's the individual's first time using an MFA kiosk 4600 then the kiosk may use the plurality of sensors 4610, 4620, and 4630 to capture a plurality of physical, biometric, physiological data associated with the individual to create a physical profile of the user which can be used as a factor in a multi-factor authentication process. Additionally, MFA kiosk 4600 may also capture device data associated with the individual's mobile device in order to link the mobile device with individual and their physical profile. In some embodiments, during an initial interaction with MFA kiosk 4600, the user may be asked to provide other types of information including, but not limited to, user demographics, user contact information (e.g., email address, social media handle, phone number, physical address, etc.), and information that could be used identify or otherwise verify the user. In some embodiments, during an initial authentication event of an individual the kiosk may prompt the user to perform one or more specific physical actions as part of the data capture process for constructing the physical profile of the individual. For example, the kiosk could prompt (e.g., voice or text-based prompt or both) the user to touch a series of body parts (e.g., head, shoulders, knees, and toes) to create physical movement that can be included as a component of the physical profile.

In operation, when it is not an individual's first time using an MFA kiosk 4600 then the kiosk uses the plurality of sensors 4610, 4620, and 4630 to capture a plurality of physical, biometric, and physiological data associated with the individual, perform various processing of the data thereof, and compare the processed data to the stored physical profiles to identify/verify the individual as a factor for multi-factor authentication. It should be appreciated that multiple sensors may be capturing and transmitting data about a kiosk user simultaneously via one or more data streams (or in batches), and that the processing of multiple data streams can be performed simultaneously as well. For example, a user may be asked to type on a keyboard integrated into or connected to the kiosk and the kiosk can simultaneously capture key stroke data and video data captured by a camera on the kiosk to analyze both the user's unique typing pattern and facial data. As another example, a microphone can capture a user's spoken pass phrase or other utterance while one or more cameras and/or one or more pressure sensors also capture the user's unique gait or walking pattern, and both sets of data are used to compare against stored physical profiles to authenticate the user.

The type of arrangement illustrated in this embodiment wherein the user has to stand in front of MFA kiosk 4600 may be referred to as a non-immersive embodiment. Another type of non-immersive embodiment may be implemented wherein the user is not required to step in front of the kiosk. For example, cameras could film an individual walking through an x-ray machine while a MFA kiosk receives the video data and x-ray imaging data to perform gait analysis and physical augmentation analysis to compare the individuals gait and possible surgical hardware embedded in their body to stored physical profiles to perform an authentication step for multi-factor authentication. In such an embodiment, the individual need not interact with a kiosk directly as this may be done passively as the individual moves through a location such as a checkpoint at a hospital or sports venue.

In an embodiment, MFA kiosk may be implemented as a micro-kiosk. Examples of micro-kiosks can include a desktop or laptop being used for trading, mobile device used for biometrics in addition to possible computer biometrics, or a separate sensor device that can be placed on desktop (e.g., microphones for ambient noise detection and analysis, independent voiceprint identification, and/or to confirm no one else is present; cameras for additional biometric verification; accelerometers for detecting tampering/movement of devices; and/or pairing with verified computer and mobile devices, etc.).

In some embodiments, MFA kiosk may be integrated with existing systems. For example, an ATM can be integrated with a MFA kiosk to provide richer user authentication for more advanced banking options and financial transaction management (e.g., stock trading, deposits, account openings, cross border money transfers, wires, etc.).

Since a kiosk may optionally include a desk or workspace, MFA kiosk can add value to remote employment activities with sensitive data or other access elements. An existing space (e.g., conference room or office) could be configured as a kiosk with sufficient sensor coverage/density. Kiosks may be rated/scored based on both their completeness of sensor coverage, ability to monito the sensor integrity/audit of all digital and physical interaction with said sensors and data storage/transmission to the overall system/network, and the ongoing accuracy of verifications of sensors in part and in aggregate (e.g., recertification or periodic verification of both accurate and precise values). Scores may be adjusted for accuracy or precision concerns linked to overall score and profile uncertainty in each “kiosk visit”. In some embodiment, the system may include comparisons of visits and scores across direct measurements, factors, computed scores, or groups of factors or measurements of models. This may be at the personal level or other levels (e.g., all users of a given kiosk) to address accuracy, precision, security, audit, verification, or maintenance/optimization concerns. The resulting individual scores or profiles may direct the system to inform a user that a given kiosk is sufficient or insufficient to complete a given task given the context, timing, and place of a user and the actions seeking to be authorized. It should be appreciated that micro-kiosk can be used and combined with other readings. For example, in a hospital setting where someone may have been admitted and thoroughly documented/verified on intake and then has ongoing records of continued treatment that could be used as elements of evidence for the authentication process and therefor enable a high score to use fewer scoring support elements in subsequent verification processes (e.g., approving a surgical procedure). It should be further appreciated that the system can record various indicators which can include active medications or biofeedback signals (e.g., breath rate, pulse, blood oxygen, brainwaves, etc.) can also help establish the conditions under which a major decision/approval was given. This could substantially improve current issues with areas like medical malpractice and consent with are plagued by “regret” based reinterpretation or preoperative consent and information when outcomes do not occur as desired. This can improve healthcare outcomes and costs by ensuring accurate recordation of consents to protect patrons and protecting against overzealous plaintiffs seeking to abuse legal processes when known risks manifest. Similarly, a “kiosk scan” prior to an airline pilot boarding and taking control of several hundred patrons or a surgeon prior to final cleanup before surgery can create powerful disincentives for misconduct and protect consumers reliant on their professional state and ability.

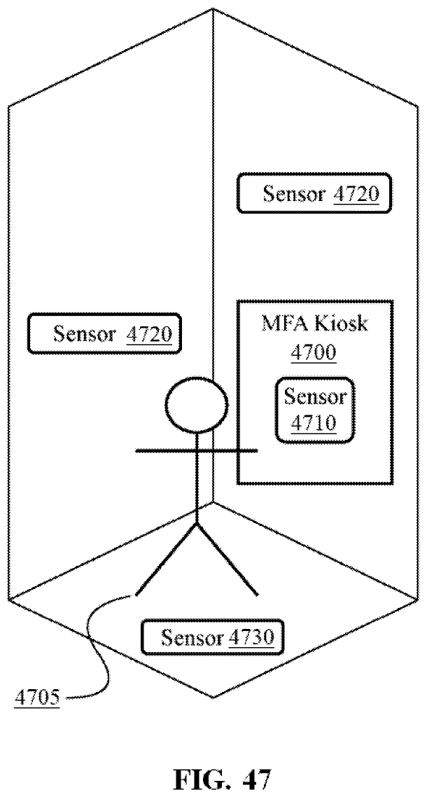

FIG. 47 is a diagram illustrating an exemplary embodiment of an MFA kiosk configured for immersive authentication. According to the embodiment, an MFA kiosk 4700 may be configured to provide immersive authentication wherein the individual seeking authentication may step into the kiosk to complete an authentication transaction. In certain embodiments, an immersive MFA kiosk may comprise an fully enclosed space (e.g., a photobooth or phone booth type of arrangement). In certain other embodiments, an immersive MFA kiosk may comprise a partially enclosed space (e.g., a cubicle type of arrangement). It should be appreciated that no matter the arrangement, a plurality of sensor may be deployed on any suitable surface of the kiosk such as on/in a surface on the floor as shown with sensor 4730, on/in the surface of the wall as shown with sensors 4720, on/in the surface of the ceiling, and hanging or otherwise suspended from any of these surfaces.

According to the embodiment, the MFA kiosk 4700 is deployed at a physical location such as at an airport, bank, sports venue, medical facility, research facility, military facility, corporate office, and/or the like. MFA kiosk 4700 may comprise one or more onboard sensors 4710 integrated into the structure of the MFA kiosk and configured to capture, measure, and transmit various physical, biometric, physiological, and/or attributes of the user 4705 in order to facilitate user authentication. Additionally, or alternatively, one or more sensors 4720 may be present and surrounding the kiosk and communicatively coupled with the kiosk via a suitable network connection and able to transmit various physical, biometric, physiological, and/or attributes of the user 4705 in order to facilitate user authentication.

In this embodiment, MFA kiosk 4700 includes at least one sensor on a surface on the ground in front of the kiosk, the at least one sensor able to provide authentication data. For example, one or more pressure sensors may be deployed in a surface in front of MFA kiosk so that when a kiosk user steps in front of the kiosk to facilitate authentication by capturing data related to the user's gait or walking pattern. The surface may be a purpose built surface with embedded sensors. For example, the surface could be a pad made from vinyl (or plastic or any other suitable material) with one or more sensor arrays embedded therein.

A kiosk user can stand inside of immersive MFA kiosk 4700 to facilitate authentication. If it's the individual's first time using an MFA kiosk 4700 then the kiosk may use the plurality of sensors 4710, 4720, and 4730 to capture a plurality of physical, biometric, behavioral, and physiological data associated with the individual to create a physical profile of the user which can be used as a factor in a multi-factor authentication process. Additionally, MFA kiosk 4700 may also capture device data associated with the individual's mobile device in order to link the mobile device with individual and their physical profile. In some embodiments, during an initial interaction with MFA kiosk 4700, the user may be asked to provide other types of information including, but not limited to, user demographics, user secrets (e.g., password, pin, or key), general user knowledge (e.g., historical addresses, mother's maiden name, favorite food, etc.), user contact information (e.g., email address, social media handle, phone number, physical address, etc.), and any other information that could be used identify or otherwise verify the user. In some embodiments, during an initial authentication event of an individual the kiosk may prompt the user to perform one or more specific physical actions as part of the data capture process for constructing the physical profile of the individual. For example, the kiosk could prompt (e.g., voice or text-based prompt or both) the user to touch a series of body parts (e.g., head, shoulders, knees, and toes) to create physical movement that can be included as a component of the physical profile.

In operation, when it is not an individual's first time using MFA kiosk 4700 then the kiosk uses the plurality of sensors 4710, 4720, and 4730 to capture a plurality of physical, biometric, and physiological data associated with the individual, perform various processing of the data thereof, and compare the processed data to the stored physical profiles to identify/verify the individual as a factor for multi-factor authentication.

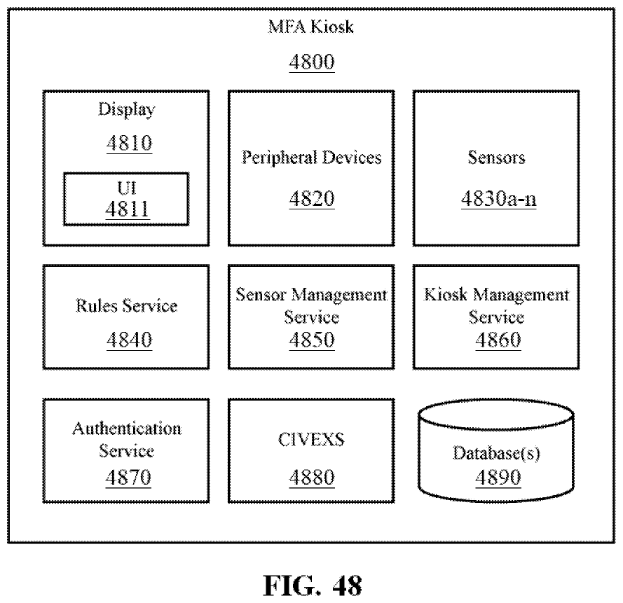

FIG. 48 is a block diagram illustrating an exemplary embodiment of a multi-factor authentication kiosk. According to some embodiments, MFA kiosk 4800 may be implemented as a computing system employing an MFA kiosk, the computing system comprising one or more hardware processors configured for executing the various methods and processes related to the authentication of an individual person and/or device. According to some aspects, MFA kiosk 4800 may be embodied as a computer-implemented method on a MFA kiosk, the computer-implemented method comprising performing various methods, steps, and processes related to the authentication of an individual person and/or device. In yet another embodiment, MFA kiosk 4800 may be implemented as a system for multi-factor authentication comprising one or more computers with executable instructions that, when executed, cause the system to execute various methods and processes related to the authentication of an individual person and/or device. In another embodiment, MFA kiosk 4800 may be implemented as non-transitory, computer-readable storage media having computer-executable instructions embodied thereon that, when executed by one or more processors of a computing system employing an MFA kiosk, cause the computing system to execute various methods and processes related to the authentication of an individual person and/or device.

As illustrated, MFA kiosk 4800 may represent an immersive or non-immersive embodiment. MFA kiosk 4800 may represent a micro-kiosk in some embodiments.

According to the embodiment, MFA kiosk 4800 comprises a user interface (UI) 4811 which may be a graphic user interface (GUI) rendered on a display unit 4810 of the kiosk. A display and user interface are not necessary, but may make it easier to facilitate some authentication processes in one or more aspects of the embodiment. The display may be an interactive touchscreen. Additionally, MFA kiosk 4800 may be connected to or integrated with (i.e., embedded in the system) one or more I/O (input/output) devices 4820 which can be used for the input and output of data or signals as required by the kiosk. Exemplary peripheral devices can include input devices (e.g., keyboard, mouse, touchpad or trackpad, graphic tablet, etc.), output devices (e.g., monitor or display, printer, projector, transducers, etc.), storage devices (e.g., hard disk drive, solid state drive, etc.), audio devices (e.g., speakers, headphones or earphones, microphones, etc.), webcam, game controllers, joystick, virtual reality or augmented reality hardware (e.g., headset, goggles), biometric devices (e.g., fingerprint scanner, facial recognition camera, etc.), and/or the like.

According to the embodiment, MFA kiosk 4800 further comprises a plurality of sensors 4830a-n either directly integrated into the structure of the kiosk or otherwise embedded in the system. Additionally, or alternatively, an external set of sensors may be added to the system that operate outside of the structure of the kiosk, but still able to communicate data to the kiosk for the purpose of authentication. Both sets of sensors may be configured to capture various physical, biometric, and physiological data of an individual interacting with the kiosk for the purpose of authenticating the individual. The plurality of physical, biometric, behavioral, and physiological data captured by sensors 4820a-n can be used to construct a physical profile of an individual that can be used as a factor in multi-factor authentication. Some exemplary sensors that may be implemented in various embodiments of MFA kiosk can include, but are not limited to, infrared scanner, fingerprint scanner, facial recognition camera, iris scanner, voice recognition via audio sensors, hand geometry scanner, vein scanner, gait analysis via camera and/or pressure sensors, gyroscopes, accelerometers, electrocardiogram (ECG) sensors, x-ray sensors, and body odor sensors.

A physical profile of a user may comprise one or more unique physical, biometric, behavioral, and/or physiological attributes or traits of an individual which can be used to identify, verify, and/or authenticate the individual using MFA kiosk 4800. Examples of physical or behavioral characteristics/attributes of an individual for the purpose of identification or authentication that can be included in an individual's physical profile and based on data captured by MFA kiosk 4800 can include, but are not limited to, fingerprints, facial recognition, iris patterns, retina patterns (e.g., analyze blood vessel patterns at the back of the eye using a low-intensity infrared light to capture unique patterns), voice recognition (e.g., analyzer voice characteristics such as pitch, tone, and speech patterns), hand geometry (e.g., capture length, width, thickness, and surface area of the hand to create a template for identification), vein patterns (e.g., analyze the vein patterns beneath the skin's surface using near-infrared light to capture the unique vein patterns), gait analysis, ECG patterns, signature recognition, key stroke analysis and dynamics (e.g., capture the timing, pressure, and duration of key strokes to create a behavioral biometric for authentication), body odor composition (e.g., analyze the unique chemical composition of an individual's body odor), ear shape recognition (e.g., analyze shape and structure of the ear to capture unique features such as the size and shape of the ear canal), palm print recognition, lip motion analysis, nailbed recognition (e.g., captures the patterns and features of the nailbed for identification), posture analysis (e.g., how a person sits, stands, or moves), and thermal facial recognition. These exemplary biometric and behavioral characteristics demonstrate the diversity of technologies that may be used to capture and analyze various physiological and behavioral traits for identification and authentication purposes. The choice of specific biometric method(s) often depends on various factors such as security requirements, user acceptance, rules and policies, and the intended application of the embodiment.

MFA kiosk 4800 may comprise a plurality of services, each of which may be configured to perform various tasks related to authentication, data management, and kiosk operational management, among others. According to the embodiment, a kiosk management service 4860 is present and configured to provide functionality for the management and operation of a kiosk such as, for example, registering kiosks and detecting counterfeit kiosks. When registering a kiosk to be a part of a MFA kiosk network, kiosk management service 4860 may utilize network policies that include encryption standards, authentication methods, and specific protocols in use. Additionally, kiosk management service 4860 can ensure that the registered kiosk has a unique identifier, such as a MAC address or device certificate, that can be used to track and manage the kiosk on the network. In embodiments where multiple MFA kiosks create a network, kiosk management service 4860 enforces secure connection methods to establish communication with each other and the network. This may involve using WPA2/WPA3 for Wi-Fi networks of a virtual private network for secure remote connection. Kiosk management service 4860 may also be configured to monitor log data and security alerts to identify any unusual or unauthorized activities.

According to some aspects, kiosk management service 4860 can be configured to gather kiosk operational data. Kiosk management service 4860 can be further configured to gather kiosk operational data over a given time interval (e.g., one hour, one day, one week, etc.). Kiosk management service 4860 may be further configured to gather operational data with respect to an individual kiosk, or multiple kiosk forming a group or sub-group. Operational data can include, but is not limited to, the number of unique users interacting with the kiosk, the number of authentication attempts (successful and unsuccessful), average time spent by users at the kiosk, sensor usage statistics (e.g., which biometric sensors are used most frequently), system performance metrics (e.g., response times, processing times, memory usage, etc.), error logs and diagnostic information, software and firmware version information, kiosk uptime and availability, energy consumption, and user feedback and ratings. This operational data can provide insights into the usage patterns, performance, and health of the kiosk system. It can help identify potential issues, optimize resource allocation, plan maintenance activities, and make data-driven decisions to improve the overall user experience and operational efficiency of the MFA kiosk network.

According to the embodiment, MFA kiosk 4800 further comprises a rules service 4840 which can allow for the setting of various rules and policies directed to authentication. The owner/operator or an administrator of an MFA kiosk 4800 may be able to set rules and policies directed to authentication and which may be applied at various scales such as, for example, applied locally only to authentication tasks performed by single kiosk or applied to a subset of (or entirety of) a network of connected kiosks. Rules and policies may be set to apply at the individual user, group, or subgroup level. For example, an individual user may have to be authenticated at the group level using set of rules and policies, and then authenticated at the individual level using a stricter set of rules and policies. The stricter set of rules and polices may be specific to an individual user and different than those applied to another individual even if that individual belongs to the same group. Rules and policies may be applied based on geographical constraints. For example, for a network of connected MFA kiosks stationed around a city, a specific set of rules and policies may be applied to only kiosks operating in a geographic area of the city corresponding to an area code. As another example, for a network of connected MFA kiosks in a medical facility, a different set of rules and policies may be applied to each floor or wing.

According to the embodiment, rules and polices may be stored in a rules database 4890 stored in a memory and/or non-volatile data storage device. A simple example of a rule and policy related to authentication that may can be applied by rules service 4840 is a rule related to password complexity. For example, the rule could require users to create strong and complex passwords utilizing a sequence of body movements (e.g., hand gestures, limb movement/positioning, specific movement such as a jumping jack, etc.). A rule/policy may be directed to account lockout policy which temporarily lock user accounts after a specified number of unsuccessful login attempts with definable duration and lockout period parameters. According to an embodiment, one or more rules/policies can be directed to user account provisioning and de-provisioning that establishes processes for creating, modifying, and deleting user accounts. For example, a policy may ensure the system disable or delete accounts promptly when employees leave an organization.

According to various embodiments, one set of rules and policies is directed to multi-factor authentication, wherein users must provide multiple forms of identification (e.g., password, PIN, and biometric verification). Rules and polices directed to MFA may specify authentication parameters such as the number and types of factors required for authentication. In various embodiments, at least one of the factors is a biometric factor based on a physical profile. The multiple factors may include something the user knows (e.g., password involving physical movement), something the user is (e.g., biometric), and something the user has (e.g., a device). In some embodiments, MFA may comprise secret, knowledge, and fact-based authentication together in some combination. Additional factors can include one-time passwords, smart cards, or mobile application authentications as part of the multi-factor authentication process. In some embodiments, the order of knowledge or biometric indicators may be configured to augment and generate a unique password (i.e., elbows, shoulders, knees and toes from the children's song but could equally include gait, heartbeat, brainwaves, eyes, finger on left hand then thumb on right hand, etc.).

According to various embodiments, one set of rules and policies is directed to the creation and modification of physical profiles. These rules/policies may indicate the type(s) of biometric and/or behavioral characteristics/attributes to be included in the physical profile. Additionally, these rules/policies may indicate a precedence level to be applied to each of a plurality of stored biometric and/or behavioral characteristics such that some characteristics may be weighted more significantly (or less) when compared to another stored characteristic. In this way, a hierarchy of biometric and/or behavioral characteristics can be established and utilized during multi-factor authentication processes as conducted by MFA kiosk 4800. In some embodiments, this hierarchical representation of characteristics may be used to create different tiers of authentication, wherein access to a service, application, and/or endpoint is restricted only to users that can provide authentication to the appropriate tier.

According to various embodiments, one set of rules and policies is directed to data retention polices that define clear data retention that limit the storage duration of biometric data and outline secure deletion processes to permanently remove biometric data when it is no longer needed.

According to the embodiment, MFA kiosk 4800 further comprises a sensor management service 4850 which can provide functionality directed to the management and deployment of various sensors 4830a-n both onboard and/or exterior to the kiosk. A kiosk owner/operator or administrator can use sensor management service 4850 to set operational parameters of the plurality of sensors 4830a-n. A set of operational parameters can include information related to, but not limited to, the sampling rate (e.g., the rate at which sensors take measurements), resolution (e.g., the smallest detectable change in the quantity being measured), sensitivity, range (e.g., the range of values over which the sensor can effectively operate), filtering, and threshold (e.g., setting threshold levels for triggering alarms or specific actions based on sensor readings exceeding or falling below certain values). Additional operational parameters can include integration time (e.g., duration over which the sensor collects data for a single measurement), power consumption, communication protocol (e.g., I2C, SPI, UART, Bluetooth, Wi-Fi, etc.), data format (e.g., specifying the format in which the sensor data is transmitted or stored, encryption, operating temperature range, response time, and auto-scaling (e.g., enabling or disabling auto-scaling features that adjust the sensor's dynamic range based on the input signals). These parameters can be adjusted and configured to optimize the performance of a sensor or sensor array for specific applications and environmental conditions. It should be appreciated that different sensor types (e.g., temperature sensors, pressure sensors, image sensors) may have unique parameters relevant to their specific measurement characteristics.

In some implementations, sensor management service 4850 is configured to monitor and/or obtain sensor state information and perform various processing and analysis thereof. General sensor state information can include data such as the total number of sensors reporting to the kiosk, the type of sensors (e.g., electromagnetic, pressure, x-ray, cranial, etc.), a type of biometric associated with the sensor (e.g., a facial template from a facial recognition camera), and other sensors specifics such as operating parameters. More specifically, sensor state information can comprise information about completeness of sensor coverage, audit data of all physical and digital interactions with sensors, and recent measurements (e.g., to perform ongoing accuracy verifications of sensors in part and/or in aggregate). Sensor state information may include derived data such as sensor accuracy and precision measurements computed based on recent measurement data. Sensor management service 4850 may store received and/or derived sensor state information in database 4890. In some embodiments, a subset of sensor state information may be used as input into a scoring model to determine an authentication score for a profile. For example, sensor capabilities and sensor accuracy/precision values for each sensor may be considered when generating an authentication score for an individual or a kiosk.

According to the embodiment, MFA kiosk may optionally comprise a cloud identity verification exchange service (CIVEXS) 4880 which enables verification of authentication transactions across multiple cloud identity providers, providing a single service where any Identity Provider can enroll and add a record of identity assertions. Additionally, CIVEXS 4880 can provide the ability to understand the degree of identity assurance risk associated with authentication transaction auditability, enforcement, and security in other organizations they interact with via the same CIVEXS capability. For more detailed information about CIVEX service 4880 please refer to U.S. Patent Application No. US/18354658, which is incorporated herein by reference.

According to the embodiment, MFA kiosk 4800 further comprises an authentication service 4870 configured to receive a plurality of biometric/behavioral data from sensors 4830a-n, process the biometric/behavioral data, and apply one or more rules/polices to the processed data to perform various authentication tasks for multi-factor authentication. For example, during an individual's initial interaction with the kiosk, authentication service 4870 can construct the individual's physical profile using the plurality of sensor data. Some of the biometric/behavioral data processing may be completed at the sensor and then the processed data can be sent to authentication service 4870 to perform authentication. For example, a facial recognition camera may have built in processors that can collect video data and process the video data to identify or verify the user.

According to an implementation, authentication service 4870 may implement one or more rules and polices directed to factor selection for multi-factor authentication. For example, a corporate policy may indicate that a password and one biometric/behavioral factor or a minimum computed authentication score is sufficient to gain access to a corporate office, but in order to access certain systems or processes, authentication may require a password augmented with physical movement or voice utterances and at least three biometric/behavioral factors. It should be further appreciated that one or more rules or policies may be directed to a hierarchy of factors which can be used for authentication. In such an embodiment, multi-factor authentication factors may be placed in tiers. For example, a first set of factors in the highest tier may be used to authenticate a user, wherein a single factor from the first set is sufficient for authentication. Continuing the example, a second set of factors may be placed in the second tier wherein multiple factors of second set of factors is required for authentication. In this embodiment, if an individual, for some reason, fails a tier one factor, then authentication service 4870 can optionally utilize multiple lower tier factors to provide authentication of the individual.

Authentication service 4870 may also be configured to collect authentication state information and process and/or analyze said data. Authentication state information can comprise general information such as a number of authentication attempts (per user, group, or in total) at the kiosk, a number of failed authentication attempts (per user, group, or in total) at the kiosk, and types of authentication factors per attempt. Obtained authentication state information may be stored in database 4890 and may be used as an input for generating an authentication score for a individual or a kiosk.

In at least one embodiment, authentication service 4870 may utilize a trained scoring model to generate an authentication score based on various inputs which may be obtained either from the one or more services or databases 4890 described herein. In some aspects of the embodiment, the scoring model may be a trained machine or deep learning algorithm. According to an aspect the deep learning algorithm is a neural network such as a multi-layer perceptron or a recurrent neural network. Given the complexity and the non-linearity in the data, a deep learning model such an autoencoder may be implemented in some embodiments, due to its ability for unsupervised feature learning. Scoring model input data can include sensor state information, authentication state information, and rule/policy based information. Creating an authentication scoring model based on a variety of inputs such as biometric sensor data, information about previous authentication attempts, and authentication rules/policies involves a combination of feature engineering and data preprocessing.

Feature engineering may comprise extracting relevant features from biometric sensor data, such as sensor type, accuracy, precision, and the type of biometric factor measure, incorporating features related to previous authentication attempts such as total number of attempts, total failed authentications, and the types of factors used, and including features from authentication rules and polices such as the type and number of biometric factors required, specific movements or actions as factors, and any group-specific or individual-specific rules. According to an embodiment, an autoencoder (or other classifier network) trained on this type of data can generate as output an authentication score for an individual or kiosk. For example, an autoencoder may output a numerical value between 0 and 1.0, inclusive, which corresponds to a classification related to authentication that can be interpreted as the authentication score.

Biometric data security is necessary to protect individuals' sensitive information from unauthorized access and potential misuse. MFA kiosk can implement strong security measures for storing and protecting biometric data such as using encryption and following best practices to prevent unauthorized access to or tampering of stored physical profiles (and the biometric templates stored therein). In various embodiments MFA kiosk 4800 utilizes encryption for both the transmission and storage of biometric data. For example, MFA kiosk can be configured to use secure socket layer or transport layer security protocols for encrypting data transmitted between devices, services, and databases. Furthermore, MFA kiosk can encrypt stored biometric templates in the database using strong encryption algorithms to safeguard against unauthorized access. Some aspects may implement encryption at the file level to secure biometric data stored in files (e.g., physical profile) or databases. One method for secure storage may involve tokenization, wherein the kiosk is configured to store references or tokens instead of raw biometric data to protect sensitive information. Another method may involve hashing wherein biometric data is converted into irreversible hashes using strong cryptographic hashing algorithms. In some embodiments, MFA kiosk may be designed for isolation of components such that components are physically and logically separate to reduce the risk of unauthorized access. Additionally, MFA kiosk 4800 may be configured to ensure compliance with data protection regulations such as GDPR, HIPAA, CCPA or other relevant laws that govern the collection and storage of biometric data.

According to at least one embodiment, database 4890 may comprise an immutable digital ledger on which sensor data (in whole or in part) is kept on record for posterity. For example, block chain technology may be used in an aspect of an embodiment to provide an immutable digital ledger for storage of sensor data, but also physical profiles biometric template data.

### Detailed Description of Exemplary Aspects of MFA Kiosk System

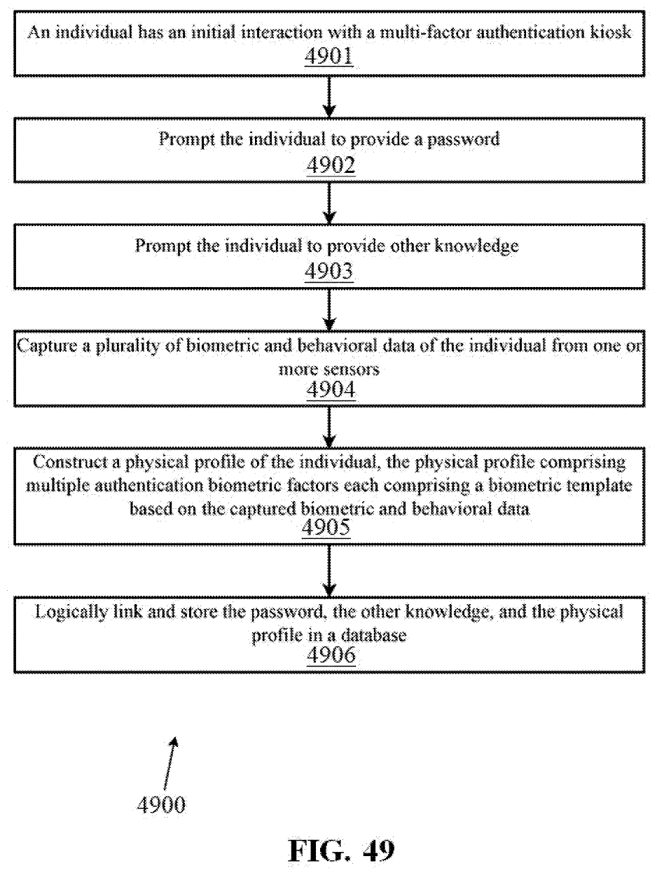

FIG. 49 is a flow diagram illustrating an exemplary method 4900 for constructing a physical profile for an individual during an initial interaction with an MFA kiosk, according to an embodiment. According to an embodiment, the process begins at step 4901 during an individual's initial interaction with a multi-factor authentication kiosk. In embodiments wherein a display is present MFA kiosk may display a greeting or some other message when an individual approaches. For example, one or more sensors (e.g., cameras, motion sensors, pressure sensors in the surface of the floor, heat/infrared sensors, microphones, etc.) may determine when an individual approaches the kiosk and displays an introductory message/greeting or some form of prompt directed to the individual. As another example, the kiosk may be able to detect a device of an individual that approaches the kiosk to determine when an individual is present. In some implementations, biometric/behavioral data may be captured by the MFA kiosk and compared against stored physical profiles and biometric templates to determine if the individual has a stored physical profile in the system. In some embodiments, the kiosk may prompt the individual for consent prior to capturing the individual's biometric/behavioral data.

It is determined that the individual does not have a profile on record so the user registration process may begin (with the user's consent) and the individual may be prompted to provide a password at step 4902. The registration process may comprise various steps of gathering user data and compiling a physical profile. The password (or some other form of secret knowledge) may be stored as part of the physical profile of the individual user or otherwise logically linked to the physical profile. The individual's password may be augmented according to one or more rules or policies to enhance security and user verification. For example, a password can be augmented with a series of physical movements or any other biometric indicator (e.g., gait, heartrate, vein pattern, surgical debris such as screws, plates or other implants, iris pattern, brainwaves, etc.). At a next step 503, MFA kiosk prompts the individual to provide other knowledge such as general knowledge and user demographics.

At step 4904 MFA kiosk captures a plurality of biometric and behavioral data of the individual from one or more sensors. The biometric data may be processed locally by the sensor (if the sensor is configured for such actions) or it may be processed by an authentication service 4870 configured to create various biometric templates which are then stored in the physical profile and used as biometric factors for multi-factor authentication, according to various embodiments. Exemplary biometric templates can include, but are in no way limited to, fingerprint, facial template, iris pattern, retina template, voice template, hand geometry template, vein pattern template, gait template, ECG template, signature template, key stroke template, body odor template, ear shape template, palm print, lip motion template, nailbed template, posture template, thermal facial template, and blood flow template, to name a few. At step 4905 MFA kiosk constructs the physical profile of the individual, the physical profile comprising multiple authentication biometric factors each comprising a biometric template based on the capture biometric and behavioral data. As a last step 4906, MFA kiosk logically links (or incorporates) and stores the password, the other knowledge, and the physical profile in a database. The data may be encrypted and stored to protect the individual's information.

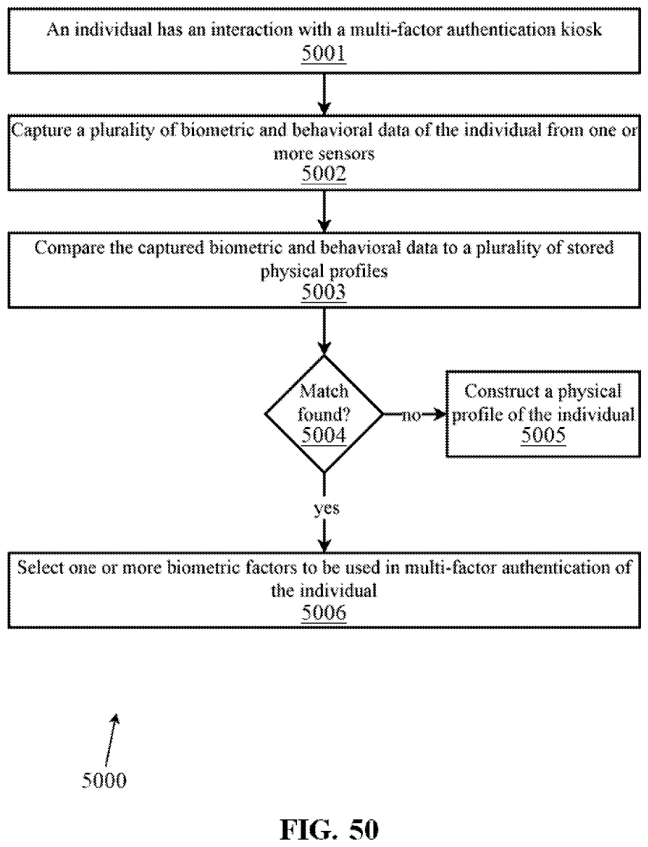

FIG. 50 is a flow diagram illustrating an exemplary method 5000 for providing multi-factor authentication to an individual using an MFA kiosk, according to an embodiment. According to an embodiment, the process begins at step S001 when an individual interacts with a multi-factor authentication kiosk. The individual may be seeking access to a restricted, controlled, or otherwise secured service, application, endpoint, resource, and/or location. In some embodiments, the individual may receive a prompt from the kiosk. The prompt may be a request to perform a specific action (e.g., stand still, perform series of gestures related to an augmented password, recite a phrase, follow a breathing pattern, etc.) or a request for information. The prompt may indicate to the individual that authentication is happening and to be still or to move to specified location near or around the kiosk to facilitate biometric and/or behavioral data capture. At step S002 the MFA kiosk captures a plurality of biometric and behavioral data of the individual from one or more sensors. At step S003, MFA kiosk compares the captured biometric and behavioral data to a plurality of stored physical profiles. A check is made 5004 whether a match was found or not. If no match is found then the process proceeds to step S005 wherein MFA kiosk constructs a physical profile of the individual in a process which may be implemented similar to method 4900. If instead, a match is found then the process proceeds to step S006 wherein MFA kiosk selects one or more biometric factors to be used in multi-factor authentication of the individual. In some embodiments, the selection of the type and/or quantity of biometric factor may be based at least in part on one or more rules or policies. In some embodiments, the selection of the type and/or quantity of biometric factor may be based at least in part on the location of the kiosk. In some embodiments, the selection of the type and/or quantity of biometric factor may be based at least in part on the status of prior authentication attempts or events associated with individual or physical profile. For example, in embodiments with hierarchical biometric factors, overcoming a failure of a higher tier authentication factor may require an individual to pass multiple lower tier authentication factors to be fully authenticated.

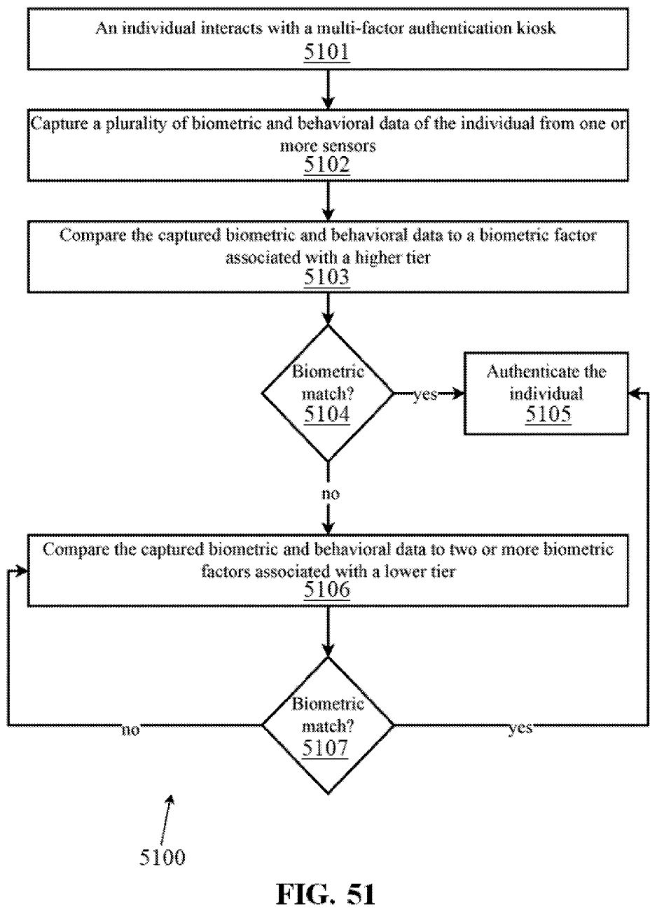

FIG. 51 is a flow diagram illustrating an exemplary method 5100 for providing multi-factor authentication to an individual using an MFA kiosk with hierarchical biometric factors, according to an embodiment. According to an embodiment, the process begins at step S101 when an individual interacts with a multi-factor authentication kiosk. The individual may be seeking access to a restricted, controlled, or otherwise secured service, application, endpoint, resource, and/or location. In some embodiments, the individual may receive a prompt from the kiosk. The prompt may be a request to perform a specific action (e.g., stand still, perform series of gestures related to an augmented password, recite a phrase, follow a breathing pattern, etc.) or a request for information. The prompt may indicate to the individual that authentication is happening and to be still or to move to specified location near or around the kiosk to facilitate biometric and/or behavioral data capture. At step S102 the MFA kiosk captures a plurality of biometric and behavioral data of the individual from one or more sensors. At step S103, MFA kiosk compares the captured biometric and behavioral data to a biometric factor associated with a higher (e.g., a first) tier. A plurality of biometric factors may be arranged into a hierarchy comprising various factor tiers, wherein biometric factors in a higher tier represent more secure or accepted factors for multi-factor authentication than biometric factors assigned to a lower tier. In some embodiments, the hierarchy of biometric factors may be based at least in part on one or more rules or polices which may be specified by the kiosk owner/operator or administrator. In some embodiments, the hierarchy may be based at least in part on the available sensors, their configuration, and calibration.

A check is made 5104 whether a match was found or not. If a match was found, then the process proceeds to step S105 wherein MFA kiosk authenticates the individual using the matched higher tier biometric factor. If instead, a match is not found, then the process proceeds to step S106 wherein MFA kiosk compares the captured biometric and behavioral data to two or more biometric factors associated with a lower tier. In some embodiments, the selection of the type and/or quantity of biometric factors from the lower tier may be based at least in part on one or more rules or policies. In some embodiments, the selection of the type and/or quantity of biometric factors from the lower tier may be based at least in part on the location of the kiosk. In some embodiments, the selection of the type and/or quantity of biometric factors may be based at least in part on the status of prior authentication attempts or events associated with individual or physical profile. For example, in embodiments with hierarchical biometric factors, overcoming a failure of a higher tier authentication factor may require an individual to pass multiple lower tier authentication factors to be fully authenticated. Another check is made at 5107 to determine if two or more of the selected biometric factors match the captured biometric and behavioral data. If a match is found then the user may be authenticated at step S105. If a match is not found then the process repeats step S106 with a lower tier of biometric factors. This process may be repeated until the individual has been authenticated, until the individual has exhausted all existing tiers, or the individual is locked out due to rules which regulate the number of attempts at authentication that may be attempted before the account is locked.

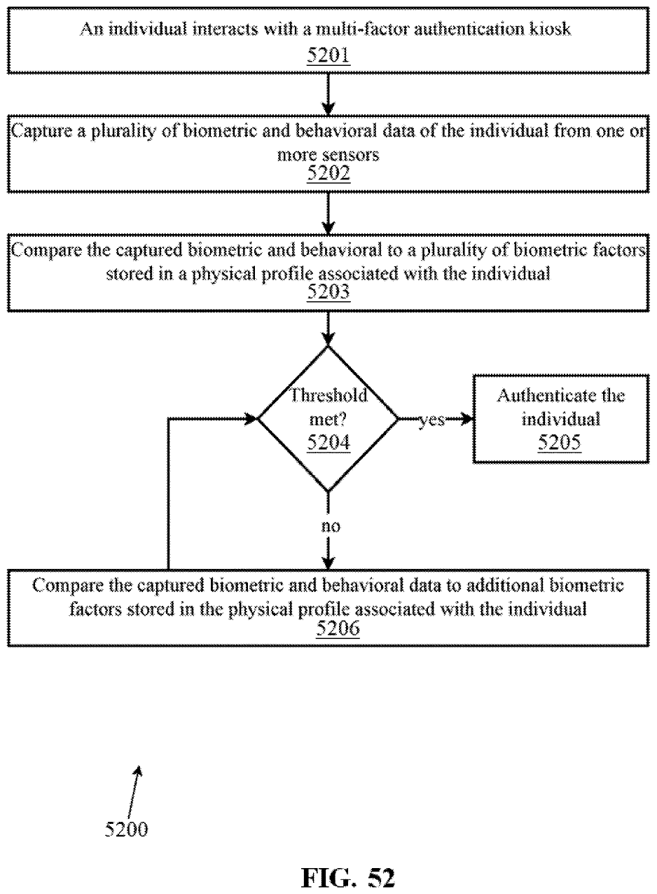

FIG. 52 is a flow diagram illustrating an exemplary method 5200 for providing multi-factor authentication to an individual using an MFA kiosk with an authentication threshold, according to an embodiment. According to an embodiment, the process begins at step S201 when an individual interacts with a multi-factor authentication kiosk. The individual may be seeking access to a restricted, controlled, or otherwise secured service, application, endpoint, resource, and/or location. In some embodiments, the individual may receive a prompt from the kiosk. The prompt may be a request to perform a specific action (e.g., stand still, perform series of gestures related to an augmented password, recite a phrase, follow a breathing pattern, etc.) or a request for information. The prompt may indicate to the individual that authentication is happening and to be still or to move to specified location near or around the kiosk to facilitate biometric and/or behavioral data capture. At step S202 the MFA kiosk captures a plurality of biometric and behavioral data of the individual from one or more sensors. At step S203, MFA kiosk compares the captured biometric and behavioral data to a plurality of biometric factors stored in a physical profile associated with the individual. At 5204 a check is made to determine if a predetermined threshold of authentication has been met. If the threshold has been met, then MFA kiosk authenticates the individual at step S205. In some embodiments, the threshold may be based at least in part on one or more rules or polices which may be specified by the kiosk owner/operator or administrator.

In embodiments wherein an authentication threshold is used to authenticate the individual, the various biometric factors may be assigned a score, weight, or some other value that indicates an increment of authentication that that particular biometric factor contributes to an overall authentication threshold value. In such embodiments, the scores/weights associated with matched biometric factors may summed or otherwise aggregated to compute a total authentication score. If the total authentication score meets or exceeds the predetermined threshold value, then the individual may be authenticated at step S205. If the threshold is not met, then the process proceeds to step S206 wherein MFA kiosk compares the captured biometric and behavioral data to additional biometric factors stored in the physical profile associated with the individual. The scores/weights of the matched additional biometric factors may be added to the total score computed at step S203 to determine if the threshold is met at 5204. This process repeats until the individual is authenticated, all existing biometric factors are exhausted, or the individual is locked out due to rules which regulate the number of attempts at authentication that may be attempted before the account is locked.

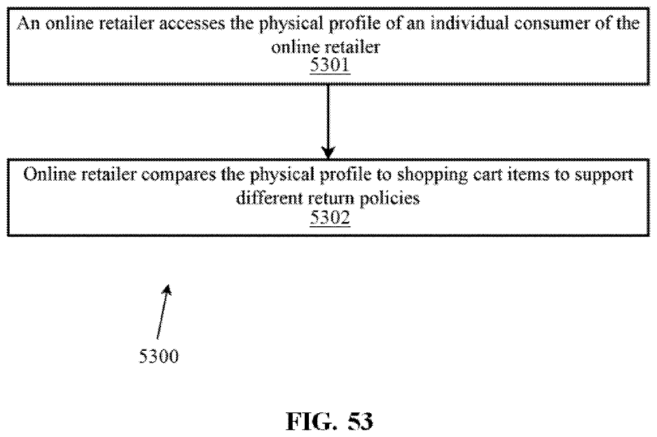

FIG. 53 is a flow diagram illustrating an exemplary method 5300 for utilizing an MFA kiosk to facilitate e-commerce transactions, according to an embodiment. According to an embodiment, the process begins at step S301 when an online retailer accesses the physical profile of an individual who is also a consumer of the online retailer. The online retailer can then compare the physical profile to the shopping cart items to support different business policies at step S302. For example, the retailer could compare the verified physical profile of the consumer with shopping cart items to support different return policies based on its actual and expected sizing of clothing or footwear. Continuing the example, if the consumer says they are buying a piece for themselves and its within their sizing windows they may have different pricing on shipping, returns, etc. than if the consumer was buying a gift for another person without a profile. Similarly, if the profile is registered and available to the retailer for gift purposes, there may likewise be different pricing, return policies, or shipping options or procedures. Since returned clothing is often processed through massive reverse logistics systems that are rampant with overhead costs, product degradation, etc., this can enable strong incentives for accurate buying and gifting while allowing retailers to avoid intentional theft via malicious rentals where clothes are over ordered or “borrowed” via return policy abuse in letter or spirit.

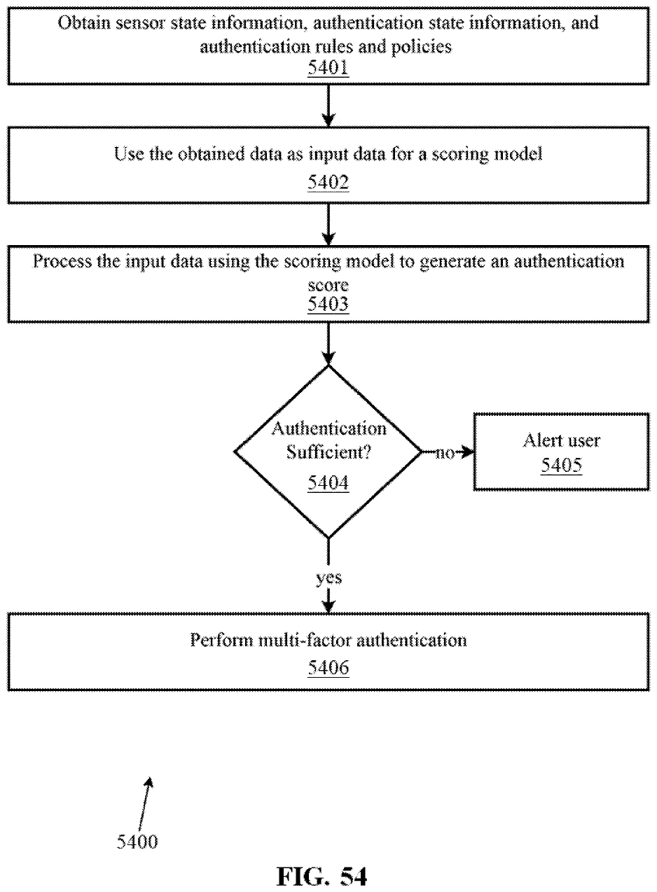

FIG. 54 is a flow diagram illustrating an exemplary method 5400 for a MFA kiosk providing multi-factor authentication using an authentication score, according to an embodiment. According to the embodiment, the process begins at step S401 wherein authentication service obtains sensor state information, authentication state information, and authentication rules and polices. The obtained information may be retrieved from storage in database 4890 or directly from one or more other services operating on the kiosk. At step S402, the obtained data is used as input data for a trained scoring model. The trained scoring model may be a neural network or variation thereof, according to an embodiment. The trained scoring model process the input data to generate an authentication score at step S403. The authentication score may be indicative of whether a given kiosk is sufficient or insufficient to complete a given task (i.e., authentication task) given the context, timing, and place of the user and the actions seeking to be authorized. A check is made at 5404 whether the computed authentication score means the kiosk is sufficient. If the authentication is not sufficient, then the process proceeds to step S405 wherein MFA kiosk can alert the user that the kiosk may not be able to provide the level of authentication needed to complete the action. If instead, the authentication is sufficient, then the process proceeds to step S406 wherein the MFA kiosk performs the multi-factor authentication according to one or more of the various methods described herein.

### Exemplary Computing Environment

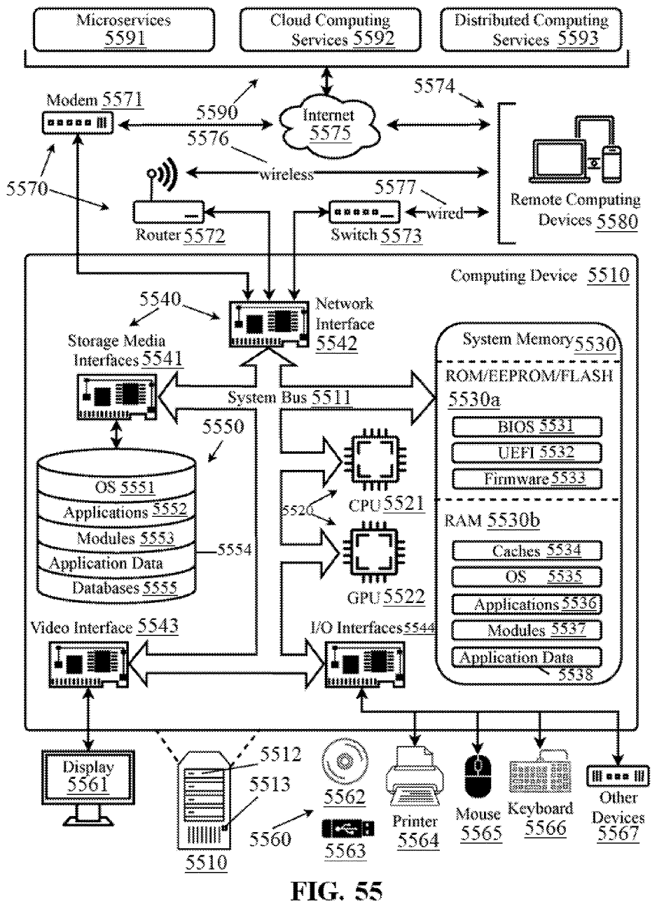

FIG. 55 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 5510 (further comprising a system bus 5511, one or more processors 5520, a system memory 5530, one or more interfaces 5540, one or more non-volatile data storage devices 5550), external peripherals and accessories 5560, external communication devices 5570, remote computing devices 5580, and cloud-based services 5590.

System bus 5511 couples the various system components, coordinating operation of and data transmission between, those various system components. System bus 5511 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 5520, system memory 5530 and other components of the computing device 5510 can be physically co-located or integrated into a single physical component, such as on a single chip. In such a case, some or all of system bus 5511 can be electrical pathways within a single chip structure.

Computing device may further comprise externally-accessible data input and storage devices 5512 such as compact disc read-only memory (CD-ROM) drives, digital versatile discs (DVD), or other optical disc storage for reading and/or writing optical discs 5562; magnetic cassettes, magnetic tape, magnetic disk storage, or other magnetic storage devices; or any other medium which can be used to store the desired content and which can be accessed by the computing device 5510. Computing device may further comprise externally-accessible data ports or connections 5512 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 5560 such as visual displays, monitors, and touch-sensitive screens 5561, USB solid state memory data storage drives (commonly known as “flash drives” or “thumb drives”) 5563, printers 5564, pointers and manipulators such as mice 5565, keyboards 5566, and other devices 5567 such as joysticks and gaming pads, touchpads, additional displays and monitors, and external hard drives (whether solid state or disc-based), microphones, speakers, cameras, and optical scanners.

Processors 5520 are logic circuitry capable of receiving programming instructions and processing (or executing) those instructions to perform computer operations such as retrieving data, storing data, and performing mathematical calculations. Processors 5520 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 5510 may comprise more than one processor. For example, computing device 5510 may comprise one or more central processing units (CPUs) 5521, each of which itself has multiple processors or multiple processing cores, each capable of independently or semi-independently processing programming instructions. Further, computing device 5510 may comprise one or more specialized processors such as a graphics processing unit (GPU) 5522 configured to accelerate processing of computer graphics and images via a large array of specialized processing cores arranged in parallel.

System memory 5530 is processor-accessible data storage in the form of volatile and/or nonvolatile memory. System memory 5530 may be either or both of two types: non-volatile memory and volatile memory. Non-volatile memory 5530a is not erased when power to the memory is removed, and includes memory types such as read only memory (ROM), electronically-erasable programmable memory (EEPROM), and rewritable solid state memory (commonly known as “flash memory”). Non-volatile memory 5530a is typically used for long-term storage of a basic input/output system (BIOS) 5531, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 5530a may also be used to store firmware comprising a complete operating system 5535 and applications 5536 for operating computer-controlled devices. The firmware approach is often used for purpose-specific computer-controlled devices such as appliances and Internet-of-Things (IOT) devices where processing power and data storage space is limited. Volatile memory 5530b is erased when power to the memory is removed and is typically used for short-term storage of data for processing. Volatile memory 5530b includes memory types such as random access memory (RAM), and is normally the primary operating memory into which the operating system 5535, applications 5536, program modules 5537, and application data 5538 are loaded for execution by processors 5520. Volatile memory 5530b is generally faster than non-volatile memory 5530a due to its electrical characteristics and is directly accessible to processors 5520 for processing of instructions and data storage and retrieval. Volatile memory 5530b may comprise one or more smaller cache memories which operate at a higher clock speed and are typically placed on the same IC as the processors to improve performance.

Interfaces 5540 may include, but are not limited to, storage media interfaces 5541, network interfaces 5542, display interfaces 5543, and input/output interfaces 5544. Storage media interface 5541 provides the necessary hardware interface for loading data from non-volatile data storage devices 5550 into system memory 5530 and storage data from system memory 5530 to non-volatile data storage device 5550. Network interface 5542 provides the necessary hardware interface for computing device 5510 to communicate with remote computing devices 5580 and cloud-based services 5590 via one or more external communication devices 5570. Display interface 5543 allows for connection of displays 5561, monitors, touchscreens, and other visual input/output devices. Display interface 5543 may include a graphics card for processing graphics-intensive calculations and for handling demanding display requirements. Typically, a graphics card includes a graphics processing unit (GPU) and video RAM (VRAM) to accelerate display of graphics. One or more input/output (I/O) interfaces 5544 provide the necessary support for communications between computing device 5510 and any external peripherals and accessories 5560. For wireless communications, the necessary radio-frequency hardware and firmware may be connected to I/O interface 5544 or may be integrated into I/O interface 5544.

Non-volatile data storage devices 5550 are typically used for long-term storage of data. Data on non-volatile data storage devices 5550 is not erased when power to the non-volatile data storage devices 5550 is removed. Non-volatile data storage devices 5550 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 5550 may be non-removable from computing device 5510 as in the case of internal hard drives, removable from computing device 5510 as in the case of external USB hard drives, or a combination thereof, but computing device will typically comprise one or more internal, non-removable hard drives using either magnetic disc or solid state memory technology. Non-volatile data storage devices 5550 may store any type of data including, but not limited to, an operating system 5551 for providing low-level and mid-level functionality of computing device 5510, applications 5552 for providing high-level functionality of computing device 5510, program modules 5553 such as containerized programs or applications, or other modular content or modular programming, application data 5554, and databases 55 such as relational databases, non-relational databases, and graph databases.

Applications (also known as computer software or software applications) are sets of programming instructions designed to perform specific tasks or provide specific functionality on a computer or other computing devices. Applications are typically written in high-level programming languages such as C++, Java, and Python, which are then either interpreted at runtime or compiled into low-level, binary, processor-executable instructions operable on processors 5520. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 5570 are devices that facilitate communications between computing device and either remote computing devices 5580, or cloud-based services 5590, or both. External communication devices 5570 include, but are not limited to, data modems 5571 which facilitate data transmission between computing device and the Internet 5575 via a common carrier such as a telephone company or internet service provider (ISP), routers 5572 which facilitate data transmission between computing device and other devices, and switches 5573 which provide direct data communications between devices on a network. Here, modem 5571 is shown connecting computing device 5510 to both remote computing devices 5580 and cloud-based services 5590 via the Internet 5575. While modem 5571, router 5572, and switch 5573 are shown here as being connected to network interface 5542, many different network configurations using external communication devices 5570 are possible. Using external communication devices 5570, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 5575. As just one exemplary network configuration, network interface 5542 may be connected to switch 5573 which is connected to router 5572 which is connected to modem 5571 which provides access for computing device 5510 to the Internet 5575. Further, any combination of wired 5577 or wireless 5576 communications between and among computing device 5510, external communication devices 5570, remote computing devices 5580, and cloud-based services 5590 may be used. Remote computing devices 5580, for example, may communicate with computing device through a variety of communication channels 5574 such as through switch 5573 via a wired 5577 connection, through router 5572 via a wireless connection 5576, or through modem 5571 via the Internet 5575. Furthermore, while not shown here, other hardware that is specifically designed for servers may be employed. For example, secure socket layer (SSL) acceleration cards can be used to offload SSL encryption computations, and transmission control protocol/internet protocol (TCP/IP) offload hardware and/or packet classifiers on network interfaces 5542 may be installed and used at server devices.

In a networked environment, certain components of computing device 5510 may be fully or partially implemented on remote computing devices 5580 or cloud-based services 5590. Data stored in non-volatile data storage device 5550 may be received from, shared with, duplicated on, or offloaded to a non-volatile data storage device on one or more remote computing devices 5580 or in a cloud computing service 5592. Processing by processors 5520 may be received from, shared with, duplicated on, or offloaded to processors of one or more remote computing devices 5580 or in a distributed computing service 5593. By way of example, data may reside on a cloud computing service 5592, but may be usable or otherwise accessible for use by computing device 5510. Also, certain processing subtasks may be sent to a microservice 5591 for processing with the result being transmitted to computing device 5510 for incorporation into a larger processing task. Also, while components and processes of the exemplary computing environment are illustrated herein as discrete units (e.g., OS 5551 being stored on non-volatile data storage device 5551 and loaded into system memory 5535 for use) such processes and components may reside or be processed at various times in different components of computing device 5510, remote computing devices 5580, and/or cloud-based services 5590.

Remote computing devices 5580 are any computing devices not part of computing device 5510. Remote computing devices 5580 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, main frame computers, network nodes, and distributed or multi-processing computing environments. While remote computing devices 5580 are shown for clarity as being separate from cloud-based services 5590, cloud-based services 5590 are implemented on collections of networked remote computing devices 5580.

Cloud-based services 5590 are Internet-accessible services implemented on collections of networked remote computing devices 5580. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 5590 are microservices 5591, cloud computing services 5592, and distributed computing services 5593.

Microservices 5591 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP or message queues. Microservices 5591 can be combined to perform more complex processing tasks.

Cloud computing services 5592 are delivery of computing resources and services over the Internet 5575 from a remote location. Cloud computing services 5592 provide additional computer hardware and storage on as-needed or subscription basis. Cloud computing services 5592 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over the Internet on a subscription basis.

Distributed computing services 5593 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power. These services enable parallel processing, fault tolerance, and scalability by distributing tasks across multiple nodes.

Although described above as a physical device, computing device 5510 can be a virtual computing device, in which case the functionality of the physical components herein described, such as processors 5520, system memory 5530, network interfaces 5540, and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 5510 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 5510 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

In some instances, the invention further includes a system and method for dynamic authentication attack detection an enforcement at the network, application, and host level that enables zero trust network security principles when combined with stateful authentication object tracking, authentication object manipulation and forgery detection, and assessment of authentication and identity attack surface. The methodology involves gathering all authentication objects issued by a network, storing the authentication objects in a centralized location for use in stateful deterministic authentication object tracking, scoring the completeness of the authentication risk observations, and intervening in authentication processes when the potential risk is too great.

Authentication profiling and scoring, when combined with identity attack paths, provides a holistic view of the identity-specific attack surface and exploitability of networks (especially when using Zero Trust paradigm which makes the identity and authentication layer the security boundary). This process improves Zero Trust principle realization around verification of end-to-end access and utilization of network resources, understanding and minimizing the impact of any given entity or credential being compromised, and implementing least privilege in actual practice via clear auditable relationships between what a given account, could, did, and should be able to access resources.

In recent years, cybersecurity has been moving from a paradigm of perimeter-based networks to a paradigm of zero trust networks. In the perimeter-based network paradigm, the perimeter of the network is protected by firewalls, demilitarized zones, anti-virus programs, and intrusion-prevention systems. Users and devices “inside” the perimeter of the network are trusted devices and can access many or most network resources without further authentication. Perimeter-based networks were appropriate when most users and devices were located onsite at the same physical location or were connected between multiple physical locations via virtual private networks. Now that networks are cloud-based, and users and devices on those networks can be located anywhere in the world, perimeter-based security is no longer sufficient as there are too many avenues of attack.

The zero trust network paradigm has been proposed as the next generation of network security. In theory, zero trust networks would be capable of dealing with the proliferation of users and devices on cloud-based networks as no device, either inside or outside of the network, is fully trusted, and every device is authenticated and verified for each access. Zero trust networks assume that bad actors are already inside the network and trying to gain access to resources. Unfortunately, current implementations of the zero trust paradigm are lacking, and themselves contain significant flaws and security vulnerabilities. Flaws of note in existing implementations are that 1) there is no stateful, deterministic means for detecting authentication forgeries, and 2) there is currently no way to know either what proportion of the network's traffic comprises lower-security protocols, or what proportion of users, devices, and transactions already within a network are threats to the network's security. What is needed is a system and method for zero trust network security combined with stateful deterministic authentication object tracking (which, in part, enables authentication object forgery detection) and assessment of the level of threat already existing within a network. A useful metric in such analysis is network “toxicity,” defined as the proportion of “good” authentications in the network versus “bad” authentications. Network “toxicity” can be analogized to a water quality report for municipal water systems which identifies the level of toxic substances in drinking water.

To implement a stateful, deterministic method of detecting authentication forgeries, a complete record of every authentication issued by a network must be kept so that the original authentication can be concretely identified for every authentication object presented for every attempted access to a network resource. This makes the detection of authentication forgeries both stateful (in that the current state of every authentication object can be determined) and deterministic (in that the validity of every authentication object presented for every request for access to network resources can be explicitly identified). Stateful, deterministic detection of authentication object forgeries provides greater security than heuristic methods, which rely on estimates or guesses as to whether forgeries may exist based on expected network behaviors.

The zero trust networks allow for dynamic revocation of credentials to client devices to preserve network security. Furthermore, in the instance where the system employs authentication delegation, this further allows for revocation of credentials to the device or user to which authentication was delegated.

### Definitions

As used herein, a “swimlane” is a communication channel between a time series sensor data reception and apportioning device and a data store meant to hold the apportioned data time series sensor data. A swimlane is able to move a specific, finite amount of data between the two devices. For example, a single swimlane might reliably carry and have incorporated into the data store, the data equivalent of 5 seconds worth of data from 10 sensors in 5 seconds, this being its capacity. Attempts to place 5 seconds worth of data received from 6 sensors using one swimlane would result in data loss.

As used herein, a “metaswimlane” is an as-needed logical combination of transfer capacity of two or more real swimlanes that is transparent to the requesting process. Sensor studies where the amount of data received per unit time is expected to be highly heterogeneous over time may be initiated to use metaswimlanes. Using the example used above that a single real swimlane can transfer and incorporate the 5 seconds worth of data of 10 sensors without data loss, the sudden receipt of incoming sensor data from 13 sensors during a 5 second interval would cause the system to create a two swimlane metaswimlane to accommodate the standard 10 sensors of data in one real swimlane and the 3 sensor data overage in the second, transparently added real swimlane, however no changes to the data receipt logic would be needed as the data reception and apportionment device would add the additional real swimlane transparently.

### Conceptual Architecture for Dynamic Authentication Attack Detection

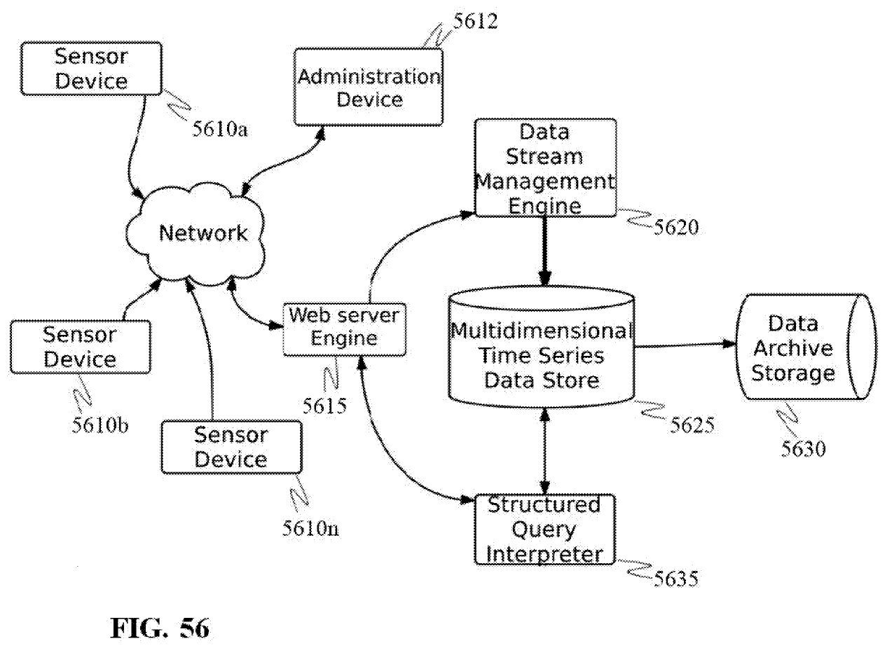

FIG. 56 is a diagram of an exemplary architecture of a system for the capture and storage of time series data from sensors with heterogeneous reporting profiles according to a preferred aspect of the invention 5600. In this embodiment, a plurality of sensor devices 5610a-n stream data to a collection device, in this case a web server acting as a network gateway 5615. These sensors 5610a-n can be of several forms, some non-exhaustive examples being: physical sensors measuring humidity, pressure, temperature, orientation, and presence of a gas; or virtual such as programming measuring a level of network traffic, memory usage in a controller, and number of times the word “refill” is used in a stream of email messages on a particular network segment, to name a small few of the many diverse forms known to the art. In the embodiment, the sensor data is passed without transformation to the data management engine 5620, where it is aggregated and organized for storage in a specific type of data store 5625 designed to handle the multidimensional time series data resultant from sensor data. Raw sensor data can exhibit highly different delivery characteristics. Some sensor sets may deliver low to moderate volumes of data continuously. It would be infeasible to attempt to store the data in this continuous fashion to a data store as attempting to assign identifying keys and store real time data from multiple sensors would invariably lead to significant data loss. In this circumstance, the data stream management engine 5620 would hold incoming data in memory, keeping only the parameters, or “dimensions” from within the larger sensor stream that are pre-decided by the administrator of the study as important and instructions to store them transmitted from the administration device 5612. The data stream management engine 5620 would then aggregate the data from multiple individual sensors and apportion that data at a predetermined interval, for example, every 10 seconds, using the timestamp as the key when storing the data to a multidimensional time series data store over a single swimlane of sufficient size. This highly ordered delivery of a foreseeable amount of data per unit time is particularly amenable to data capture and storage but patterns where delivery of data from sensors occurs irregularly and the amount of data is extremely heterogeneous are quite prevalent. In these situations, the data stream management engine cannot successfully use strictly single time interval over a single swimlane mode of data storage. In addition to the single time interval method the invention also can make use of event based storage triggers where a predetermined number of data receipt events, as set at the administration device 5612, triggers transfer of a data block consisting of the apportioned number of events as one dimension and a number of sensor ids as the other. In the embodiment, the system time at commitment or a time stamp that is part of the sensor data received is used as the key for the data block value of the value-key pair. The invention can also accept a raw data stream with commitment occurring when the accumulated stream data reaches a predesigned size set at the administration device 5612.

It is also likely that that during times of heavy reporting from a moderate to large array of sensors, the instantaneous load of data to be committed will exceed what can be reliably transferred over a single swimlane. The embodiment of the invention can, if capture parameters pre-set at the administration device 5612, combine the data movement capacity of two or more swimlanes, the combined bandwidth dubbed a metaswimlane, transparently to the committing process, to accommodate the influx of data in need of commitment. All sensor data, regardless of delivery circumstances are stored in a multidimensional time series data store 5625 which is designed for very low overhead and rapid data storage and minimal maintenance needs to sap resources. The embodiment uses a key-value pair data store examples of which are Riak, Redis and Berkeley DB for their low overhead and speed, although the invention is not specifically tied to a single data store type to the exclusion of others known in the art should another data store with better response and feature characteristics emerge. Due to factors easily surmised by those knowledgeable in the art, data store commitment reliability is dependent on data store data size under the conditions intrinsic to time series sensor data analysis. The number of data records must be kept relatively low for the herein disclosed purpose. As an example, one group of developers restrict the size of their multidimensional time series key-value pair data store to approximately 8.64×10⁴ records, equivalent to 24 hours of 1 second interval sensor readings or 60 days of 1 minute interval readings. In this development system the oldest data is deleted from the data store and lost. This loss of data is acceptable under development conditions but in a production environment, the loss of the older data is almost always significant and unacceptable. The invention accounts for this need to retain older data by stipulating that aged data be placed in long term storage. In the embodiment, the archival storage is included 5630. This archival storage might be locally provided by the user, might be cloud based such as that offered by Amazon Web Services or Google or could be any other available very large capacity storage method known to those skilled in the art.

Reliably capturing and storing sensor data as well as providing for longer term, offline, storage of the data, while important, is only an exercise without methods to repetitively retrieve and analyze most likely differing but specific sets of data over time. The invention provides for this requirement with a robust query language that both provides straightforward language to retrieve data sets bounded by multiple parameters, but to then invoke several transformations on that data set prior to output. In the embodiment isolation of desired data sets and transformations applied to that data occurs using pre-defined query commands issued from the administration device 5612 and acted upon within the database by the structured query interpreter 5635. Below is a highly simplified example statement to illustrate the method by which a very small number of options that are available using the structured query interpreter 5635 might be accessed.

SELECT [STREAMING|EVENTS] data_spec FROM [unit] timestamp TO timestamp GROUPBY (sensor_id, identifier) FILTER [filter_identifier] FORMAT [sensor [AS identifier][, sensor [AS identifier]] . . . ] (TEXT|JSON|FUNNEL|KML|GEOJSON|TOPOJSON);

Here “data_spec” might be replaced by a list of individual sensors from a larger array of sensors and each sensor in the list might be given a human readable identifier in the format “sensor AS identifier”. “unit” allows the researcher to assign a periodicity for the sensor data such as second(s), minute (m), hour (h). One or more transformational filters, which include but a not limited to: mean, median, variance, standard deviation, standard linear interpolation, or Kalman filtering and smoothing, may be applied and then data formatted in one or more formats examples of with are text, JSON, KML, GEOJSON and TOPOJSON among others known to the art, depending on the intended use of the data.

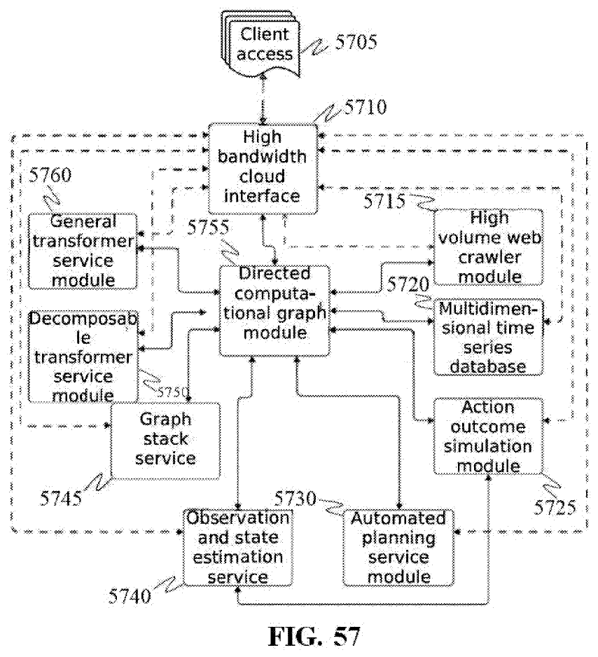

FIG. 57 is a diagram of an exemplary architecture of a business operating system 5700 according to a preferred aspect. Client access to the system 5705 both for system control and for interaction with system output such as automated predictive decision making and planning and alternate pathway simulations, occurs through the system's highly distributed, very high bandwidth cloud interface 5710 which is application driven through the use of the Scala/Lift development environment and web interaction operation mediated by AWS ELASTIC BEANSTALK™, both used for standards compliance and ease of development. Much of the business data analyzed by the system both from sources within the confines of the client business, and from cloud based sources, also enter the system through the cloud interface 5710, data being passed to the analysis and transformation components of the system, the directed computational graph module 5755, high volume web crawling module 5715 and multidimensional time series database 5720. The directed computational graph retrieves one or more streams of data from a plurality of sources, which includes, but is in no way not limited to, a number of physical sensors, web based questionnaires and surveys, monitoring of electronic infrastructure, crowd sourcing campaigns, and human input device information. Within the directed computational graph, data may be split into two identical streams, wherein one sub-stream may be sent for batch processing and storage while the other sub-stream may be reformatted for transformation pipeline analysis. The data is then transferred to general transformer service 5760 for linear data transformation as part of analysis or decomposable transformer service 5750 for branching or iterative transformations that are part of analysis. The directed computational graph 5755 represents all data as directed graphs where the transformations are nodes and the result messages between transformations edges of the graph. These graphs which contain considerable intermediate transformation data are stored and further analyzed within graph stack module 5745. High volume web crawling module 5715 uses multiple server hosted preprogrammed web spiders to find and retrieve data of interest from web based sources that are not well tagged by conventional web crawling technology. Multiple dimension time series database module 5720 receives data from a large plurality of sensors that may be of several different types. The module is designed to accommodate irregular and high volume surges by dynamically allotting network bandwidth and server processing channels to process the incoming data. Data retrieved by the multidimensional time series database 5720 and the high volume web crawling module 5715 may be further analyzed and transformed into task optimized results by the directed computational graph 5755 and associated general transformer service 5750 and decomposable transformer service 5760 modules.

Results of the transformative analysis process may then be combined with further client directives, additional business rules and practices relevant to the analysis and situational information external to the already available data in the automated planning service module 5730 which also runs powerful predictive statistics functions and machine learning algorithms to allow future trends and outcomes to be rapidly forecast based upon the current system derived results and choosing each a plurality of possible business decisions. Using all available data, the automated planning service module 5730 may propose business decisions most likely to result is the most favorable business outcome with a usably high level of certainty. Closely related to the automated planning service module in the use of system derived results in conjunction with possible externally supplied additional information in the assistance of end user business decision making, the business outcome simulation module 5725 coupled with the end user facing observation and state estimation service 5740 allows business decision makers to investigate the probable outcomes of choosing one pending course of action over another based upon analysis of the current available data. For example, the pipelines operations department has reported a very small reduction in crude oil pressure in a section of pipeline in a highly remote section of territory. Many believe the issue is entirely due to a fouled, possibly failing flow sensor, others believe that it is a proximal upstream pump that may have foreign material stuck in it. Correction of both of these possibilities is to increase the output of the effected pump to hopefully clean out it or the fouled sensor. A failing sensor will have to be replaced at the next maintenance cycle. A few, however, feel that the pressure drop is due to a break in the pipeline, probably small at this point, but even so, crude oil is leaking and the remedy for the fouled sensor or pump option could make the leak much worse and waste much time afterwards. The company does have a contractor about 8 hours away, or could rent satellite time to look but both of those are expensive for a probable sensor issue, significantly less than cleaning up an oil spill though and then with significant negative public exposure. These sensor issues have happened before and the business operating system 5700 has data from them, which no one really studied due to the great volume of columnar figures, so the alternative courses 5725, 5740 of action are run. The system, based on all available data predicts that the fouled sensor or pump are unlikely the root cause this time due to other available data and the contractor is dispatched. She finds a small breach in the pipeline. There will be a small cleanup and the pipeline needs to be shut down for repair but multiple tens of millions of dollars have been saved. This is just one example of a great many of the possible use of the business operating system, those knowledgeable in the art will easily formulate more.

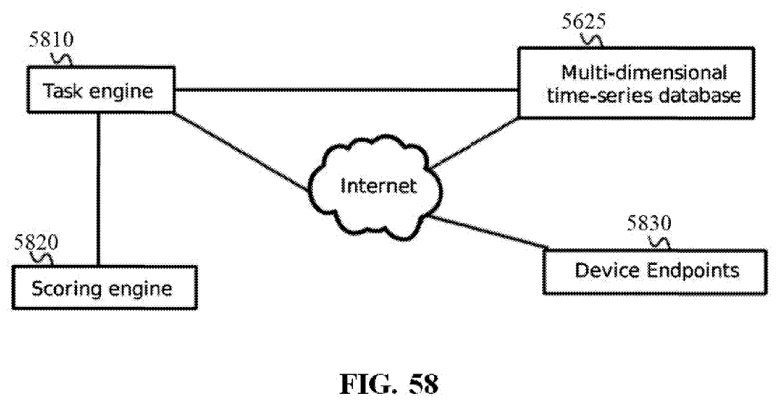

FIG. 58 is a system diagram, illustrating the connections between crucial components, according to an aspect of the invention. Core components include a scheduling task engine 5810 which will run any processes and continue with any steps desired by the client, as described in further methods and diagrams in the disclosure. Tasks may be scheduled to run at specific times, or run for certain given amounts of time, which is commonplace for task scheduling software and systems in the art. This task engine 5810 is then connected to the internet, and possibly to a single or plurality of local Multi-Dimensional Time-Series Databases (MDTSDB) 5625. It is also possible to be connected to remotely hosted and controlled MDTSDB's 5625 through the Internet, the physical location or proximity of the MDTSDB for this disclosure not being a limiting factor. In such cases as the MDTSDB 5625 is not hosted locally, it must also maintain a connection to the Internet or another form of network for communication with the task engine 5810. Device endpoints 5830, especially Internet-of-Things (IOT) devices, are also by definition connected to the internet, and in methods described in later figures will be used for cybersecurity analysis and risk assessment. The task engine 5810 which will perform the scheduling and running of the methods described herein also maintains a connection to the scoring engine 5820, which will be used to evaluate data gathered from the analysis and reconnaissance tasks run by the task scheduling engine 5810.

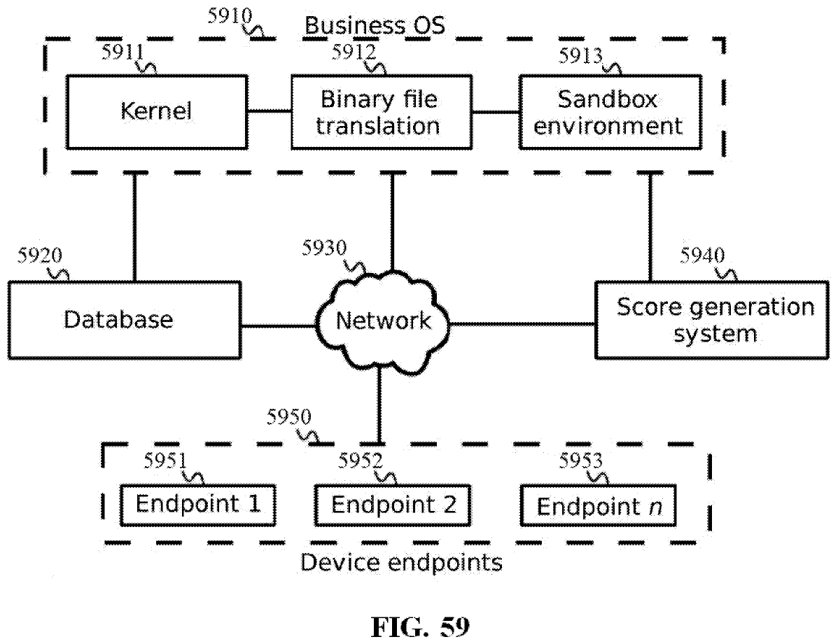

FIG. 59 is a system diagram illustrating connections between important components for analyzing software and network-connected endpoints. A business operating system (OS) 5910 operates on a system outlined in FIG. 57, with key components including the OS kernel 5911 which is a component common to all operating systems, and on that kernel, aside from other pieces of software for other purposes, are two important engines, a binary file translator 5912 and a sandbox simulation environment 5913. A binary file translator 5912 may convert any given file or set of input data into executable machine code, and a sandbox environment 5913 is a simulation environment which may execute machine code in a closed-off environment, similar in purpose to an experiment carried out in a sealed room. This may be done in a variety of ways, including emulator software for specific system architectures and open source code executors. Such an OS 5910 would be connected to a database 5920, which may be formatted in Structured Query Language (SQL) form, formatted raw text, encrypted text, or no-SQL forms, and may be used in conjunction with management software such as APACHE HADOOP™ for increased performance. This connection may be either a direct physical connection, or the OS 5910 and database 5920 may be located on the same physical machine, or they may be connected over a network 5930, including the Internet or other kinds of computer networks. Similarly, a score generation system 5940 may be connected to the operating system 5910, either through a network 5930, or through a direct physical connection, or by operating on the same machine as the operating system 5910 itself. This scoring engine is used in later figures to prioritize software vulnerabilities and exploits. A variety of device endpoints 5950 may be connected over a network 5930 and accessible to the operating system 5910, by use of endpoint instrumentation such as OSQUERY™, and these device endpoints may be varied in form, including laptop computers, desktops, mobile phones, and various Internet of Things (IOT) devices. It is possible for only one endpoint 5951 to be connected, and it is similarly possible for a multitude of various different endpoints to be connected 5952, 5953.

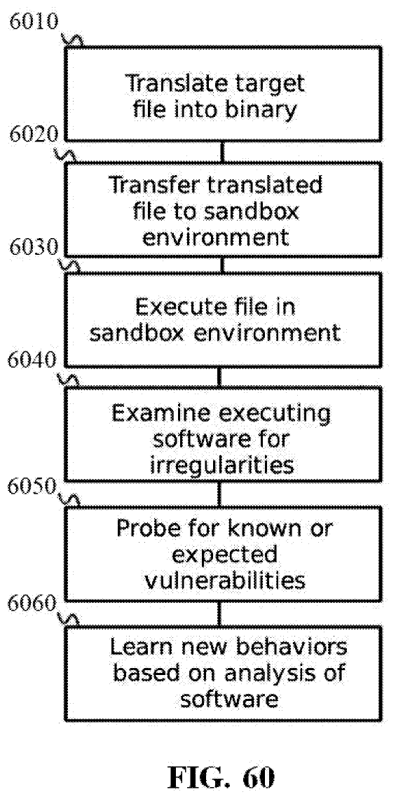

FIG. 60 is a method diagram illustrating important steps in detecting and analyzing software exploits or vulnerabilities of the invention. A file that is targeted for analysis may be translated into executable binary code 6010 by use of a binary translation engine 5912, and this executable binary code may then be transferred to a sandbox environment 6020, 5913, for analysis. The specific environment in use may vary depending on the code generated by the binary translation engine 5912, including hardware emulators, operating system emulators, and more. The executable binary code is then executed in the simulated environment 6030, and the operating system then may examine the executing software for any irregularities 6040. Irregularities include activities not normally performed by benign software including memory scanning, and deletion of the executable binary during execution (but the executing code remaining in memory), which are known patterns of malware to avoid detection and elimination. Attempted access of system files, permissions, settings, or network adapters in suspicious ways may also be classified as “irregularities,” though the characterization and scope of what the operating system 5910 looks for may grow and change over time as cybersecurity and malware both advance. The operating system may also probe the executing software for vulnerabilities and exploits 6050, which will often be known forms of attack, such as the Heartbleed exploit in OPENSSL™, and are known to many skilled in the art of cybersecurity. The types of vulnerabilities and exploits probed for may change and grow as cybersecurity advances as a field. The operating system 5910 may then learn new behaviors 6060 according to the results of analysis, for example the operating system 5910 may probe for the Heartbleed exploit 6050 in a piece of software to see if it is prone to that exploit, and if it is, the operating system may be trained look for similar execution patterns in future software analyses to determine if a piece of software is likely to be vulnerable to the same exploit, an example of reinforcement learning 6060. This may be achieved in numerous ways common in the art including neural networks, a basic decision weight system, and more, all common concepts in computer science and software development as a whole.

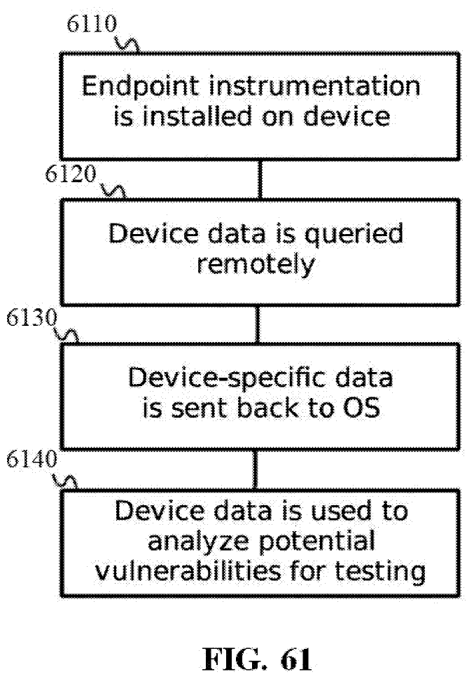

FIG. 61 is a method diagram illustrating the use of advanced endpoint instrumentation to collect data on endpoint devices across a network. First, the network endpoint must have the instrumentation installed before it can be utilized 6110, and some common instrumentations include OSQUERY™ and open source fleet management software including “doorman,” an open source fleet management suite for OSQUERY™. Software such as OSQUERY™ allows devices to be queried and scanned similar to data files or databases, so that property and/or relational data about the device may be scanned easily and swiftly by an authorized user, in this case the business operating system 5910. Once a form of instrumentation software is installed onto the endpoints used in the system 6110, device data may be remotely queried by the business operating system 6120, similar to a database query over the internet. Device data is then sent back to the machine hosting the business operating system 6130, which is then analyzed for potential vulnerability profiling 6140. For example, certain phones that may be used in this system have various exploits and vulnerabilities that are exclusive to each other, as do many older operating systems for personal computers, and this information would be able to be queried for analysis 6140.

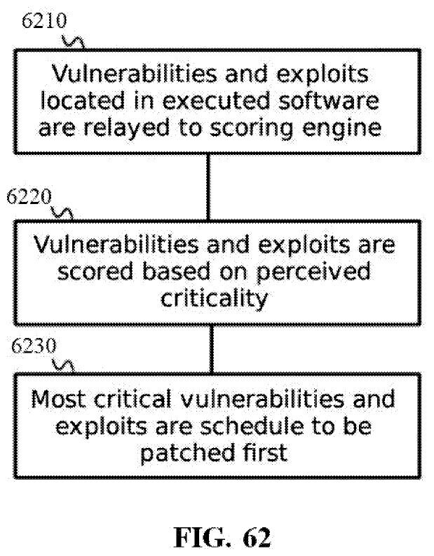

FIG. 62 is a method diagram illustrating the prioritization of software flaws and exploits according to a preferred aspect. Vulnerabilities and exploits found in software executed in the sandbox environment 5913 are relayed to the scoring engine 5940, 6210, which may be either a connection over a network 5930 or a direct physical connection between only the two machines, or both the scoring engine 5940 and operating system 5910 may be operating on the same computing device. The vulnerabilities and exploits found in the software execution may then be scored by the scoring engine 6220, which will assign a higher risk level to exploits which may involve deleting system critical files, highly evasive code techniques which may evade most forms of antivirus software, and more, using a scoring methodology which may be specified and changed at any time by the user of the software. The scoring methodology may be arbitrary or follow any given set of rules specified by the user of the software, the importance of this being that as cybersecurity and malware advance, the need for a changing and advancing ranking of threats is obvious and immediate-what was considered a horrible computer virus 15 years ago may be easily detectable today, and similarly, what is considered incredibly high-risk today may be of no consequence to antivirus software 15 years from now, and therefore be categorized as a low threat to most devices. Regardless, at the time of execution, the scoring engine 5940 will then inform the operating system 5910 of a ranking of the found vulnerabilities or threats in the executed software 6230, ranking the issues found from most dangerous or pressing, to least dangerous or pressing.

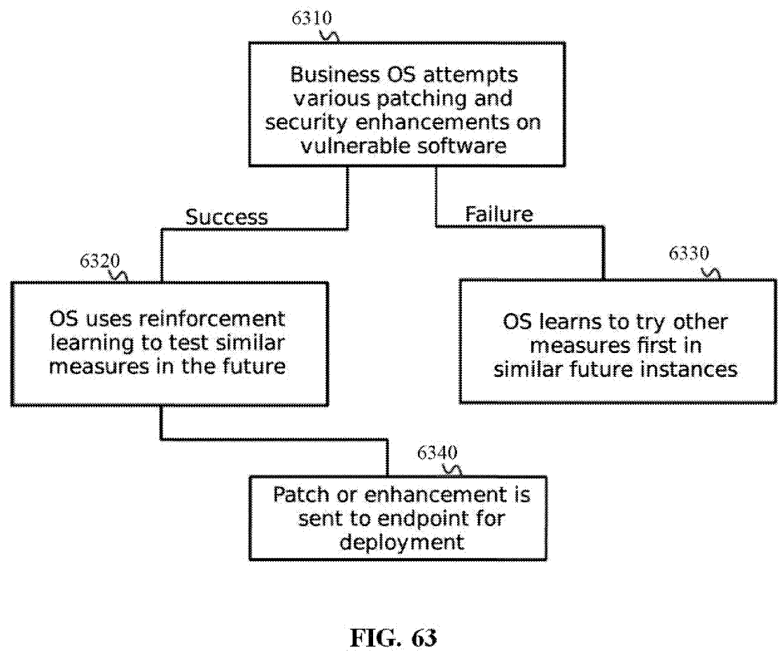

FIG. 63 is a method diagram illustrating the basic steps for patching exploits and vulnerabilities in analyzed software, according to an aspect. After receiving a list of exploitable or dangerous behaviors from a simulated piece of software 6230, the business operating system 5910 will attempt to make any of various changes or limitations implementable at the kernel level to the software's execution 6310, to “patch” the vulnerability or threat. Such measures may include techniques such as Address Space Layout Randomization (ASLR), a memory protection process which randomizes the location in computer memory where system executable code is loaded, and measures used to patch undesirable behavior or vulnerabilities may include other techniques including data execution prevention (DEP), which prevents certain sectors of memory from being executed, protecting potentially important system processes from attack. There are a large variety of security measures that may be implemented in an effort to patch software behavior, and the importance of noting that it is to patch behavior is that the system is not analyzing the code itself and re-writing code in software to be permanently patched, but rather it is changing system behavior based on observed software behavior to protect against any behavior that is either vulnerable to exploitation, or is itself malware. If an implemented patch does not solve the undesired behavior or vulnerability in the tested software, and is deemed a failure, then the operating system 5910 may learn through reinforcement learning algorithms to try different measures first, if the same behavior occurs during analysis of a different piece of software 6330. If the implemented patch or hotfix does stop the undesirable behavior, and is deemed a success, the operating system 5910 learns, conversely to the previous situation, that this patch is an effective measure against such behaviors, and will try it sooner than other (either untested or possibly ineffective) measures that it may have tried 6320. This patch or enhancement to the software's functionality is then sent to the endpoint 5950, 6340 which hosted this file or piece of software that was being analyzed, so that the undesired behavior or vulnerability is effectively mitigated.

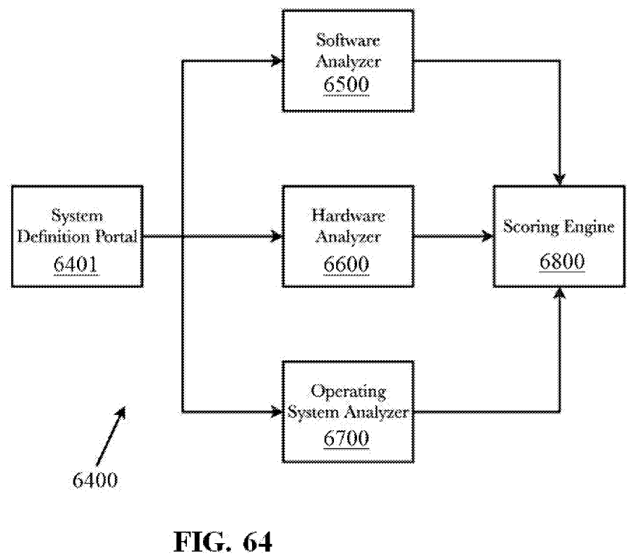

FIG. 64 is a block diagram showing an exemplary overall system architecture for a holistic computer system cybersecurity evaluation and scoring system 6400. In this embodiment, the system comprises a system definition portal 6401, a software analyzer 6500, a hardware analyzer 6600, an operating system analyzer 6700, and a scoring engine 6800. The system definition portal 6401 provides the means for a user to define the system to be tested (also known as the “system under test”) in terms of its hardware, software, and operating system components. The software analyzer 6500 receives the definition of the software component of the system under test and analyzes it for cybersecurity issues. The hardware analyzer 6600 receives the definition of the hardware component of the system under test and analyzes it for cybersecurity issues. The operating system analyzer 6700 receives the definition of the software component of the system under test and analyzes it for cybersecurity issues. The scoring engine 6500 receives the analyses from the software analyzer 6500, hardware analyzer 6600, and operating system analyzer 6700, performs additional checking and testing of the system under test as a whole, and assigns a cybersecurity rating or score to the system under test as a whole computing environment. Note that an operating system is a type of software, so references to software may include operating systems where the context allows.

With respect to the system definition portal 6401, in this embodiment the system definition portal 6401 is a stand-alone portal allowing for definition of the entire system under test, but in other embodiments, it may be simply be an input component of the software analyzer 6500, hardware analyzer 6600, and operating system (OS) analyzer 6700. Each of the software, hardware, and operating components of the system under test can be defined in several ways. One primary method of definition is specification of the component's parameters. For the hardware component, for example, the hardware may be defined by specifying the particular components that make up the hardware (e.g., the central processing unit (CPU), memory, storage, system bus, etc.), including details such as the manufacturer, date of manufacture, model number, serial number, etc., from which the performance characteristics of each part can be obtained. Alternatively, the hardware may be defined directly in terms of performance characteristics, for example specifying the bit width (or word length) of the architecture (e.g., 32-bit, 64-bit, etc.), the processor clock speed, the bus speed, and other characteristics that determine the hardware's performance. For hardware, in particular, definitions by specification may be useful as the actual hardware may not be available or may be difficult to obtain, yet can often be emulated using an emulator or virtual machine. Similar definitions by specification can be made of software and operating systems, for example specifying the software name, version, etc., from which operating characteristics may be identified, or by directly specifying the operating characteristics. While it is possible to emulate or simulate the operation of software, this is typically not done as the software is usually readily available. A second method of definition is provision of the actual software, hardware, and/or OS to be tested. For example, software and operating systems can be uploaded, the actual hardware to be tested may be provided, and in some cases the entire system may be provided for testing with the software and operating system already installed on the hardware. Where physical hardware is used to define the hardware under test, the actual physical computing device may be used as the hardware under test. In some cases, the physical hardware may be physically transported (e.g., delivery, drobox, etc.), while in other cases the physical hardware may be accessed and operated locally (i.e., onsite), while in yet other cases the physical hardware may be accessed and operated remotely (e.g., via a terminal associated with the physical hardware, remote device control using a different computer, screensharing, etc.).

A further aspect of the system definition portal 6401 is that information about the usage of the computer system under test may be specified for scoring purposes. For example, the domain in which the computer system will be used, the use to which the computer system will be put, the criticality of the computer system to overall operations of a business or larger network of computers, and the magnitude of losses that would occur if the system was compromised may all be entered to more precisely define the parameters of the evaluation and scoring. This list is not intended to be exhaustive, and other such information and parameters may be used.

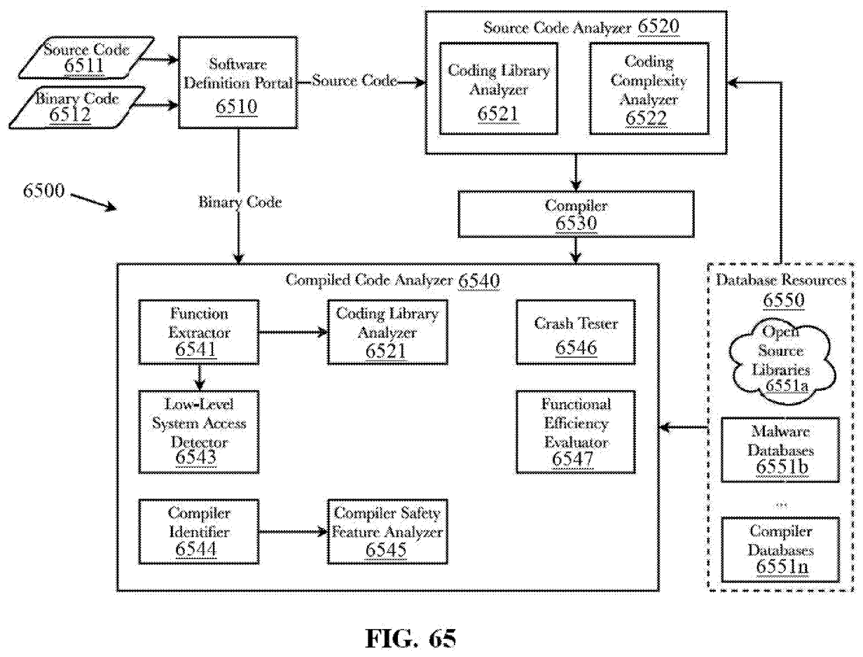

FIG. 65 is a block diagram showing an exemplary architecture for a software analyzer 6500 for a holistic computer system cybersecurity evaluation and scoring system. In this embodiment, the software analyzer 6500 comprises a software definition portal 6510, a source code analyzer 6520, a compiler 6530, a compiled code analyzer 6540, and one or more database resources 6550. The software definition portal 6510 receives either uncompiled, human-readable source code 6511, or compiled machine-readable binary code 6512 to define the software component of the system under test. In this example, definition by specification is not used, and it is assumed that the software to be tested is provided. If source code 6511 is provided, the software definition portal 6510 forwards the source code 6511 to the source code analyzer 6520 for coding analysis prior to compiling.

The source code analyzer 6520 comprises a coding library analyzer 6521 and a coding complexity analyzer 6522. The coding library analyzer searches the code for functions, classes, modules, routines, system calls, and other portions of code that rely on or incorporate code contained in code libraries developed by a different entity than the entity that developed the software under test. Code libraries are collections of code that have been developed for use in specific circumstances, such as standardized classes developed for an object-oriented coding language (e.g., C++, JAVA, etc.), tools developed for a particular integrated development environment (e.g., Code: Blocks, Eclipse), common libraries for interacting with the operating system, templates, subroutines, etc., that are designed to help speed up, standardize, or make easier the coding of applications. The code in such libraries is of varying quality, complexity, usability, security, etc. Code in open source libraries is particularly variable, depending on the skill and knowledge of the (usually part-time, volunteer) contributors, and subject to deprecation if maintenance of the code slows or stops. The source code analyzer 6521 uses this information to determine which code libraries are used, what code from the libraries is used, and the security level of that code, and the security level of the source code 6511 as a result of using code from those libraries. The coding library analyzer 6521 may access one or more database resources 6550 such as open source libraries 6551a, malware databases 6551b, lists of deprecated or out of date software, etc.

The coding complexity analyzer 6522 analyzes the level of additional cybersecurity risk due to the complexity of the code. As an illustrative example, the cyclomatic complexity of a particular software package is a strong indicator of the number of errors that are likely to be in the code. The cyclomatic complexity of a piece of software is a quantitative measure of the number of linearly independent paths through a program's source code.

After the source code analyzer 6520 has completed analysis of the source code 6511, the source code 6511 is compiled by a compiler 6530 for operational testing. The compiler 6530 used will depend on the language in which the source code 6511 was written. Many different compilers 6530 may be available for any given coding language.

Binary code 6512, whether received directly by the software definition portal 6510 or compiled by the compiler 6530 from source code 6511, is sent to a compiled code analyzer 6540 which analyzes the software while it is in operation (i.e., running) on hardware under an operating system. While the software is running, a function extractor 6541 monitors which operations are performed by the software, the order of such operations, and which system resources are accessed by the software, which can disclose the functions, subroutines, etc., that are being executed by the compiled code. The characteristics of those functions, subroutines, etc., can be matched to similar functions, subroutines, etc., in coding libraries and such that the function extractor can identify code from code libraries that are contained in, and being used by, the compiled software. This information about the binary code 6512 can be sent to the coding library analyzer 6521 for analysis (typically where such analysis has not already been performed by the source code analyzer 6520). Further, a low-level system access detector 6543 will simultaneously monitor the running software to identify access of, or attempted access of, low-level system resources (e.g., kernel, stack, heap, etc.) that may indicate cybersecurity concerns. A compiler identifier 6544 can be used to identify the compiler used to create the binary code 6512 and certain information about the settings used when during compilation. In many cases, compilers embed information in the compiled code such as the compiler identification, version number, settings, etc., in a comment section composed of ASCII text. The binary can be scanned for such textual information. Alternatively, the binary file can be “decompiled” or “disassembled” in an attempt to match the inputs and outputs of known compilers. The compiler identifier 6544 may access one or more database resources 6550 to make its determination, such as a database of compilers 6551n and their identifications. An important aspect of cybersecurity analysis of software is determining whether or not a compiler's safety features were enabled, which is done by the compiler safety feature analyzer 6545. Modern compilers have the ability to substitute insecure functions called for in the source code with more secure versions that perform the same functions. However, if this feature is not enabled, the functions will not be substituted. Enablement of the safety features can be determined using the same methods as for compiler identification. A crash tester 6546 may be used to determine the robustness of the software to bad inputs or attempts to crash or hang the software by intentionally inputting improper or unexpected information. Further, a functional efficiency evaluator 6547 may be used to evaluate whether the software does what it purports to do, and its level of efficiency in doing so. For example, if the software is a malware detector, the functional efficiency evaluator 6547 may determine whether it functions as such, and evaluate what percentage of malware introduced into the computer system it detects and quarantines.

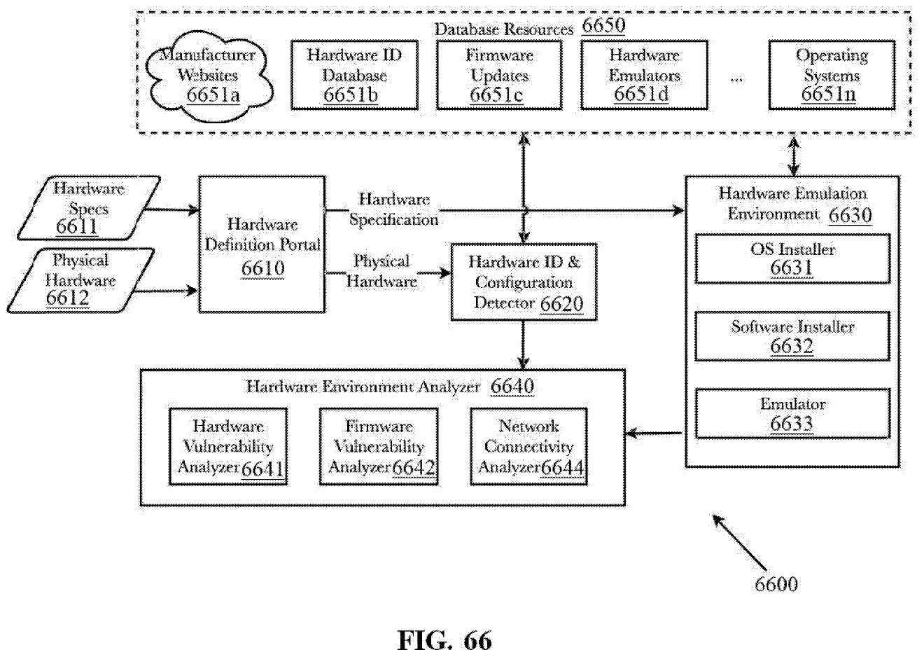

FIG. 66 is a block diagram showing an exemplary architecture for a hardware analyzer 6600 for a holistic computer system cybersecurity evaluation and scoring system. In this embodiment, the hardware analyzer 6600 comprises a hardware definition portal 6610, a hardware identification and configuration detector 6620, a hardware emulation environment 6630, a hardware environment analyzer 6640, and one or more database resources 6650. The hardware definition portal 6610 receives either hardware specifications 6611 to define the hardware under test or physical computer hardware 6612 (e.g., via delivery, a drobox, etc.) as the hardware under test.

Where the hardware is defined by specification 6611, the hardware may be defined by specifying the particular components that make up the hardware (e.g., the central processing unit (CPU), memory, storage, system bus, etc.), including details such as the manufacturer, date of manufacture, model number, serial number, etc., from which the performance characteristics of each part can be obtained. Alternatively, the hardware may be defined directly in terms of performance characteristics, for example specifying the bit width (or word length) of the architecture (e.g., 32-bit, 64-bit, etc.), the processor clock speed, the bus speed, and other characteristics that determine the hardware's performance. The operation of hardware defined by specification can be emulated using an emulator or virtual machine. Where physical hardware is used to define the hardware under test 6612, the actual physical computing device may be used as the hardware under test. In some cases, the physical hardware may be physically transported (e.g., delivery, drobox, etc.), while in other cases the physical hardware may be accessed and operated locally (i.e., onsite), while in yet other cases the physical hardware may be accessed and operated remotely (e.g., via a terminal associated with the physical hardware, remote device control using a different computer, screensharing, etc.).

Where the hardware is defined by specification 6611, the hardware definition portal 6610 sends the hardware specification 6611 to a hardware emulation environment 6630. The hardware emulation environment 6630 is a computing device configured to emulate the operation of the hardware defined by the specification 6611. Emulation is usually performed by running emulation software on a computer that is more powerful than the hardware being emulated, to account for the additional processing overhead of the emulator itself in addition to the processing within the emulated hardware. The hardware emulation environment 6630 comprises an operating system installer 6631, a software installer 6632, and the emulator 6633. In some embodiments, the OS installer 6631 and software installer 6632 will be part of the emulator 6633. The OS installer 6631 installs the operating system under which certain software will run. The software installer 6632 installs software to run on the hardware. When testing the hardware platform separately, this software may or may not be the software under test. For example, in some tests, the software may be a benchmarking application designed to generate artificial loads, or other functional application designed to test the operation of the hardware under test. Once the OS and software are installed, and the emulator 6633 is operating, the emulator acts as the hardware under test, and can be analyzed by the hardware environment analyzer 6640, just as physical hardware would be. The hardware emulation environment 6630 may use one or more database resources 6650 such as databases of downloadable hardware emulators 6551d, operating systems 6551n, etc. In some embodiments, emulation is not required at the hardware analysis stage (but may be used in a later stage when the system is evaluated as a whole), and the hardware specifications 6611 are passed directly to the hardware environment analyzer 6640.

Where physical hardware is used to define the hardware under test 6612, a hardware identification and configuration detector 6620 is run, which automatically identifies the type of hardware, its components, its performance specifications, and its configuration. Modern operating systems conduct a series of port checks and queries of hardware components attached to a computer system each device returns its device identifier (e.g., CPU ID, MAC address, etc.), which is then matched against lists of such identifiers to determine various characteristics of that hardware component (e.g., type of hardware, manufacturer, performance characteristics, size of storage, etc.). The hardware components and their characteristics can generally be obtained by querying the operating system about hardware that makes up the computer system. Where the operating system cannot identify a hardware component, the hardware component can be queried directly, and database resources 6650 external to the operating system may be used to identify the hardware component such as manufacturer websites 6651a, hardware ID databases 6651b, etc. Once the hardware and its configuration have been identified by the hardware ID and configuration detector 6620, operation passes to the hardware environment analyzer 6640.

The hardware environment analyzer 6640 conducts one or more analyses of the hardware. The hardware vulnerability analyzer 6641 can conduct either static evaluations or dynamic testing of the hardware for vulnerabilities. For example, the hardware vulnerability analyzer 6641 may search a number of database resources 6550 such as manufacturer websites 6651a, hardware ID databases 6651b, etc., to identify known vulnerabilities in the physical configuration of the hardware. For example, the most notorious hardware security flaw to date (commonly known as Spectre and Meltdown, which are variants on the flaw) was identified in 2018 and affected nearly every computer chip manufactured in the two decades prior to 2018. The flaw involved exploiting speculative execution and caching to gain access to information that was supposed to be secure. Where database results cannot be used or are inconclusive, the operation of the hardware can be tested by running operations on the hardware associated with known hardware exploits to determine whether the hardware is susceptible to such exploits. The firmware vulnerability analyzer 6642, operating system analyzer 6643, and network connectivity analyzer 6644 operate similarly, first checking database resources 6650 such as firmware updates 6651c, operating systems, updates, and patches 6551n, etc., to determine known vulnerabilities based on hardware components identified in the hardware under test, and performing operational testing of the hardware components in cases where the database results cannot be used or are inconclusive.

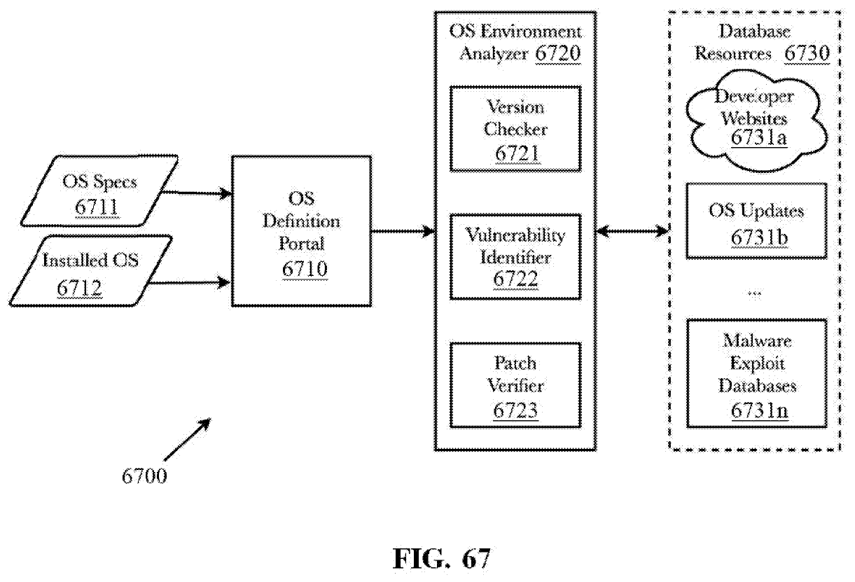

FIG. 67 is a block diagram showing an exemplary architecture for an operating system analyzer 6700 for a holistic computer system cybersecurity evaluation and scoring system. In this embodiment, the operating system (OS) analyzer 6700 comprises an OS definition portal 6710, an OS environment analyzer 6720, and one or more database resources 6730. The OS definition portal 6710 receives either operating system specifications 6711 or uses an installed operating system to define the operating system component of the system under test. In this example, definition by installation 6712 is not used, and it is assumed that the definition of the operating system 6711 will be sufficient to conduct the analysis. However, in some embodiments, testing on an installed operating system may be performed as is the case for hardware analysis above. While operating systems are software, they provide low-level functionality to allow applications to operate on the hardware.

The OS definition portal 6710 forwards the OS specifications 6711 to an operating system environment analyzer 6720, whose functions are similar in nature to those of the hardware environment analyzer 6640. The version checker 6721 may search a number of database resources 6730 such as developer websites 6731a, OS update databases 6731b, malware exploit databases 6731n, etc., to identify known vulnerabilities in the operating system. A patch verifier 6723 can determine whether patches are available and/or installed for any identified vulnerabilities. Where database results cannot be used or are inconclusive, the security of the operating system can be tested by running operations on the hardware associated with known hardware exploits to determine whether the hardware is susceptible to such exploits. One area in which this capability is particularly useful is in industrial control systems, which often have older and customized/proprietary hardware and operating systems installed which cannot be upgraded without major upgrades throughout the facility. In such cases, operating tests can be conducted by the vulnerability identifier 6722 to identify security issues common on such older and/or customized systems such as whether any passwords or authentications at all are required, password length, use of group-based passwords, transmission of plain (unencrypted) text, ease of user access to low-level system operations, application access to low-level system components like the kernel, stack, and heap, and the like.

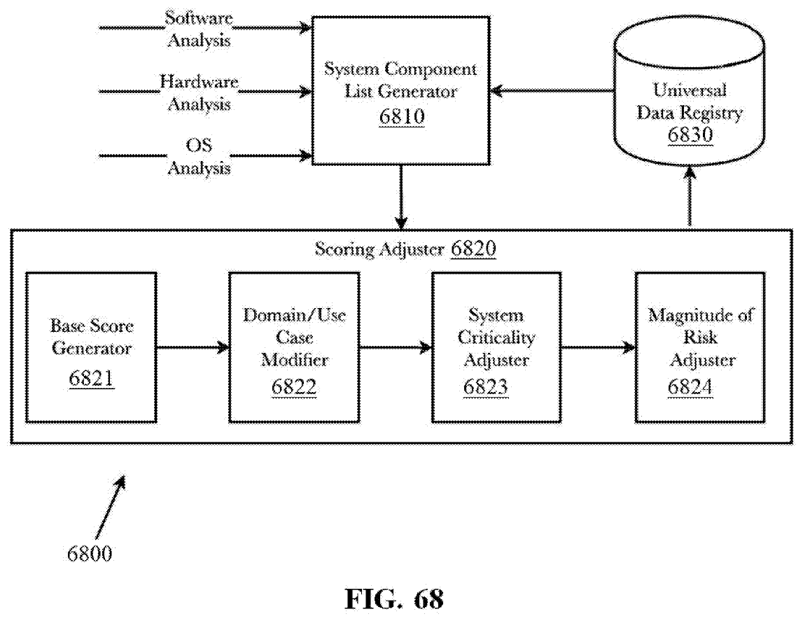

FIG. 68 is a block diagram showing an exemplary architecture for a scoring engine 6800 for a holistic computer system cybersecurity evaluation and scoring system. The separate software, hardware, and operating system analyses are fed into a system component list generator 6810, which compiles a comprehensive list of all system components (in a manner similar, for example, to a bill of materials for manufactured or constructed projects). This comprehensive list can be compared with a universal data registry 6830 to determine whether similar or identical systems have been evaluated and scored in the past, in which case the prior evaluation and scoring may be used to speed up the analysis or avoid some or all of the evaluation process. In some embodiments, the system component list generator 6810 receives a list of all identified software, hardware, and operating system components before the software, hardware, and operating system analyses are conducted, and allowing for scoring to be based on prior analyses of some or all of the components of the system under test without having to repeat those analyses. The system component list generator 6810 sends the comprehensive list of system components, the results of the software, hardware, and OS analyses and any prior evaluations and scoring from the universal data registry 6830 to a scoring adjuster 6820 for scoring.

The scoring adjuster 6820 comprises a base score generator 6821, a domain and use case modifier 6822, a system criticality 6823 adjuster, and a magnitude of risk adjuster 6824. The base score generator 6821 calculates a base cybersecurity score for the system as a whole, based on all information received by the scoring adjuster 6820. The domain and use case modifier 6822 modifies the score to account for the domain and/or use case in which the system will be used. For example, the base score of a given computer system may be adjusted downward if that computer system is to be used in the finance industry, where a greater level of security is required, and adjusted upward if the computer system is to be used in the retail industry where it will be used for the less critical purpose of tracking inventory. The system criticality 6823 adjuster may further adjust the score to account for the criticality of the system in overall operations. For example, even in the finance industry, a given computer system used primarily for document production will be less critical that the same system used to manage account passwords. Finally, the magnitude of risk adjuster 6824 may be used to further adjust the score based on the magnitude of the losses and/or damage that would occur if the computer system is compromised. For example, a small, desktop computer that stores passwords for access to online financial accounts would have a very large impact if compromised, so the score storage of such passwords on that computer cause the score to be reduced. The evaluation and scoring, component lists, and other information may be stored in the universal data registry 6830 for evaluations and comparisons with other systems.

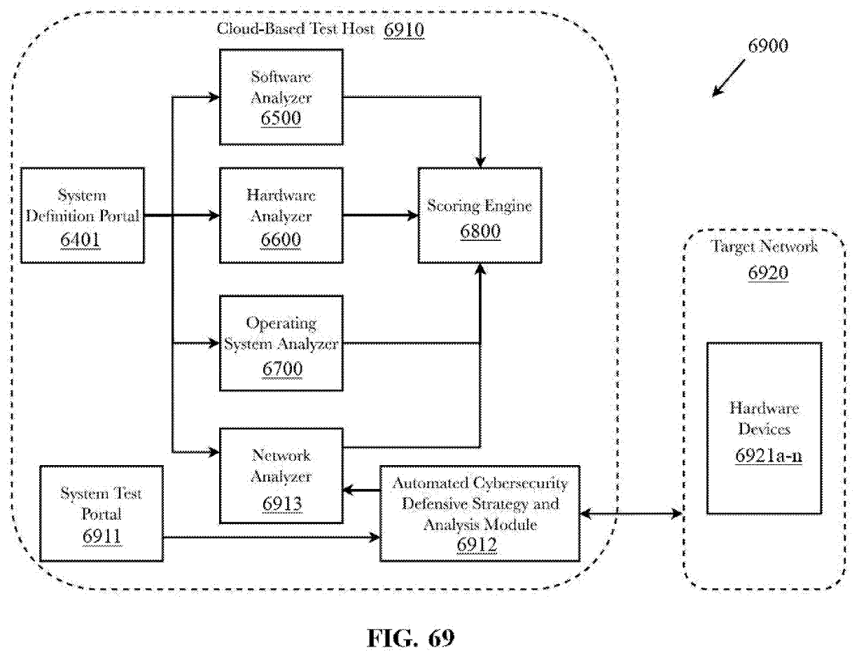

FIG. 69 is a block diagram illustrating an exemplary architecture for an embodiment of a holistic computer system cybersecurity evaluation and scoring system configured to provide hardware exploit testing on external networks utilizing virtualized network testing. In this embodiment, the system 6900 comprises a cloud-based test host 6910 which applies hardware emulation techniques described herein to a target network 6920 while operating outside of the target network. The cloud-based test host 6910 may be a specifically configured and/or augmented embodiment of a holistic computer system cybersecurity evaluation and scoring system which, based on the configuration, provides target network 6920 virtualized testing of an entire target network comprising a plurality of hardware devices 6921a-n and the physical and logical connections between and among the plurality of hardware devices 6921a-n via a hardware emulator. Cloud-based test host 6910 may function as a single computing device on which to emulate an entire target network 6920, or it may function as distributed system wherein two or more computing devices are used to provide target network testing and scoring. In a distributed architecture, the two or more computing devices may be disposed in a single location (e.g., data center) or the two or more computing devices may be operating in two separate locations (e.g., a first data center and a second data center). By utilizing a cloud-based architecture, system 6900 can dynamically adapt and quickly scale to meet the processing needs that may be required to emulate an entire target network 6920.

According to the embodiment, cloud-based test host 6910 may comprise a system definition portal 6401, a software analyzer 6500, a hardware analyzer 6600, an operating system analyzer 6700, and a scoring engine 6800. For more details on these system components, please refer to FIG. 64, FIG. 65, FIG. 66, FIG. 67, and FIG. 68 respectively. The system definition portal 6401 provides the means for a user to define the system to be tested (also known as the “system under test”) in terms of its hardware, software, and operating system components. The software analyzer 6500 receives the definition of the software component of the system under test and analyzes it for cybersecurity issues. The hardware analyzer 6600 receives the definition of the hardware component of the system under test and analyzes it for cybersecurity issues. The operating system analyzer 6700 receives the definition of the software component of the system under test and analyzes it for cybersecurity issues. The network analyzer 6913 receives the definition of the hardware and the definition of the target network 6920 and analyzes it for cybersecurity issues. The scoring engine 6500 receives the analyses from the software analyzer 6500, hardware analyzer 6600, operating system analyzer 6700, and network analyzer 6913 performs additional checking and testing of the system under test as a whole, and assigns a cybersecurity rating or score to the system under test as a whole computing environment. Note that an operating system is a type of software, so references to software may include operating systems where the context allows.

With respect to the system definition portal 6401, in this embodiment the system definition portal 6401 is a stand-alone portal allowing for definition of the entire system under test (i.e., target network 6920), but in other embodiments, it may be simply be an input component of the software analyzer 6500, hardware analyzer 6600, operating system (OS) analyzer 6700, and network analyzer 6913. Each of the software, hardware, and operating components of the system under test can be defined in several ways. One primary method of definition is specification of the component's parameters. For the hardware component, for example, the hardware may be defined by specifying the particular components that make up the hardware (e.g., the central processing unit (CPU), memory, storage, system bus, etc.), including details such as the manufacturer, date of manufacture, model number, serial number, etc., from which the performance characteristics of each part can be obtained. Alternatively, the hardware may be defined directly in terms of performance characteristics, for example specifying the bit width (or word length) of the architecture (e.g., 32-bit, 64-bit, etc.), the processor clock speed, the bus speed, and other characteristics that determine the hardware's performance. The hardware may be defined using memory maps. Memory maps are used to associate hardware components of a physical hardware system (e.g., hardware devices 6921a-n) and memory locations of the virtualized system. In other words, a memory map reproduces the memory locations used by the physical hardware of the target network 6920 to exchange information while also describing the connections between components of the physical hardware system of target network 6920 from a memory interface perspective. For example, a memory map can represent locations of information for memory registers of hardware devices 6921 of the target network 6920 as an offset from the starting memory address. Furthermore, a hardware device may be defined by the interrupt logic which can be information describing the interrupt functionality of the hardware devices 6921a-n.

For hardware, in particular, definitions by specification may be useful as the actual hardware may not be available or may be difficult to obtain, yet can often be emulated using an emulator or virtual machine. Similar definitions by specification can be made of software and operating systems, for example specifying the software name, version, etc., from which operating characteristics may be identified, or by directly specifying the operating characteristics. While it is possible to emulate or simulate the operation of software, this is typically not done as the software is usually readily available. A second method of definition is provision of the actual software, hardware, and/or OS to be tested. For example, software and operating systems can be uploaded, the actual hardware to be tested may be provided, and in some cases the entire system may be provided for testing with the software and operating system already installed on the hardware. Where physical hardware is used to define the hardware under test, the actual physical computing device may be used as the hardware under test. In some cases, the physical hardware may be physically transported (e.g., delivery, drobox, etc.), while in other cases the physical hardware may be accessed and operated locally (i.e., onsite), while in yet other cases the physical hardware may be accessed and operated remotely (e.g., via a terminal associated with the physical hardware, remote device control using a different computer, screensharing, etc.).

Cloud-based test host 6910 further comprises a system test portal 6911 an automated defensive strategy and analysis module 6912. System test portal 6911 provides the means for a user to define the test case to be tested on the target network 6920. Additionally, or alternatively, system test portal 6911 can allow for a user to configure a virtual machine and upload it to cloud-based test host 6910. Cloud-based test host 6910 can create a plurality of virtual machines based on the user configuration, thereby enabling the system 6900 to dynamically scale with the size of the target network. In some implementation, a set of clones of an emulated device, system, or network are created and tools are injected in each clone for testing. Automated cybersecurity defensive strategy analysis and recommendation module 6912 may be utilized to perform various tasks. For example, automated cybersecurity defensive strategy (ACDS) analysis and recommendation module may be leveraged to provide: simulated/emulated representations of a target network under test; a network score based on test results and analysis thereof; and the capture of system characteristics and information about the operation of the network under test during exploit testing. ASDS module 6912 may comprise a reconnaissance engine configured to capture network information about a target network 6920. The network information may comprise system information and characteristics generated by target network 6920 nodes (i.e., hardware devices, resources) associated with the target network 6920. ACDS module 6912 may leverage a cyber-physical graph which is used to represent a completer picture of an organization's infrastructure and operations, including, importantly, the organization's computer network infrastructure. Target network information captured by reconnaissance engine and the device classifications it generates may be used by hardware emulator or a machine learning simulator to create an accurate virtualized model of the target network 6920. ACDS module 6912 may also function as a centralized test generation and deployment mechanism wherein ACDS module 6912 can receive user submitted test cases from system test portal 6911 or use a plurality of tests and tools stored in the module to perform exploit testing on the target network 6920. In some implementations, the exploit testing comprises penetration testing.

Target network information may be used to define a target network and sent to network analyzer 6913 which may also receive hardware definitions from system definition portal 6401 and use this information to establish a network cybersecurity score. The network cybersecurity score may be used an input into scoring engine 6800 to generate an overall cybersecurity score for a target network 6920. In some implementations, network analyzer 6913 or the functionality it provides may be integrated with ACDS module 6912, wherein the ACDS module 6912 performs automated testing and analyzes an entire virtualized target network's response to the test, and outputs a risk score which measures the vulnerability of the target network to an exploit or compromise. The risk score can be used as a network cybersecurity score which can then be fed into scoring engine 6800 as an input to determine an overall cybersecurity score for the target network 6920. For more detailed information regarding ACDS module 6912 please refer to U.S. Patent Application No. 17,567,060, the entirety of which is included herein by reference.

According to the embodiment, the system is configured to provide hardware exploit testing on external networks. In some implementations, the hardware exploit testing on external networks is provided by applying the hardware emulation techniques described herein to networks from testing hosts operating outside the target network. Testing the hardware components of a network (e.g., modems, Ethernet hubs, network switches, routers, etc.) and the connections between and among the hardware components can provide a few benefits. For example, using an external testing host 6910 provides ease of management and ease of deployment because it does not require a network connected resource (e.g., a computing device, hardware component, etc.) to be identified to be used as a host for the emulated environment and as a result there is no need to create tests on the machine where the emulation will occur. System 6900 leverages the fact that while emulation of hardware components is host-specific; test case needs are not. As a result, system can provide for centralized test generation and deployment to one or more target networks and/or one or more hosts in a target network.

Centralized test generation and deployment can be used to scale up the testing capabilities of the system as well as to provide test cases to various and/or multiple targets. In some implementations, system can implement modular test case components such that a user can create a test case. Examples of modular test case components may include, but are not limited to, known exploits the user wishes to test for and against, known hardware the user wants to include or not include in a test case, plug-and-play hardware configurations using known components (configurations may be user inputted, or obtained from database resources 6750 which provide hardware configuration information), and/or preconfigured rules that indicate dependencies and processes that govern interaction between hardware, software, and/or applications (e.g., Operating System, etc.). The test cases may be stored in a database and retrieved when a particular test case has been selected to be used to test the target network. Test cases can be used on various/multiple targets to improve testing speed and throughput. For example, system can allow for testing of multiple hosts in a target network with a single test case, allow for the testing of multiple networks using a single test case, or allow for scheduled testing to see if countermeasures (e.g., output recommendations) are working or if the patches have been deployed properly. In some implementations, a user, such as a customer of a cloud service, can configure an initial test virtual machine on a cloud platform. One or more components of the cloud architecture can then scale to test the service/software/hardware by creating multiple tenant virtual machines with the user configuration, can run tests, and can report results.

According to the embodiment, system 6900 is configured to provide virtualized network testing by emulating a target network 6920 hardware 6921a-n and connections (e.g., both physical and logical) between and among the network hardware. An hardware emulator or machine learning simulator can be leveraged to virtualize entire networks in a testing environment (e.g., cloud-based test host 6910) which provides an isolated, virtualized sandbox, then safely attack them using various attack and exploit vectors. Emulating network hardware allows the same hardware exploit testing as described herein, but with specialized hardware components and embedded system. Network emulations enable broad testing of network attacks and various compromises such as, for example, Kerberos attacks, database attacks, and man-in-the-middle attacks, to name a few. Additionally, using virtual hardware and virtual networking gives a more complete picture with a virtualized sandbox. For example, a user (e.g., individual or enterprise) may wish to know how different attacks work together to compromise a network, which is difficult if not near impossible to tell from testing a single virtual machine. As another example, using only discrete testing of virtual hardware to identify how an attacker would daisy-chain attacks to get what they want is impossible because to properly test for this scenario multiple virtual machines are needed with different hardware all connected as they would be in a live system.

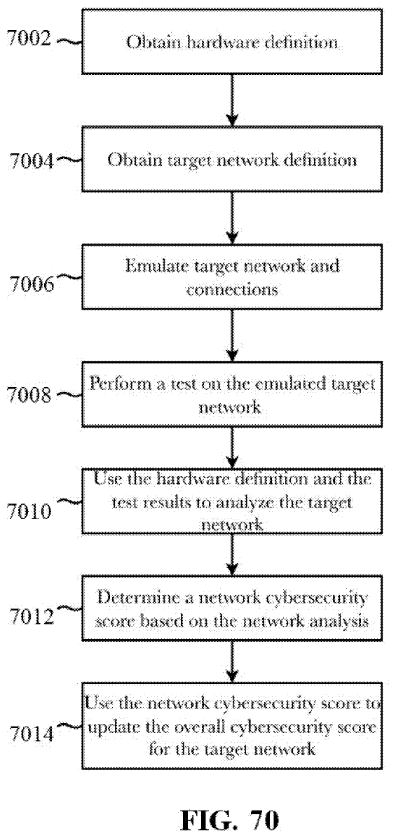

FIG. 70 is a flow diagram illustrating an exemplary method for emulating, testing, and scoring a target network using a cloud-based test host. According to the embodiment, the process begins at step 7002 when a hardware emulator receives, retrieves, or otherwise obtains hardware definition(s) for a plurality of hardware devices 6921a-n of a target network 6920. Hardware definitions may comprise operating components, performance characteristics, and/or memory maps associated with one or more of the plurality of hardware devices 6921a-n. Hardware emulator may also receive, retrieve, or otherwise obtain target network definitions from ACDS module 6912 or one of its components such as a reconnaissance engine at step 7004. Target network definitions may comprise network information and characteristics. Target network definitions may be used to create a cyber-physical graph representation of the target network, wherein the nodes of the graph represent hardware devices 6921a-n and resources, and wherein the edges of the graph represent connection and dependencies between and among the hardware devices of the target network. At step 7006 hardware emulator uses the hardware definitions and network definitions to emulate the target network in secure, isolated virtual test environment (i.e., cloud-based test host 6910). The emulated target network may be represented on a virtual machine or machines operating in a cloud environment of a cloud-based service provider. Once the entire target network, including the plurality of hardware devices 6921a-n and the connections between and among the network devices, have been emulated the next step 7008 is to perform a test on the emulated target network. Tests may be configured to execute an attack associated with a known hardware exploit on the emulated target network. In some implementations, the test performed on the emulated target network may comprise a penetration test. Furthermore, a penetration test may be performed on a live network and the response by the live network to the penetration test may be used as an input to create a network definition, which can then be used to emulate a virtualized version of the live network (i.e., the target network 6920).

Hardware emulator at step 7010 can use the hardware definition and the test results to analyze the target networks response to a hardware exploit test. Based on this analysis, hardware emulator can determine a network cybersecurity score at step 7012, which can be sent to scoring engine 6800 to be used as an input to update the overall cybersecurity score for the target network 6920 at step 7014. According to this embodiment, system 6900 can provide holistic network cybersecurity evaluation and scoring using a test host system operating outside the target network.

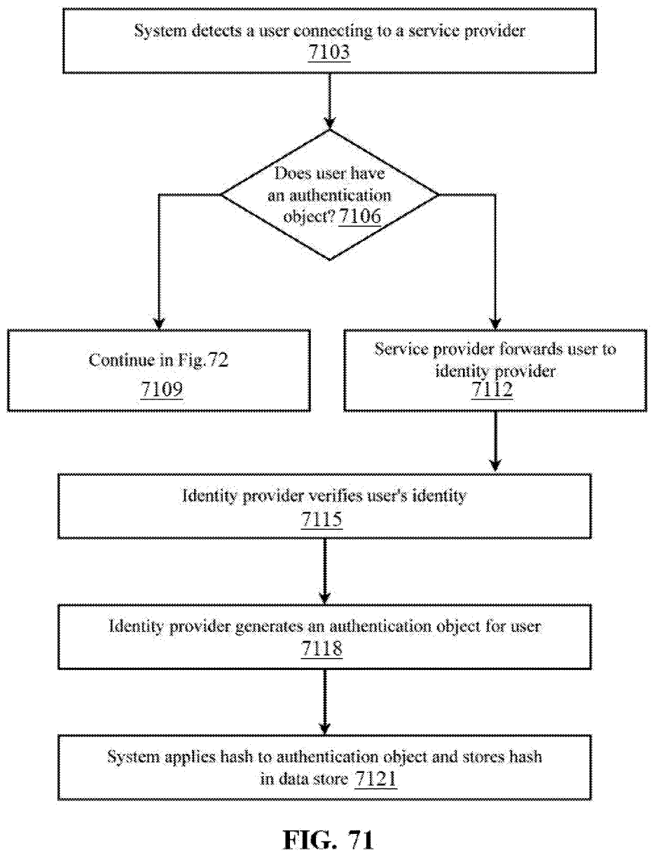

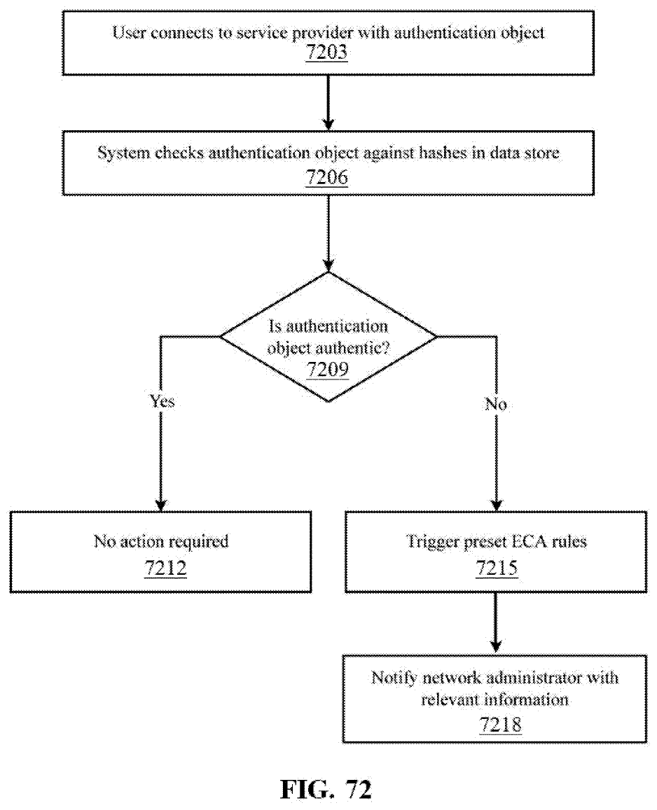

FIG. 71 is a flow diagram illustrating an exemplary method 7100 for processing a new user connection, according to one aspect. At an initial step 7103, system detects a user connecting to a monitored service provider. At step 7106, if the user is connecting with an existing AO, the process leads to the method discussed in FIG. 72 at step 7109.

If the user doesn't have an existing AO, the service provider forwards the user to an identity provider at step 7112. At step 7115, the identity provider prompts the user for identifying information, such as a username and password. At step 7118, after successful verification, the IdP generates a unique AO for the user. At step 7121, system 6410 retrieves the AO and uses a hashing engine to calculate a cryptographic hash for the newly generated AO, and stores the hash in a data store.

FIG. 72 is a flow diagram illustrating an exemplary method 7200 for verifying the authenticity of an authentication object, according to one aspect. At an initial step 7203, a user with an AO connects to a monitored service provider. At step 7206, system detects the connection request, retrieves the AO, and generates a cryptographic hash for the AO. System may now compare the newly generated hashes with previous generated hashes stored in memory. At step 7209, if the AO is found to be authentic, the connect proceeds as normal and method 7200 ends at step 7212 as no further action for this session is required. If the AO is determined to be forged, method 7200 goes to step 7215 where ECA rules may be triggered to perform their preset functions, and perform “circuit breaker” checks within a user-configurable time period. At step 7218, a network administrator at step may be notified, and sent any relevant information, such as blast radius, access logs for the forged AO connection, and the like.

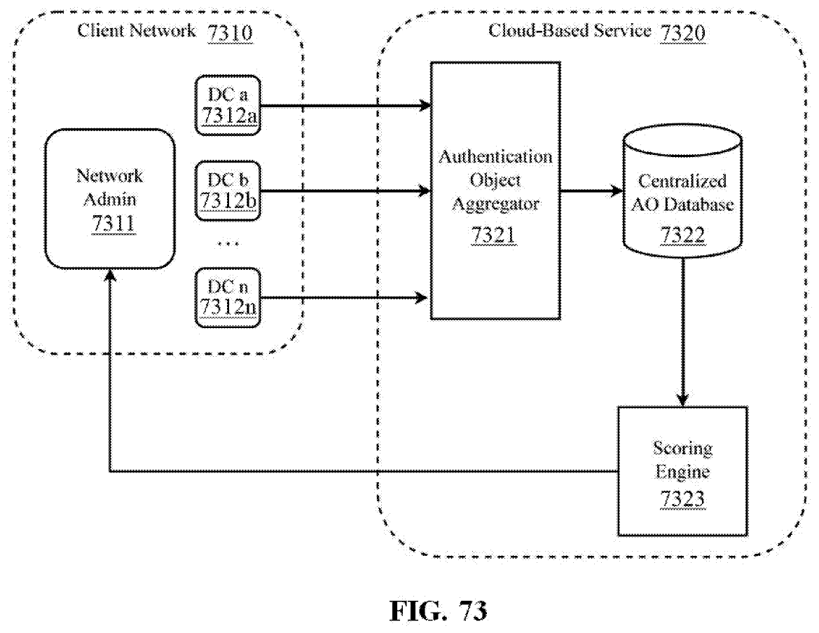

FIG. 73 is a block diagram illustrating an exemplary system architecture for a system for authentication transaction toxicity scoring. In this example, a client network is protected by a cloud-based service 7320 which implements zero trust network security combined with stateful deterministic authentication object tracking and assessment of the level of threat already existing within a network. Client network 7310 comprises one or more domain controllers 7312a-n. A network administrator 7311 is responsible for establishing network access controls (NACs) which typically comprise settings for the Active Directory (AD) service for each domain controller 7312a-n plus implementation of some authentication protocol such as Kerberos, New Technology LAN Manager (NTML), or Security Assertion Markup Language (SAML), OpenID, OAuth operating on each domain controller 7312a-n. Each of these authentication protocols, however, has flaws and vulnerabilities that allow malicious actors to access resources within a network via cyberattacks such as silver ticket attacks and golden ticket attacks, in which the malicious actor is able to forge an authentication object, making it look as though it was issued by the authentication protocol. The malicious actor then uses the forged authentication object to access network resources. For purposes of clarity, Single Sign-On (SSO) is defined as a network security protocol that allows access to network resources within a single domain or organization, while a federated authentication allows access to network resources across domains or organizations. Kerberos and NTML are SSO network security protocols, while SAL, OpenID, and OAuth are federated network security protocols.

An implementation of zero trust network security which uses stateful, deterministic detection of authentication object forgeries provides greater security than heuristic methods, which rely on estimates or guesses as to whether forgeries may exist based on expected network behaviors. To implement a stateful, deterministic method of detecting authentication forgeries, a complete record of every authentication issued by a network must be kept so that the original authentication can be concretely identified for every authentication object presented for every attempted access to a network resource. This makes the detection of authentication forgeries both stateful (in that the current state of every authentication object can be determined) and deterministic (in that the validity of every authentication object presented for every request for access to network resources can be explicitly identified). Stateful, deterministic detection of authentication object forgeries provides greater security than heuristic methods, which rely on estimates or guesses as to whether forgeries may exist based on expected network behaviors.

Thus, cloud-based service 7320 comprises an authentication object aggregator 7321 for gathering of all authentication objects issued by domain controllers 7312a-n operating their authentication protocols, a centralized database 7322 for storing a complete record of every authentication issued by a client network 7310 so that the original authentication can be concretely identified for every authentication object presented for every attempted access to a network resource, and a scoring engine 7323 for scoring the completeness of the authentication observations, assessing the quality of the authentication observations, and assigning organization-specific penalty functions.

While this example shows a fully-cloud-based implementation in which authentication object aggregator 7321, centralized database 7322, and scoring engine 7323 are all located on cloud-based service 7320, other locations for these components are possible, including fully on-premise solutions (such as an a central office location having its own server network), and hybrid solutions wherein certain components are located on-premise and others are cloud-based. For example in another embodiment, authentication object aggregator 7321 may be located on premise so as to avoid network traffic bottlenecks, and centralized database 7322 and scoring engine 7323 may be located on cloud-based service 7320, with authentication object aggregator 7321 transmitting issued authentications to centralized database 7322 at off-peak times for network traffic.

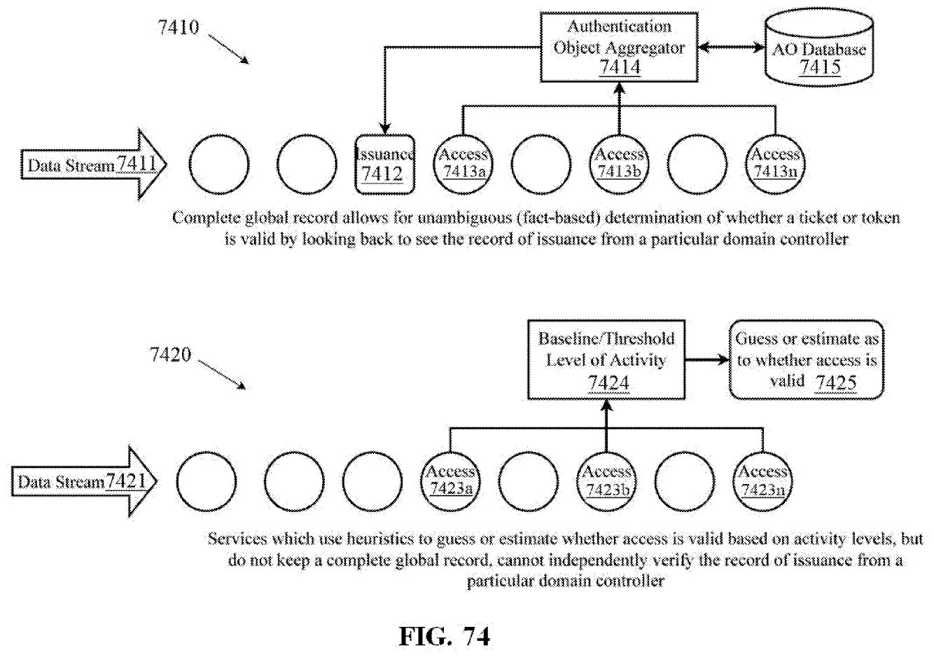

FIG. 74 is a diagram illustrating differences between global authentication record validation versus heuristic assessment validation. To implement a stateful, deterministic method of detecting authentication forgeries, a complete record of every authentication issued by a network must be kept so that the original authentication can be concretely identified for every authentication object presented for every attempted access to a network resource. This makes the detection of authentication forgeries both stateful (in that the current state of every authentication object can be determined) and deterministic (in that the validity of every authentication object presented for every request for access to network resources can be explicitly identified). Stateful, deterministic detection of authentication object forgeries provides greater security than heuristic methods, which rely on estimates or guesses as to whether forgeries may exist based on expected network behaviors.

Here, heuristic detection of authentication object forgeries is contrasted with stateful, deterministic detection of authentication object forgeries. While heuristic detection is useful, it provides a lower level of protection because it relies on assumptions, estimates, and guesses instead of concrete, discretely-determinable facts.

In stateful, deterministic detection of authentication object forgeries as shown at 7410, as streams of data 7411 are received from a network every issuance 7412 of an authentication object from every domain controller of the network is gathered by an authentication object aggregator 7414 and stored in a centralized authentication object database 7415. Each time an authentication object (i.e., ticket or token) is presented for access 7413a-n to a network resource, authentication object aggregator 7414 checks authentication object database 7415 for existence in the database of the issuance claimed by that authentication object (i.e., ticket or token). If that issuance 7412 exists in the database, the authentication object is granted access to the requested resource. If the issuance claimed by the authentication object does not exist in the database, then the authentication object is a forgery, which is statefully and deterministically confirmed by fact that no issuance of that authentication object can be found. Thus, in stateful, deterministic detection of authentication object forgeries, the existence of forgeries are facts which can be concretely and explicitly determines.

In heuristic detection of authentication object forgeries as shown at 7420, no independent record of issuance of authentication objects is kept outside of the authentication protocol operating on each domain controller. Thus, as there is no independent, centralized way to confirm the authenticity of authentication objects, forgeries must be detected through application of heuristics (estimates, assumptions, and guesses). As streams of data 7421 are received from a network, activity levels and behaviors of the network are stored 7424 as baselines, and algorithms are applied (e.g., thresholds exceeded, unusual numbers of access requests made, accounts which have been dormant but are suddenly active, etc.) to guess or estimate as to whether access is valid 7425. For example, each time an authentication object (i.e., ticket or token) is presented for access 7423a-n to a network resource, that access attempt is stored as a data point. If the activity level of that authentication object suddenly increases, warnings may be issued to network administrators indicating that that authentication object may have been forged. As relies on assumptions, estimates, and guesses instead of concrete, discretely-determinable facts, it provides a lower level of protection than stateful, deterministic detection.

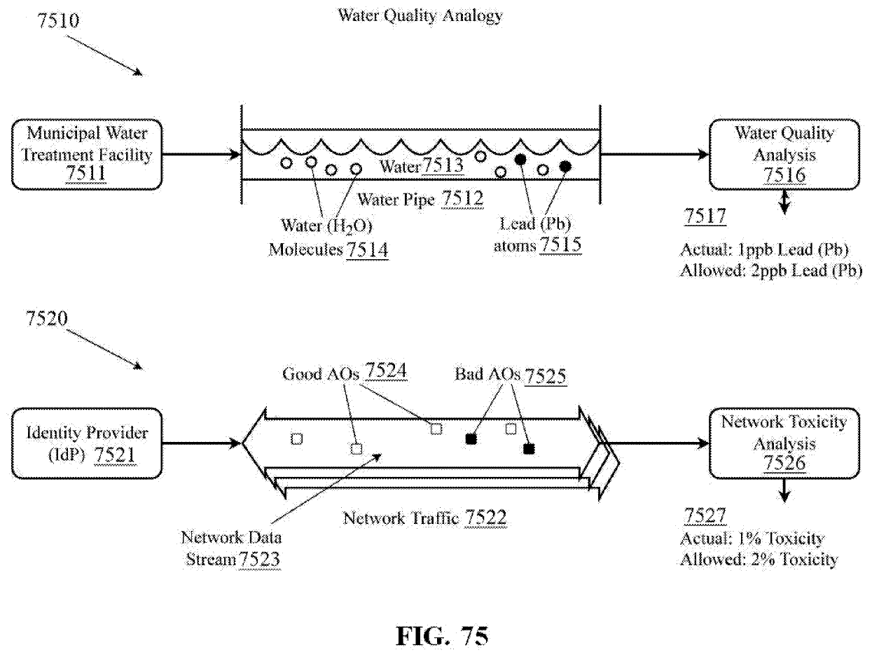

FIG. 75 is a diagram illustrating an analogy between authentication transaction toxicity scoring and water quality. One of the chief limitations of the zero trust network security paradigm is that network security (NS) and information technology (IT) staff need to consider both “good” and “bad” traffic. Detected attacks are tremendously valuable in this regard, but what is missing is the ability to measure the overall health of the authentication flow of a network. NS and IT staff need to know the ratio of good authentication traffic versus bad authentication traffic (which may be further broken down into known bad, potentially bad, and bad-looking but benign). These measures of the overall health of a network can be used to improve security and to assess the value of different security controls across IAM, PAM, PIM, and ITDR functions. As there is no perimeter security in a zero trust network (or if there is, it can't be relied upon completely), the proportions of good versus bad authentication traffic can help NS and IT staff to identify the relationship between authentication issues and broader events. It can help NS and IT staff reprioritize security information and event management (SIEM), incident investigation, or analysis based on links between identified or suspected bad authentication events and other indicators of instability (e.g. other detections or even crashes/crush dumps), authentication instability, or detected manipulation or authentication forgery.

Accordingly, a useful metric in such analysis is network “toxicity,” defined as the proportion of “good” authentications in the network versus “bad” or less secure authentications. In other words, a network's toxicity is what proportion of the network's traffic comprises lower-security protocols, or what proportion of users, devices, and transactions already within a network are threats to the network's security.

Network “toxicity” can be analogized to a water quality report for municipal water systems which identifies the level of toxic substances in drinking water. For example, shown at 7510 is the water quality portion of the analogy. A municipal water system 7511 treats and provides water in accordance with drinking water regulations. Drinking water regulations are legally enforceable primary standards and treatment techniques that apply to municipal water systems. Primary standards and treatment techniques protect public health by limiting the levels of contaminants in drinking water. But having water quality standards does not ensure 100% pure water in a municipal system. In fact, contaminants are allowed to be in drinking water in limited quantities as long as the amount stays under a defined limit that has been determined to be safe for human consumption. For example, in the U.S., the chemical element mercury is highly toxic to humans, but is allowed to exist in drinking water up to 0.002 mg/L or 2 ppb. While it would be ideal not to have any toxic substances at all in municipal water systems, a perfect absence of them is impossible in any real-world water system. Therefore, acceptable limits of such contaminants have been established as a balance between health and practicality. Thus, the water 7513 contained in any given water pipe 7512 or other portion of the water system will have some high proportion of pure water (i.e., water molecules) 7514 and some small proportion of contaminants such as lead (chemical symbol Pb) 7515. A water quality report 7516 is produced on a regular basis showing the levels of contaminants 7517 in this case a lead (Pb) toxicity of 1 part per billion (ppb) actual versus 2 parts per billion (ppb) allowed (meaning that the water meets the standard even though it has some small level of the contaminant). The known levels of contaminants allow the municipal water system to make adjustments to its water treatment systems and procedures.

The levels of contaminants allowed may be different for small-scale systems (e.g., single family wells) versus large-scale systems (e.g., major municipal water systems) as they have different materials, lengths of pipe, storage capacities, and treatment methods. As a perfect absence of toxic substances is impossible or highly impractical, a balance must be struck between ensuring that water is generally safe for use within the reasonable operational constraints and associated degree of economic/life exposed to its underlying operating assumptions. However, that balance cannot be struck unless the level of contaminants (i.e., the level of toxicity) in the water is known.

The situation is similar for zero trust network security. In manner analogous to the public's reliance on the municipal water authority for provision of clean water, NS and IT professionals rely on standard Identity Providers (IdPs) 7521 to ensure that traffic within the network is clean (i.e., that only the users that are authenticated and authorized have access to data). NS and IT professionals trust that traffic is clean because it is authenticated by a trusted source. Single Sign-on (SSO) in computer networks is loosely analogous to opening a faucet on a municipal water system. We trust the water that comes out of the faucet because we trust the water source in the same way that network services trust SSO tickets and tokens presented because they come from a trusted IdP. In both cases, we have previously established trust, but in both cases do not verify quality for every ounce of water or data transaction. When we request data or resources from a Service Provider (SP), whether it's an on premise file share or cloud service, it allows us access because we provide proof from an Identity Provider, a previously trusted source, that we're allowed to do so.

Similarly to having acceptable levels of contaminants in drinking water, there is some percentage of authentications in network traffic 7522 that may also be “contaminated” in one way or another. As with water in municipal water systems, there will be a high proportion of “good” authentications in the network data streams 7523, and a low proportion of “bad” authentication objects 7525 in the network data streams 7523. Current network security protocols have no way of measuring what portion of authentication traffic is “bad” such as authentications using weak protocols like NTLM, use of weak encryption like Rivest Cipher 4 (RC4), or even outright authentication forgeries like Golden Tickets or Golden SAML. This is true of any given IdP but even more striking when considering the common federation of Microsoft's® Active Directory and various IdP and SP infrastructure in modern enterprises. Without knowing the proportion of “good” versus “bad” authentications, it is not possible to determine what level of network “toxicity” is operationally acceptable to ensure that a network (or a process within a network) is generally safe and within the enterprise risk tolerance given the range of potential attack and disruption paths, For forgeries of Kerberos or SAML in modern systems the acceptable level may be approaching zero in much the same way that zero is the only acceptable level of lead in drinking water. However, for NTLM most enterprises have some level or risk tolerance for its use on the network as much as they would like to be rid of it. Regardless of what the imposed limit for network “contaminants” should be, the first step is measuring and monitoring the authentication contaminants in real-time with periodic snapshots/indexing of such data to support appropriate reporting and analysis. A network toxicity analysis 7526 such as that described herein below would produce the necessary information 7527 about network toxicity, for example, that the network has 1% actual toxicity versus 2% allowable toxicity. The levels of allowable toxicity will depend on a number of factors such as the type of computer network, the sensitivity of information on the computer network, the types of computing devices involved, other security measures that may be in place, and other factors.

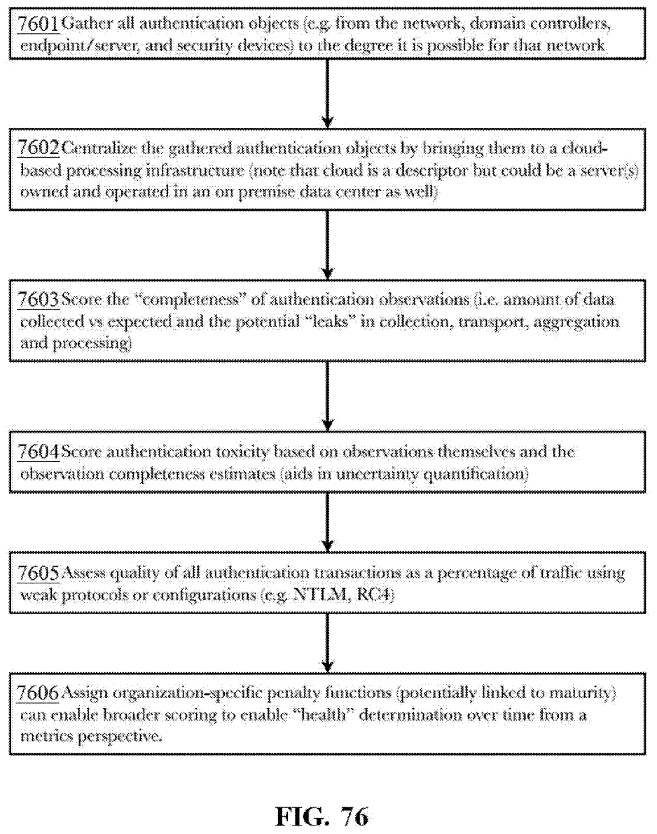

FIG. 76 is a flow diagram illustrating an exemplary method for performing authentication transaction toxicity scoring. At step 7601, all authentication objects are gathered from the computer network (e.g. from the network, endpoint/server, and security devices) to the degree it is possible. The amount and quality of gathered objects may vary by organization or network.

At step 7602, the gathered authentication objects are centralized by bringing them to a cloud-based processing infrastructure. Note that while this embodiment uses a cloud-based processing infrastructure, other configurations are possible, including fully on-premise solutions (such as in a central office location having its own server network), and hybrid solutions wherein certain components are located on-premise and others are cloud-based.

At step 7603, an authentication observation completeness score is assigned to the “completeness” of authentication observations (i.e. amount of data collected vs expected and the potential “leaks” in collection, transport, aggregation and processing).

At step 7604, an authentication toxicity score is assigned based on observations of “good” versus “bad” authentication objects in the centralized database of gathered authentication objects. The authentication toxicity score may also take into account the authentication observation completeness score, which adjusts for uncertainty in the quality of gathered authentication objects. Inclusion of an adjustment for authentication observation completeness is particularly important for certain authentication objects as ticket granting ticket (TGT) issuances which compound the importance of those authentication objects by allowing proliferation of new authentication objects based on them. TGT issuance as a proportion of authentication objects is particularly important, so that quality of data gathered for them is important to assessing authentication toxicity. The levels of allowable toxicity will depend on a number of factors such as the type of computer network, the sensitivity of information on the computer network, the types of computing devices involved, other security measures that may be in place, and other factors. Referring again to the water quality analogy, water ppm requirements for a hospital would be more stringent than those a residential home. The balance between security and functionality is similar to water quality requirements, where 100% purity is likely impossible or unfeasible, but contamination rates are managed down to meet specific quality and observability goals based on intentional sampling.

At step 7605, the quality of all authentication transactions is analyzed as a percentage of traffic using weak protocols or configurations (e.g. NTLM, RC4), or as a percentage of known bad authentication objects, or both. Examples of notifications to network administrators would include examples such as “90% of your authentication transactions were verified as good (non-toxic)” and “1.5% of authentication objects have been detected as fraudulently issued.” In some cases, a certain level of authentication contextual evidence with additional triggers/acceptance of actions may be required (e.g. requiring users with suspected bad AOs to confirm their requests for access to network resources). For example, biometrics, device IDs, operating systems, browsers, and other contextual evidence may be stored in a supplemental audit log (in a manner similar to workflows like Imprivata for hospitals involved in Opiate prescription/dispensing processes). In some cases, alerts may be triggered when levels of bad AOs exceed a given threshold.

At step 7606, organization-specific and/or network-specific penalty functions (potentially linked to maturity) may be assigned as adjustments to the AO toxicity score. These adjustments enable broader scoring to enable “health” determination over time from a metrics perspective.

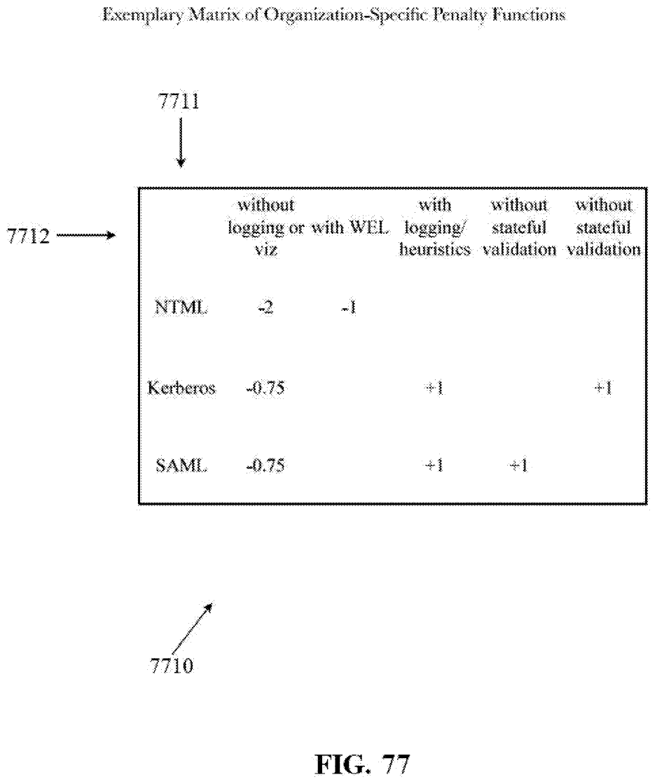

For example, penalties and bonuses may be assigned based on the types of network security protocols detected in the gathering of authentication objects, as described in the exemplary matrix of organization-specific penalty functions shown in FIG. 77.

FIG. 77 shows an exemplary matrix of organization-specific penalty functions. Different network security protocols have different vulnerabilities. Thus, as AOs are gathered, their types can be determined, and bonuses or penalties can be applied to the authentication toxicity score.

For example, an exemplary matrix of organization-specific penalty functions is shown at 7710, wherein the vertical axis 7711 of the matrix represents different types of security protocols for which AOs may have been gathered, and the horizontal axis 7712 of the matrix represents different settings within each security protocol. The intersections of the vertical and horizontal axes represent the penalties assigned for each combination of types and settings. Thus, the following bonuses and penalties are represented in the matrix:
NTLM without logging or visibility→−2 per event; NTLM with web express logons (WELs)→−1 per event
Kerberos without logging or visibility→−0.75 per event; Kerberos with logging/heuristics→+1; Kerberos with stateful validation→+1.5
SAML without logging or visibility→−0.75; SAML with logging/heuristics→+1; SAML w/stateful validation→+1.5

In an embodiment, the bonuses and penalties may be represented as a fraction wherein the numerator is the sum of all transaction counts multiplied by the penalty per transaction, and the denominator is the sum of all transaction counts. This would result in a very poor score for an NTLM heavy network (dangerous) and a very good score in a fully instrumented Kerberos/SAML+stateful validation case. Thus, application of organization-specific or network-specific bonuses and penalties enables exploration of the correlation between authentication toxicity levels within network topologies and network hosts.

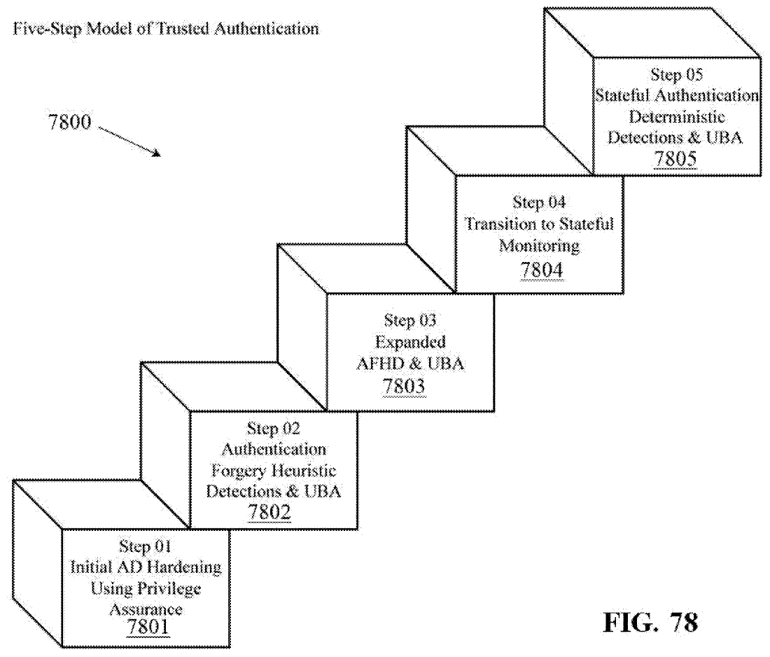

FIG. 78 is a diagram illustrating an exemplary five-step model of trusted authentication for computer networks. Step 01 7801 of the model comprises initial Active Directory (AD) hardening with privilege assurance protections. Here, Active Directory and federated identity environments are mapped using a privilege assurance engine. This ensures that a comprehensive map of users, groups, hosts, domains, etc. is available and identifies the assets and trust relationships that should be considered. Since integrated indicators of exposure and compromise and remediation steps are provided, this can provide cost and time effective improvements to security posture as part of an organization's network security initiatives.

Step 02 7802 of the model comprises enabling authentication forgery heuristic detections and user behavioral analysis (UBA). With a clear map in hand from Step 01 7801, focused teams can now make intelligent decisions about how to approach instrumenting their environment. The map provides an understanding of critical assets and their relationships, but more information is needed to view and understand the nature of ongoing interactions between all system components. The highest value initial component analysis requires identifying and understanding the nature and location of all protocols, encryption types, and trusts used across the holistic identity environment. To gain insight into how authentication works in reality, collection of Windows Event Logs, Kerberos and SAML transaction data is needed to provide the network with identity assurance, which complements the privilege assurance of Step 01 7801 by providing real-time collection and analysis of the identity information.

Step 03 7803 expands coverage of authentication forgery heuristic detections and UBA from Step 02 7802. Once domain controllers have been configured to feed behavioral analytics and protocol information to network administrators to provide visibility into network security, the steps toward trusted authentication can begin. At this Step 03, all domain controllers are instrumented with identity assurance collectors and all web express logons (WELs) are available. This enables comprehensive visibility into Tier0 infrastructure from a security and availability perspective and allows for enhanced detections of NTLM, Kerberos, and SAML based attacks.

Step 04 7804 starts the transition to stateful monitoring of authentication forgery detections. With comprehensive visibility across the entire Kerberos and SAML authentication transaction stream, the identity assurance implementations of previous steps enables network administrators to maintain a real-time view of all valid tickets in Kerberos or tokens in SAML. By keeping track of every valid request for a ticket or token and every valid issuance of a ticket or token, these identity assurance implementations enable a centralized “ledger” of valid credentials. This allows for stateful validation of Kerberos and SAML at the protocol level and aids in identifying and modernizing (and eventually sunsetting) NTLM. This trusted authentication of continuously validated Kerberos and SAML systems in standalone and federated configurations coupled with complementary behavioral analysis, detection analytics, indicators of exposure, indicators of compromise and known attack signatures is a substantial improvement in gaining and sustaining control over network security.

Step 05 7805 involves full stateful authentication forgery deterministic detections and UBA. This provides substantially greater protection than existing network security protocols. As an example, silver ticket (ST) attacks are increasingly common in advanced attacks and ransomware events, and stateful authentication forgery detection allows all six basic elements of a Kerberos handshake to be fully observed and cataloged. This additional information is useful in rapidly detecting attacks in even simple Active Directory (AD) environments but even more so in complicated configurations (e.g. networks using trusts and delegations) where the basic 6-way handshake is more complicated and involved (e.g. across trusts or with delegations).

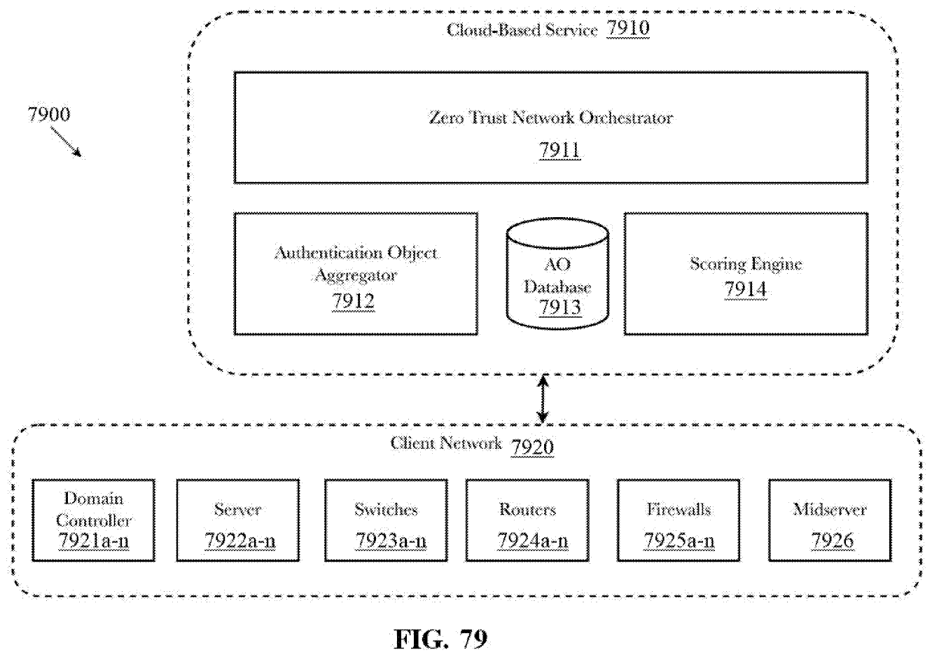

FIG. 79 is a block diagram illustrating an exemplary system architecture 7900 for providing dynamic authentication attack detection and enforcement at the network, application, and host level, according to an embodiment. The system is configured to provide a zero trust network architecture and cybersecurity paradigm by implementing stateful authentication protocol, heuristic, and behavioral analysis utilizing multiple sources of stateful data sourced from a client network 7920 including domain controllers 7921a-n, member servers 7922a-n, endpoints and network devices such as switches 7923a-n, routers 7924a-n, and firewalls 7925a-n. Further, system improves upon existing policy-based zero trust network architectures by continuously collecting, monitoring, and measuring network device state information. Device state feeds into the system security state estimation of the device used for authentication and the state of a given user or service account. This can include, for example, but not limited to, local account information and privileges, historical usage/application connectivity, which users and associated privileges access the device, vulnerabilities and defensive tooling/observation capabilities on the device, and/or the like.

According to the embodiment, the system may comprise a cloud-based service 7910 which can provide an authentication object aggregator 7912 which monitors and collects all authentication objects associated with a client network 7920 and creates an authentication object database 7913 or ledger which can be used to provided deterministic authentication and identity assurance by providing an immutable records of all authentication objects (e.g., Kerberos tickets, SAML tokens, RADIUS attributes, etc.) which are valid within a given network. A zero trust network orchestrator 7911 (ZTNO) is present and configured to process massive streams of data (e.g., network, host, application, and device state data), analyze the stateful information in real-time, and perform dynamic authentication attack detection and enforcement at the network, application, and/or host level. A scoring engine 7914 is present and configured to determine various scores associated with authentication objects such as a dynamic authentication risk score and a dynamic privilege risk score, which can be used to inform ZTNO 7911 processes and actions. The risk scores are dynamic in that they are based on currently available state data and can change as data is gathered and the network monitored.

A zero trust network orchestrator 7911 (ZTNO) is present and configured to process massive streams of data, analyze the stateful information in real-time, and perform dynamic authentication attack detection and enforcement at the network, application, and/or host level. In some implementations, ZTNO 7911 utilizes a distributed processing engine for stateful computations over unbounded and bounded data streams. A stream event may be the plurality of stateful authentication transactions that are occurring at any given moment in a client network 7920 and may be collected from various host-based mechanisms (e.g., custom hardware, firmware, etc.) and/or other methods. For example, ZTNO 7911 support for distributed processing can enable chains of Kafka topics and Flink stages for analysis of authentication transaction data, enable maintenance of in-memory state of authentication tickets and tokens for Kerberos and SAML, respectively, and can enable dynamic publication of the entire, or subset, of valid (or suspicious) or some combination of tickets and tokens to devices on the network.

In some implementations, ZTNO 7911 may provide dynamic triggers of more expensive and invasive analytics based on one or more cursory stream processing or manual actions (e.g., looking for leaks in the “stateful” processing pipelines in situations where the data completeness drops below thresholds of interest. Similarly, looking at detailed audit log changes in active directory from lightweight directory access protocol change detection stream following detections around suspicious user actions. Part of this analysis may include looking at such modification histories to dynamically triggers deeper analytics in an automated manner with results sent directly to an enterprise analyst or administrator.

In some implementations, ZTNO 7911 may leverage a cyber physical graph to generate “routing tables” for subsets of the ticket/token publication scheme which can enable sufficiently efficient approaches to distributing the combined authentication “knowledge” across network operations and defense devices for defensive purposes. Again, this can include authentication specific elements or broader risk-based elements that can include the additional device or user state or posture information that could be optionally influenced by historical behaviors of the device, user or both. This can include the concept of specific interventions alongside one or more of the tickets, users, accounts, etc. Such that a “report only” or “actively disrupt/drop” kind of intervention can be suggested or required. Additionally, applications of this by Group or other “tags” used in the CPG which enable various (even conflicting) policies for active reporting or response to be determined in the cloud and then condensed and sent as targeted instructions to devices.

According to an embodiment, system 7900 is configured to periodically provide asynchronous updates (e.g., instructions) to network 7920 or host devices with an intervention list of credentials which may be of interest, potentially malicious, or known to be malicious. This can enable a variety of potential interventions on the endpoint or network devices including “sinkholing” the associated requests affiliated with such a credential alongside reporting back on the attempted use of the credential. It may also be advantageous to let the credential be used and to track/instrument the resulting behavior of the network or impacted computer to gain information about the threat actor's goals or intent (or to gain evidence for prosecution).

Application-specific integrated circuits (ASICs) are custom designed hardware components built for specific tasks, allowing them to perform these tasks more efficiently than general-purpose CPUs. Such ASICs may be used by network devices to accelerate packet processing and deep inspection of network traffic. Such ASICs can be leveraged to inspect packets and identify authentication objects, such as Kerberos, SAML, RADIUS, or NTLM, by performing various steps.

In some implementations, client network 7920 may comprise a mix of host and network based sensors. For example, sensors could be placed (e.g., span port or Gigamon style devices) or could be integrated into hardware at the network/switch layer. In at least one embodiment of the disclosed system, active measures on the network and/or host devices to potentially take blocking actions or “sinkhole” traffic associated with traffic that is identified as malicious. This can occur at higher level processes or directly at the network interface card (NIC) endpoints. Similarly, for switches and firewalls, this could leverage existing IDS/IPS/firewall hardware or software or could rely on a new auxiliary logic circuit (e.g., a new dedicated ASIC or FPGA device on new hardware) that could be responsible for specifically decrypting Kerberos, NTML, and SAML/Oauth2 related authentication objects and taking action or modifying them.

Network detection and response (NDR) solutions are designed to detect and respond to threats within a client network 7920 by analyzing network traffic and identifying anomalies or signs of malicious activities. However, they may fail to observe all authentication exchanges (e.g., Kerberos, SAML, NL™, and RADIUS) due to the following reasons: highly varied routing, encrypted traffic, and distributed architecture. To overcome these limitations, organizations can employ host-based agents to efficiently capture all authentication data. Host-based agents can be installed on the relevant servers, such as service principal names, key distribution centers, active directory federation services, AD connect, SAML identify provider, and service provider servers, to name a few. This approach ensures comprehensive monitoring of authentication exchanges, as the agents can directly access the data on the host systems.

By combining host-based agents with NDR solutions or capabilities embedded inside networking hardware at the switch, router, firewall and access points, organization can achieve a more comprehensive and efficient monitoring of authentication exchanges, enhancing their overall security posture and ability to detect and respond to potential threats.

According to an embodiment, a scoring engine 7914 is present and configured to determine (e.g., compute, calculate, derive, infer, etc.) one or more risk scores associated with an authentication object, network, application, host, and/or enterprise based on various contexts including, stateful information associated with a network device, user, or service, IP history, user behavior, device history, application usage history, cyber reconnaissance data, and/or the like. Scoring engine 7914 may be configured to determine an authentication risk score associated with an authentication object, a network device, an application, and/or a host. Authentication risk measures deviation from a user's typical behavior during a sign-in request, classifying it as low, medium, or high risk. In some implementations, an authentication toxicity score or scoring model may be used as an input when determining an authentication risk score. In addition, scoring engine 7914 can be configured to determine an application risk score. An application risk score may be generated by determining the sensitivity of an application and its stored data to a potential attack.

Scoring engine 7914 can also be configured to compute a privilege risk score associated with an authentication object, a network device, an application, and/or a host. Privilege refers to the level of access or authority granted to a user, process, or system within network environment. It determines the actions a user or system can perform and the resources they can access. It may generally be expressed through user roles, permissions, or levels of authority. In some implementations, a cyber physical graph (CPG) may be created and referenced as a component when determining a privilege risk score. A CPG represents an organizations entire network and provides a visual and navigable graph representation of a network's devices, applications, users, groups, protocols, etc. as well as additional context about the relationships between and among said network components.

In various implementations, ZTNO 7911 may receive, retrieve, or otherwise obtain one or more of an authentication risk score, a privilege risk score, and a cybersecurity risk score associated with an authentication object, a network device, an application, and/or a host. ZTNO 7911 may compare the received one or more risk scores with a predetermined threshold value and based on the comparison determine whether to intervene in an authentication transaction. The predetermined threshold value may be set by an organization based on its appetite risk. For example, the privilege risk score associated with a device is calculated to be 0.6 and an organization has set a policy which indicates a privilege risk score of 0.5 as the threshold value, wherein if that threshold value is exceeded, then an intervention should occur. In some implementations, the interventions may be based on whether the intervention is occurring at the network, application, or host level. In some implementations, an intervention may be directed to creating and sending a report about the suspicious behavior. In other implementations, an intervention is directed to actively disrupting or dropping authentication transactions such as, for example, credential blocking, sinkholing an authentication event, terminating an application session, blocking or stopping a process on the impacted host or server, and/or the like.

The aggregate “risk score” applied to any authentication event enables comprehensive scoring of the Kerberos, SAML/Oauth2, NTLM, or remote authentication dial-in user service (RADIUS) authentication protocols.

RADIUS is a client-server protocol primarily used for network access control. It enables access servers to authenticate users and authorize their access to the requested system or service. RADIUS is considered a stateless protocol, as it does not maintain a continuous connection between the client and server during the authentication process. Each request and response are treated as independent transactions. Some common attacks against RADIUS include brute-force attacks, dictionary attacks, replay attacks, and man-in-the-middle attacks.

Protocol monitoring using packet capture is a technique for capturing and analyzing network traffic in real-time or from stored data. This method can be employed to detect RADIUS attacks by monitoring and analyzing the traffic between RADIUS clients and servers. By inspecting the packets transmitted between these devices, potential security threats and anomalies can be identified. There are a few ways protocol monitoring using packet capture can detect RADIUS attacks including, but not limited to, unusual traffic patterns, suspicious packet content, unusual source or destination IP addresses, replay attacks, and insecure or outdated protocol usage. Monitoring the packet capture can reveal abnormal traffic patterns, such as a sudden increase in RADIUS requests or a high rate of failed authentication attempts, indicating a potential brute-force or dictionary attack. By analyzing the content of RADIUS packets, system can identify unusual or malicious attributes. For example, a packet with the incorrect or unexpected RADIUS shared secret, a malformed attribute, or an unknown RADIUS message type might indicate an attempt to compromise the RADIUS server. Monitoring the packet capture can reveal traffic originating from or directed to unexpected IP addresses, indicating potential unauthorized access attempts or man-in-the-middle attacks. By analyzing timestamps and sequence numbers of RADIUS packets, the system can detect replay attacks, in which an attacker captures and retransmits a valid RADIUS packet to gain unauthorized access. Packet capture analysis can identify the use of insecure or outdated RADIUS protocols, which may be more susceptible to attacks. By detecting and alerting on these outdated protocols, organizations can take steps to update their systems and improve their security posture.

To effectively detect RADIUS attacks using packet capture, it is important to establish a baseline of normal RADIUS traffic patterns and behaviors. This baseline can be used to identify deviations and anomalies that may indicate an attack. Additionally, using network intrusion detection and prevention systems (IDS/IPS) in conjunction with packet capture analysis can further enhance the detection and mitigation of RADIUS attacks.

According to the embodiment, zero trust network orchestrator (ZTNO) 7911 may provide credential revocation as an intervention method to maintain security and enforce zero trust principles. ZTNO can provide credential revocation at various levels including at the host, KDC, network, and application levels. At the host level, the system 7900 monitors the local authentication events and detects anomalies, forgeries, tampering, or misuse of credentials. By ensuring that only validly issued, recorded, and authorized credentials are used to access resources at the host level, the ZTNO 7911 prevents unauthorized access and maintains the integrity of the system. In case of any detected compromise, ZTNO 7911 can revoke the affected credentials, effectively stopping any potential security breaches.

At the key distribution center (KDC) level the KDC is responsible for managing and distributing cryptographic keys within the Kerberos authentication protocol. Authentication object aggregator 7912 and AO database 7913 build and maintain a real-time ledger of valid Kerberos tickets (e.g., or SAML tokens or other authentication objects.), ensuring that only legitimate tickets are accepted by the KDC. By continuously validating the tickets and monitoring the KDC's interactions, the system can detect and revoke compromised credentials, thus preventing attackers from gaining unauthorized access to resources within the network.

At the network level, the system collects and analyzes authentication transaction data across various protocols, including (but not limited to) NL™, Kerberos, and SAML. This allows system 7900 to identify potential attacks, such as encryption downgrade or pass-the-ticket attempts, and respond accordingly. By revoking the compromised credentials at the network level, the system stops attackers from exploiting the network infrastructure to gain unauthorized access to resources. This process can be supported using network authentication toxicity scoring as a context when analyzing authentication transaction data to identify potential attacks.

Applications that use authentication protocols like SAML and OAuth2 can benefit from the system's stateful validation and heuristic detection techniques. By monitoring the authentication events and tokens at the application level, the system can identify, and revoke forged or stolen tokens, ensuring that only authorized users can access the application. This helps to maintain a secure application environment and enforces the zero trust principles at the application level. Credential revocation techniques at the host, KDC, network, and application levels provide a comprehensive security approach that enforces zero trust principles. By continuously monitoring, validating, and revoking compromised credentials across various layers, system 7900 ensures a strong foundation for a secure and reliable authentication process.

A result of this ability to send Kerberos transaction revocation instruction to a KDC or to drop them at the network level and force a new attempt for a ticket (e.g., a ticket granting ticket) means that the composite approach also reduces the potential for false positives and can enforce stateful validation. The ability to trigger new Kerberos transactions enable the system to enforce reauthentication meaning the system can reduce potential challenges associated with missed or dropped tickets/exchanges at the KDC or service or user endpoint. It can also address potential for data loss between collection and cloud processing as an additional resilience measure to enhance confidence in gaining stateful validation/enforcement of the protocol.

A particular use case for system 7900 is directed to the detection and response of damaging attacks such as NTLM relay. TLM relay can be difficult to detect overall because NTLM is largely insecure with respect to authentication protocols. At its core NTLM relay is a man-in-the-middle attack. The way it works is an attacker wants to gain access to something and doesn't have permissions, but other systems on the network do have access. NTLM relay is a technique of standing between a client and a server to perform actions on the server while impersonating the client. Just as authentication object aggregator can create a ledger of authentication objects, the ZTNO 7911 can be configured to curate a dynamic list of approved domain controller (DC) accounts or hostnames. The dynamic in-memory list of active DC hostnames (with optional archiving as snapshots during change events, like an audit trail) is used for detections and the list may be accessed via a rules pipeline. The DC controller list is dynamically maintained and used to detect NL™ relay attacks on domain controllers in a client network.

According to some implementations, a midserver 7926 may be present and configured for collecting, aggregating, analyzing, filtering, transforming, and securely transmitting data, data transfers, and interactions with a cloud-based service bbb, typically co-located with the enterprise domain controller (or Active Directory (AD) server) 7921a-n for exploration of network-enabled directories and to control access to and authenticate security requests on the network for other connected servers 7922a-n. In cases where network devices are capable of feeding data to midserver 7926 or directly to a cloud service edge, the additional telemetry data provided by midserver can be incorporated into risk score calculations, authentication toxicity computations, and cyber threat analysis. A midserver 7926 in this implementation may be used for streamlined communications with a cloud-based service 7910 including a single point of connectivity with the service, a ticket form of security adding further security to such a connected system, and a batch method of data transfer, allowing numerous other servers 7922a-n or endpoints or log sources to communicate with midserver 7926 which then collates data for transfer to a cloud-based service 7910 (e.g., ZTNO 7911, authentication object aggregator 7912, etc.), which may further collate data received from the cloud-based service 7910, for ease of analysis and which allows for other forms of network optimization to take place which are not present in systems where numerous endpoints and servers maintain individual connections to a cloud-based service 7910, also allowing for new data sources including servers 7922a-n and endpoints to be added swiftly and integrated into the system for connection to the cloud-based service rapidly and easily due to midserver 7926 acting as an interface between the service 7910 and the other possible client network 7920 components. For more detailed information on midserver and its applications, please refer to U.S. Patent Application No. 18/186.

In some implementations, system 7900 may perform one or more functions to perform uncertainty quantification wherein the system (e.g., data stream management engine 5620) seeks to “approximate” non-observed data via intentional sampling from continuously observed data as well as periodically observed data (e.g., packet capture using a system tool or a third party tool such as Wireshark) for a period of time.

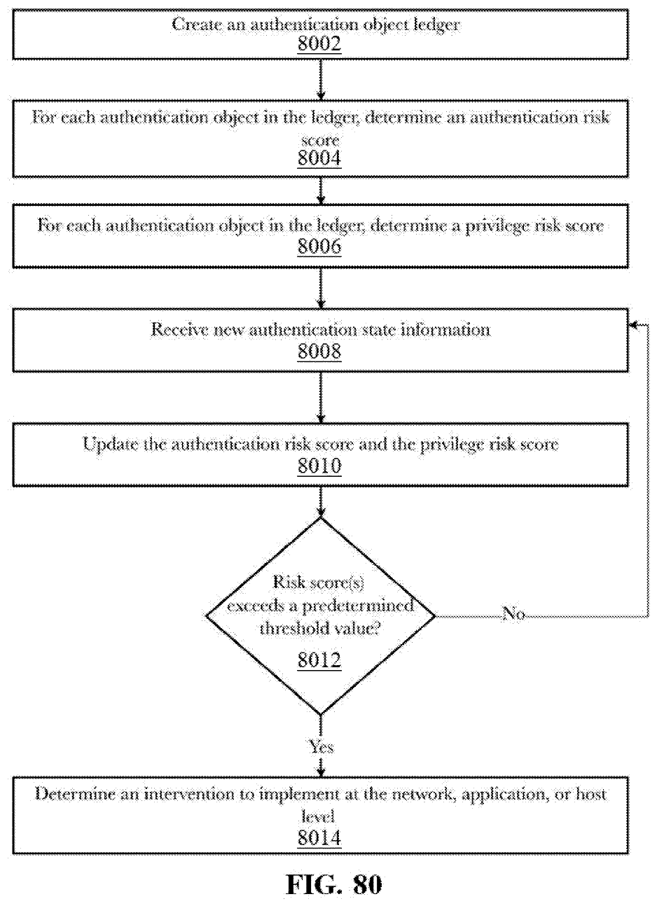

FIG. 80 is a flow diagram illustrating an exemplary method for providing dynamic authentication attack detection and enforcement, according to an embodiment. According to the embodiment, the process may be carried out using one or more of the various system components illustrated in FIG. 79. According to the embodiment, the process begins at step 8002 when an authentication object aggregator 7912 collects a plurality of authentication transaction data and creates an authentication object ledger. The ledger may store a plurality of authentication objects (e.g., tickets, tokens, attributes, etc.). For each authentication object in the ledger, at step 8004, determine an authentication risk score using scoring engine 7914. Likewise, for each authentication object in the ledger, determine a privilege risk score at step 8006. At step 8008 ZTNO 7911 receives new authentication state information from various sources such as, for example, midserver 7926, host-based monitoring agents, and custom hardware (e.g., ASIC) integrated on network devices. This new state information can be used by scoring engine 7914 to dynamically updated one or more of the authentication risk score, the privilege risk score, and the overall network cyber threat risk score at step 8010. Because ZTNO 7911 supports highly scalable distributed processing and in combination with host-based agents, it is capable of continuous monitoring and data aggregation, which in turn lends itself to dynamic risk scoring used to inform network authentication transaction intervention implementations. At step 8012 the updated risk scores are compared against one or more predetermined threshold values, which may be set by an organizational administrator. If the threshold value has not been exceeded, then the process continues to step 8008 as new information is received so are the risk scores updated.

If instead, the risk score does exceed the threshold value, then the process continues to step 8014 wherein ZTNO 7911 determines an intervention to implement at the network, application, or host level based on available information such as, for example, authentication transaction details, attack paths associated with a network device, and organizational policy.

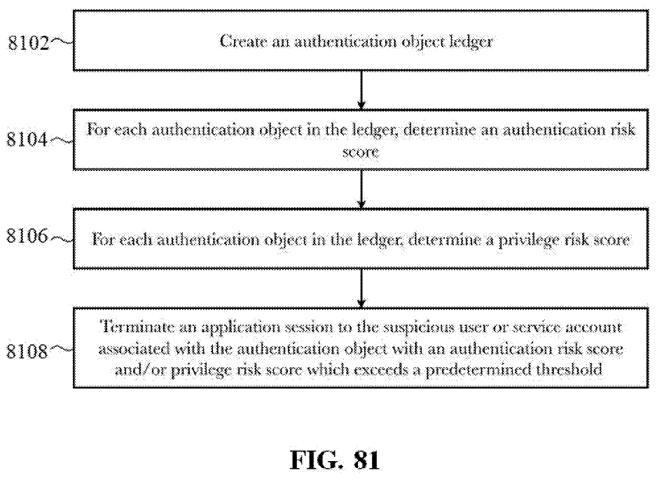

FIG. 81 is a flow diagram illustrating an exemplary method for providing an intervention at the application level, according to an embodiment. According to the embodiment, the process begins at step 8102 when an authentication object aggregator 7912 collects a plurality of authentication transaction data and creates an authentication object ledger. The ledger may store a plurality of authentication objects (e.g., tickets, tokens, attributes, etc.). For each authentication object in the ledger, at step 8104, determine an authentication risk score using scoring engine 7914. Likewise, for each authentication object in the ledger, determine a privilege risk score at step 8106. At step 8108, ZTNO 7911 determines an authentication risk score and/or privilege risk score has exceeded a predetermined threshold value and determines the risk is associated with an application authentication transaction and selects an appropriate intervention. For example, ZTNO 7911 can terminate an application session to the suspicious user or service account associated with the authentication object whose risk score(s) exceeded a threshold value.

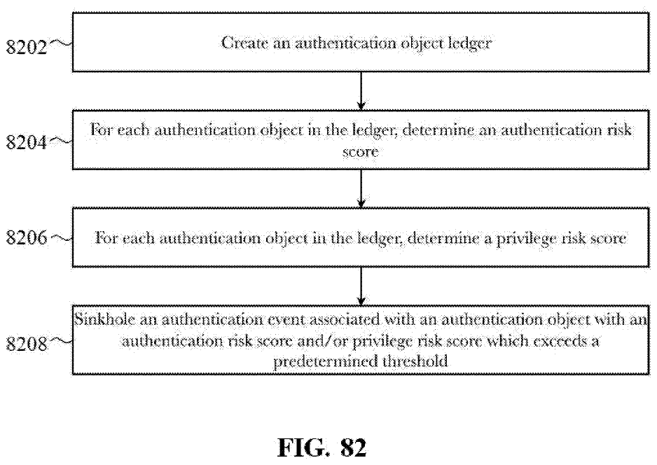

FIG. 82 is a flow diagram illustrating an exemplary method for providing an intervention at the host level, according to an embodiment. According to the embodiment, the process begins at step 8202 when an authentication object aggregator 7912 collects a plurality of authentication transaction data and creates an authentication object ledger. The ledger may store a plurality of authentication objects (e.g., tickets, tokens, attributes, etc.). For each authentication object in the ledger, at step 8204, determine an authentication risk score using scoring engine 7914. Likewise, for each authentication object in the ledger, determine a privilege risk score at step 8206. At step 8208, ZTNO 7911 determines an authentication risk score and/or privilege risk score has exceeded a predetermined threshold value and determines the risk is associated with an host's authentication transaction and selects an appropriate intervention. For example, ZTNO 7911 can sinkhole an authentication event associated with the authentication object whose risk score(s) exceeded a threshold value.

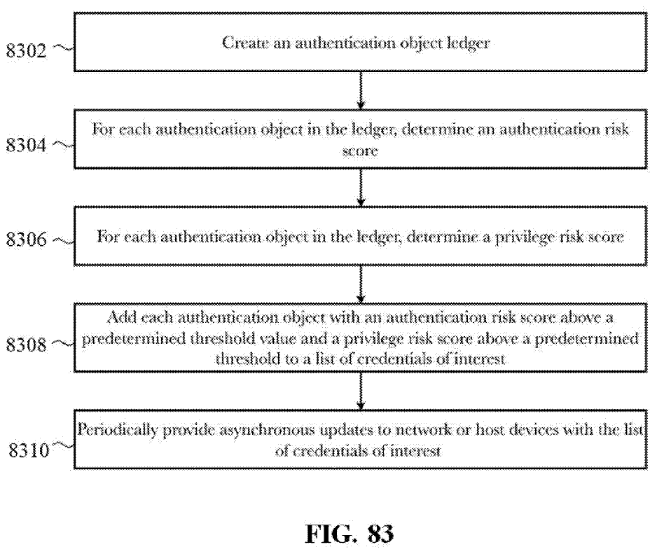

FIG. 83 is a flow diagram illustrating an exemplary method for providing an intervention list to network or host devices, according to an embodiment. According to the embodiment, the process begins at step 8302 when an authentication object aggregator 7912 collects a plurality of authentication transaction data and creates an authentication object ledger. The ledger may store a plurality of authentication objects (e.g., tickets, tokens, attributes, etc.). For each authentication object in the ledger, at step 8304, determine an authentication risk score using scoring engine 7914. Likewise, for each authentication object in the ledger, determine a privilege risk score at step 8306. At step 8308, ZTNO 7911 determines an authentication risk score and/or privilege risk score has exceeded a predetermined threshold value and adds the authentication object to an intervention list of credentials of interest. At step 8310, ZTNO 7911 may periodically provide updates to network or host devices with the list of credentials of interest. This list may be used by custom hardware integrated with network hosts or devices to perform packet capture and comparison schemes, according to an embodiment.

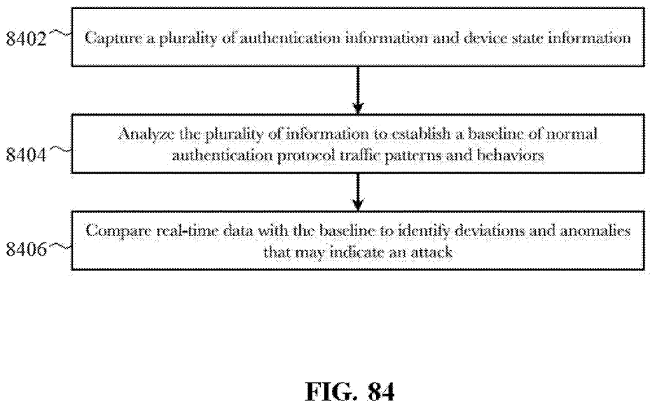

FIG. 84 is a flow diagram illustrating an exemplary method for determining if an intervention is required using a baseline comparison, according to an embodiment. The process begins at step 8402 when ZTNO 7911 captures, receives, retrieves, or otherwise obtains a plurality of authentication information and device state information from multiple sources of data. Such information can include local account information and privileges, historical usage/application connectivity, which users and associated privileges access the device, vulnerabilities or defensive tooling/observation capabilities on the device, and/or the like. At step 8404 ZTNO 7911 can analyze the plurality of information to establish a baseline of normal authentication protocol traffic patterns and behaviors. This step may be applied to specific authentication protocols (e.g., Kerberos, SAML, RADIUS, etc.) wherein there is a baseline establish for each of the applicable authentication protocols. At step 8406, ZTNO 7911 compares real-time data with the baseline to identify deviations and anomalies that my indicate an attack. Identified anomalous activity may be flagged for further intervention. In some embodiments, this process of establishing a baseline and comparing said baseline with real-world data may be used in place of a previously disclosed predetermined thresholds.

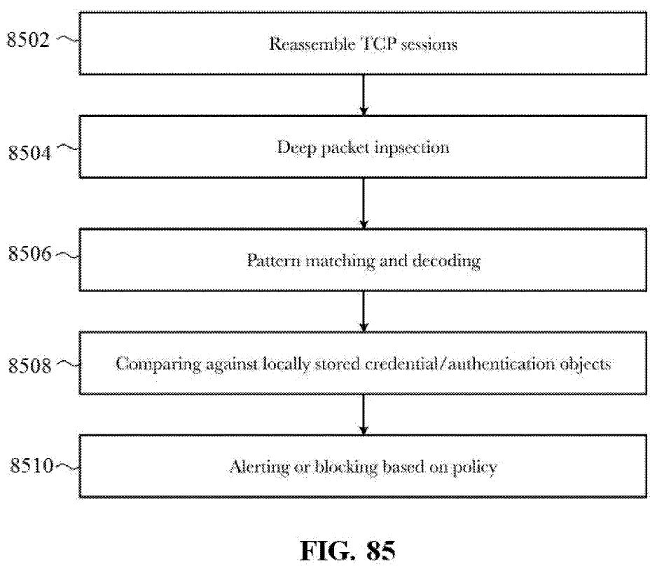

FIG. 85 is a flow diagram illustrating an exemplary method for using custom-designed hardware on network devices to inspect packets and identify authentication objects, according to an embodiment. In an embodiment of the system, the system comprises custom-designed hardware such as ASICs or FPGA boards integrated with network devices (e.g., switches, routers, etc.) and configured to provide efficient packet capture and inspection in real-time in order to detect potential authentication attacks and to take some intervening action if a potential attack is detected. According to the embodiment, the process begins at step 8502 by reassembling the transmission control protocol sessions. The ASIC accelerates the process of reassembling TCP sessions by offloading the task from the main CPU. This allows the network devices to analyze the complete flow of data with the session, including authentication objects and other relevant information. As a next step 8504, the ASIC is designed for deep packet inspection, enabling the network devices to analyze the content of the packets at the application layer. By inspecting the payloads of packets, the ASIC can identify specific authentication objects (e.g., Kerberos tickets, SAML assertions, RADIUS attributes, or NTLM tokens). As a next step 8506, the network device performs pattern matching and decoding. Pattern matching may utilize various information sources using various data storage methods including, but not limited to, time-series databases, graph databases, relations databases, NoSQL databases, and vector databases. Once the authentication objects are identified, the network devices can use pattern matching and decoding algorithms to extract relevant information from these objects. This may include usernames, passwords, session identifiers, or other data required for authentication.

At step 8508, a comparison against locally stored credentials/authentication objects is made. Network devices can maintain a local database of credentials or authentication objects of interest, which can be optionally salted and hashed for increased security. By comparing the extracted information from the inspected packets with the locally stored credentials, the network devices with the integrated ASIC can verify the authenticity of the authentication objects. As a last step 8510, the network devices may generate an alert or an intervention based on policy. If the comparison reveals a mismatch or any suspicious activity, the network device can generate alerts or block the traffic based on the configured security policy. This can help prevent unauthorized access or attacks targeting authentication protocols. By utilizing ASICs (or similar) on network devices and updating those network devices with target lists from the zero trust network orchestrator 7911, the network devices can efficiently inspect packets and identify authentication objects in real-time, enabling organizations to monitor, analyze, and secure their network traffic more effectively.

The skilled person will be aware of a range of possible modifications of the various aspects described above. Accordingly, the present invention is defined by the claims and their equivalents.

What is claimed is:

1. A computer system for dynamically authenticating devices in a network, comprising:
a computing device, including a processor and memory;
a plurality of programming instructions stored in the memory of, and operating on the processor of, the computing device, wherein the first plurality of programmable instructions, when operating on the processor, cause the computing device to:
maintain a record of authentication objects associated with different users in the network;
receive a first authentication object and a request for delegation from a primary user, wherein the request for delegation designates a secondary user;
authenticate the primary user based on comparing the first authentication object to the record of authentication objects;
generate a second authentication object associated with the secondary user, wherein the second authentication object provides a subset of privileges allowed by the primary user;
add the second authentication object to the record of authentication objects;
upon receiving a request by the secondary user to perform an action beyond the subset of privileges provided by the second authentication object, send a request for additional authentication information to the primary user; and
upon receiving a request for revocation of delegation from the primary user, automatically remove the second authentication object from the record of authentication objects and revoke any authentication of the secondary user.

2. The system of claim 1, wherein the secondary user is a nonhuman user.

3. The system of claim 1, wherein the additional authentication information includes biometric data and/or other information associated with a physical profile of the primary user.

4. The system of claim 1, wherein the first authentication object includes biometric data and/or other information associated with a physical profile of the primary user.

5. The system of claim 1, wherein the second authentication object is derived from the first authentication object.

6. The system of claim 1, wherein the computing device is further caused to generate a baseline profile for the secondary user and automatically revoke privileges provided by the second authentication object based on detected deviations from the baseline profile.

7. A computer-implemented method for dynamically authenticating devices in a network, comprising:
maintaining a record of authentication objects associated with different users in the network;
receiving a first authentication object and a request for delegation from a primary user, wherein the request for delegation designates a secondary user;
authenticating the primary user based on comparing the first authentication object to the record of authentication objects;
generating a second authentication object associated with the secondary user, wherein the second authentication object provides a subset of privileges allowed by the primary user;
adding the second authentication object to the record of authentication objects;
upon receiving a request by the secondary user to perform an action beyond the subset of privileges provided by the second authentication object, sending a request for additional authentication information to the primary user; and
upon receiving a request for revocation of delegation from the primary user, automatically removing the second authentication object from the record of authentication objects and revoking any authentication of the secondary user.

8. The method of claim 7, wherein the secondary user is a nonhuman user.

9. The method of claim 7, wherein the additional authentication information includes biometric data and/or other information associated with a physical profile of the primary user.

10. The method of claim 7, wherein the first authentication object includes biometric data and/or other information associated with a physical profile of the primary user.

11. The method of claim 7, wherein the second authentication object is derived from the first authentication object.

12. The method of claim 7, further comprising generating a baseline profile for the secondary user and automatically revoking privileges provided by the second authentication object based on detected deviations from the baseline profile.

13. Non-transitory, computer-readable storage media having computer-executable instructions embodied thereon that, when executed by one or more processors of a computing system for dynamically authenticating devices in a network, cause the computing system to:
maintain a record of authentication objects associated with different users in the network;
receive a first authentication object and a request for delegation from a primary user, wherein the request for delegation designates a secondary user;
authenticate the primary user based on comparing the first authentication object to the record of authentication objects;
generate a second authentication object associated with the secondary user, wherein the second authentication object provides a subset of privileges allowed by the primary user;
add the second authentication object to the record of authentication objects;
upon receiving a request by the secondary user to perform an action beyond the subset of privileges provided by the second authentication object, send a request for additional authentication information to the primary user; and
upon receiving a request for revocation of delegation from the primary user, automatically remove the second authentication object from the record of authentication objects and revoke any authentication of the secondary user.

14. The non-transitory, computer-readable storage media of claim 13, wherein the secondary user is a nonhuman user.

15. The non-transitory, computer-readable storage media of claim 13, wherein the additional authentication information includes biometric data and/or other information associated with a physical profile of the primary user.

16. The non-transitory, computer-readable storage media of claim 13, wherein the first authentication object includes biometric data and/or other information associated with a physical profile of the primary user.

17. The non-transitory, computer-readable storage media of claim 13, wherein the second authentication object is derived from the first authentication object.

18. The non-transitory, computer-readable storage media of claim 13, wherein the computing device is further caused to generate a baseline profile for the secondary user and automatically revoke privileges provided by the second authentication object based on detected deviations from the baseline profile.
